(19) United States
(12) Patent Application Publication
(10) Pub. No.: US 2023/0092526 A1
(43) Pub. Date: Mar. 23, 2023

(54) MOBILE DISPERSION SYSTEM AND METHODS FOR THE RESUSPENSION OF PARTIALLY-DRIED MICROFIBRILLATED CELLULOSE

(71) Applicant: FIBERLEAN TECHNOLOGIES LIMITED, PAR (GB)

(72) Inventors: Chris BONDS, St. Austell (GB); Stephan du TOIT, St. Austell (GB); Ben BULSON, St. Austell (GB); Guillaume TELLIER, Saint Gilles (BE); Mark WINDEBANK, Cornwall (GB); David SKUSE, Truro (GB)

(73) Assignee: FIBERLEAN TECHNOLOGIES LIMITED, PAR (GB)

(21) Appl. No.: 17/939,431

(22) Filed: Sep. 7, 2022

Related U.S. Application Data
(63) Continuation of application No. PCT/US2022/042728, filed on Sep. 7, 2022.
(60) Provisional application No. 63/241,700, filed on Sep. 8, 2021.

(51) Int. Cl. D21B 1/34; D21C 9/00; D21H 17/68; C08K 3/26

(52) U.S. Cl. CPC D21B 1/34; D21C 9/007; D21H 17/68; C08K 3/26

(57) ABSTRACT

Transportable equipment systems and associated methods for re-dispersing previously partially-dried belt press cakes or other partially-dried caked compositions produced by filtration, comprising microfibrillated cellulose and, optionally, one or more inorganic particulate material, and, optionally, one or more additive.

### FIELD OF INVENTION

The present invention relates generally to transportable mixing (make down) equipment systems and associated methods for re-dispersing previously partially-dried belt press cakes or other partially-dried caked compositions produced by filtration, comprising microfibrillated cellulose and, optionally, one or more inorganic particulate material, and, optionally one or more additive.

### BACKGROUND OF INVENTION

Transportable equipment systems of the type described herein require reduced energy input and are economical means to re-disperse previously partially-dried, belt press cakes or other partially-dried caked compositions produced by filtration, for example, plate and frame press cakes or tube press caked compositions (hereinafter collectively described as “filtration cakes or caked compositions”) comprising microfibrillated cellulose (hereinafter, sometimes MFC) and, optionally, one or more inorganic particulate material, and, optionally, one or more additive, as a substantially homogeneous suspension for end-use applications. The described transportable equipment systems minimize or avoid agglomeration and/or hornification normally associated with the re-dispersion of microfibrillated cellulose in partially-dried filtration cake form. The equipment systems and associated methods also restore viscosity and/or tensile index of the re-dispersed microfibrillated cellulose, compared to similar never-dewatered compositions, for use in various end-use applications in which such re-dispersed liquid compositions of microfibrillated cellulose and, optionally, one or more inorganic particulate material, and, optionally, one or more additive compositions, are utilized. The described equipment systems also address the need for transportable mobile equipment systems which may be installed at remote end-user locations, for example at a paper manufacturing facility.

The present invention also relates generally to methods of improving the re-dispersibility of partially-dried filtration cake compositions comprising microfibrillated cellulose and, optionally, one or more inorganic particulate material, and, optionally, one or more additive. Additional examples of partially-dried filtration cakes include plate and frame press cakes and tube press caked compositions. The described methods comprise preparation of slurries of previously partially-dried filtration cake compositions comprising microfibrillated cellulose and, optionally, one or more inorganic particulate material, and, optionally, one or more additive, wherein the slurry of microfibrillated cellulose or the slurry of microfibrillated cellulose and one or more inorganic particulate material, and, optionally one or more additive, can be re-dispersed in a continuous single pass process, or optionally by a recirculating (multiple pass) process, while requiring reduced energy input to re-disperse the microfibrillated cellulose and, optionally, one or more inorganic particulate material composition, and, optionally, one or more additive. The described methods minimize or eliminate agglomeration and/or hornification of the microfibrillated cellulose upon re-dispersion. The described methods also restore viscosity and/or tensile index of the re-dispersed microfibrillated cellulose to within 70% to essentially completely restored levels compared to similar compositions which have never been partially-dried.

Microfibrillated cellulose and inorganic particulate materials, for example an alkaline earth metal carbonate (e.g., calcium carbonate) or kaolin clay, and mixtures thereof are used widely in a number of industrial applications. These include, without limitation, the production of microfibrillated cellulose and inorganic particulate material-containing compositions, which may be used as fillers in paper manufacture and/or in paper coatings, for example, in accordance with U.S. Pat. Nos. 8,231,764; 9,127,405; and 10,100,464, which are hereby incorporated by reference in their entirety. In paper and coated paper products, such fillers are typically added to replace a portion of other more expensive components of the paper and/or coated paper product. Fillers may also be added with an aim of modifying the physical, mechanical, and/or optical requirements of paper and/or coated paper products, for example in the manner described in U.S. Pat. No. 10,253,457, which is hereby incorporated by reference in its entirety. Clearly, the greater the amount of filler that can be included in the paper product or paper coating, the greater potential for cost savings. However, the amount of filler added and the associated cost saving must be balanced against the physical, mechanical and optical requirements of the final paper product or coated paper product. Thus, there is a continuing need for the development of improved fillers for paper and paper coatings, which can be used at a high loading level without adversely affecting the physical, mechanical and/or optical requirements of such paper and/or coated paper products. There is also a need for the development of methods for preparing such fillers economically.

In recent years, microfibrillated cellulose and compositions comprising same as well as compositions comprising microfibrillated cellulose and one or more inorganic particulate material have been shown to have a variety of useful properties, including the enhancement of the mechanical, physical and/or optical properties, of a variety of end-use products, such as paper, paperboard, polymeric articles, paints, and the like.

Typically prepared in aqueous form, microfibrillated cellulose compositions are frequently partially dried for transport in order to reduce the overall weight of the compositions as well as to reduce associated transportation costs. The end-user will then typically re-disperse the partially-dried microfibrillated cellulose prior to use in an intended end-use application. Exemplary processes for dewatering and drying compositions comprising microfibrillated cellulose and one or more inorganic particulate material are described in U.S. Pat. No. 11,001,644, which is incorporated herein by reference in its entirety. However, following drying and re-dispersion some of the advantageous properties of the microfibrillated cellulose can be diminished or lost, for reasons that include agglomeration and/or hornification of the microfibrillated cellulose. Thus, there is an ongoing need to improve the properties of microfibrillated cellulose following partial drying and re-dispersion.

### SUMMARY OF THE INVENTION

The present invention has solved the foregoing technical problem by providing a system and process that enables re-dispersion of partially-dried, filtration cake compositions through energy efficient and economical process steps and equipment. The present invention provides for dewatering a liquid composition (preferably, an aqueous composition) and eliminating a drying step, wherein the partially-dried filtration cake composition (for example, a belt press cake or a plate and frame press cake, or a tube press caked composition) in partially-dried form is re-dispersed in a liquid medium (preferably an aqueous medium) in a minimum number of process steps and utilizing a minimum number of apparatus, to yield a liquid composition of microfibrillated cellulose or microfibrillated cellulose and one or more inorganic particulate material, and, optionally, one or more additive, in which viscosity is restored and/or tensile index of the re-dispersed microfibrillated cellulose is restored to within 70% to essentially completely restored levels compared to a similar composition that has never been partially dried. Such compositions include liquid (e.g., aqueous) compositions of microfibrillated cellulose (i.e., essentially mineral-free MFC) and microfibrillated cellulose and one or more inorganic particulate material (i.e., mineral-containing MFC).

Accordingly, the present invention seeks to address the problem of re-dispersing a dewatered, partially-dried filtration cake composition comprising microfibrillated cellulose and, optionally, comprising one or more inorganic particulate matter, and, optionally one or more additive composition, in a dispersing liquid (for example, water, or a hydroalcoholic mixture, or any other compatible solvent), optionally in the presence of an additive other than inorganic particulate material (for example, one or more biocide or flocculant) and/or in the presence of a combination of inorganic particulate materials, while avoiding the well-known problems of agglomeration and/or hornification. The additive and/or combination of inorganic particulate materials may, for example, enhance a mechanical and/or physical property of the re-dispersed microfibrillated cellulose. The additive may also provide biocidal properties to the caked composition or filtration cake materials, while in transit and storage. The present invention further relates to manufacturing of articles, products or compositions comprising re-dispersed microfibrillated cellulose or microfibrillated cellulose and one or more inorganic particulate material, and, optionally, one or more additive.

The present invention further seeks to provide alternative and/or improved fillers for paper and/or coated paper products, which may be incorporated in the paper and/or coated paper product at relatively high loading levels, whilst maintaining or even improving the physical, mechanical and/or optical properties of the paper and/or coated paper product.

The present invention also seeks to provide an economical method and corresponding portable manufacturing system for re-dispersing a liquid composition comprising microfibrillated cellulose and, optionally, one or more inorganic particulate material, and, optionally one or more additive, for preparing such fillers comprising same for a variety of end-use applications, as described more completely herein. Such portable systems allow construction of a system for re-dispersing a partially-dried, filtration cake composition comprising microfibrillated cellulose and, optionally, one or more inorganic particulate material, and, optionally one or more additive at a location proximate to an end-use manufacturing site, for example, a paper manufacturing and/or a paper coating site.

The solution to the problem is a transportable system for re-dispersing previously partially-dried and, optionally, comminuted or pulverized, compositions comprising microfibrillated cellulose or microfibrillated cellulose and one or more inorganic particulate material, and, optionally, one or more additive, and associated methods for the re-dispersion of a previously partially-dried, filtration cake composition comprising microfibrillated cellulose and, optionally, one or more inorganic particulate material, and optionally, one or more additive, as described in detail in the present specification.

Transportable re-dispersion systems of the type described comprise either single or twin moderate-to-high-shear mixing apparatus comprising a shear-head impeller, for example a dispergator, disperser, overhead stirrer for high-speed, high-shear mixing or a Cowles-type mixer, or other generally vertically-oriented, shear-head impeller apparatus, although horizontally oriented embodiments are contemplated, as well. The single or twin moderate-to-high-shear mixing apparatus comprising a shear-head impeller may be used either singly in a single mixing tank, or two or more in succession when the transportable system incorporates a second mixing tank (or more), to partially de-agglomerate and form a flowable liquid slurry or suspension of microfibrillated cellulose and, optionally, one or more inorganic particulate material, and, optionally on or more additive, before performing a high-shear mixing operation to further process the flowable slurry or suspension into a substantially homogeneous suspension. The flowable suspension or slurry comprising microfibrillated cellulose and, optionally, one or more inorganic particulate material, and, optionally, one or more additive, is sequentially subjected to high-shear mixing by one or more rotor-stator and/or rotor-rotor mixing apparatus, to form a substantially homogenous suspension, wherein viscosity and/or tensile index of the re-dispersed microfibrillated cellulose is restored to within 70% to essentially completely restored levels compared to similar compositions which have never been partially-dried. The high-shear mixing apparatus is preferably selected from a rotor-rotor apparatus, a rotor-stator apparatus, a colloid mill, an ultrafine grinding apparatus, or a refiner, wherein the rotor-rotor apparatus comprises counter-rotating rings, for subjecting the substantially homogenous suspension to additional high-shear processing.

As used herein, a “rotor-rotor mixer” produces high and focused shear with high viscosity slurries compared to conventional mixers. Rotor-rotor mixers have two counter-rotating mixing elements (rotors) which are capable of imparting high shear forces. Due to the geometry of the mixer, the liquid slurry is forced through a zone of high shear forces formed by the rotors. An exemplary commercially available rotor-rotor mixer is an Atrex® mixer supplied by Megatrex Oy, Lempäälä, Finland. Alternative apparatus include an ultra-fine friction grinder (Supermasscolloider® available from Masuko Sangyo Co. Ltd., Japan. An example of an Atrex® mixer is a rotor-rotor dispergator, model G30, diameter 500 mm, 6 rotor peripheries, rotation speed applied 1500 rpm (counter-rotating rotors). The preferred gap width is less than 10 mm and preferably less than 5 mm. So-called rotor-rotor dispergators operate in a manner where a series of frequently repeated impacts to the dispersion, i.e., substantially homogeneous suspension, are caused by blades of several rotors that rotate in opposite directions. An Atrex® dispergator is an example of such a dispergator. The adjacent rotors rotated in opposite directions at 1500 rpm. The present invention contemplates use of comparable rotor-rotor mixing apparatus to those named herein.

As used herein, a rotor-stator apparatus imparts higher shear rates than a radial flow impeller in the mixing of suspended solids in a solvent, e.g., water. A commercially available rotor-stator apparatus is exemplified, for example, by a Trigonal® mixer, and other comparable high-shear mixers, for instance a BVG ShearMaster rotor-stator mixing apparatus. The rotor-stator mixer typically has tip speeds >20 m/s and an in-situ adjustable rotor-stator gap width of 0.1, 0.2, 0.3 mm and so on, depending on required shear-levels and the physical limits of their design. Feed flows typically within the range 7 to 16 m³/hr but can handle flows of up to 35 m³/h if required, High Shear mixer is controlled off a variable speed drive (VSD) drive to vary the amount of energy input. The present invention contemplates use of comparable rotor-stator mixing apparatus to those named herein.

In some preferred embodiments, the transportable system is used in conjunction with a feed hopper, conveyor and screw feeder to load partially-dried, filtration cake compositions of microfibrillated cellulose or microfibrillated cellulose and one or more inorganic particulate material, and optionally, one or more additive, into a mixing tank having a dispergator, disperser, overhead stirrer for high-speed, high-shear mixing or Cowles type mixer or comparable mixing apparatus.

In some embodiments, the feed hopper may have a motor driven scraper for loosening particulate that may adhere to the interior wall of the feed hopper.

In some embodiments, there is a second mixing tank having a second dispergator, disperser, overhead stirrer for high-speed, high-shear mixing or Cowles type mixer or comparable apparatus for further de-agglomerating and mixing the flowable liquid slurry or suspension of microfibrillated cellulose or microfibrillated cellulose and one or more inorganic particulate material, and, optionally, one or more additive.

In some embodiments, the first mixing tank and second mixing tank are connected with an overflow pipe. Once the level of flowable slurry inside the first mixing tank reaches overflow level, the flowable slurry is constantly transferred to second mixing tank during a continuous re-dispersing process. In some embodiments, the overflow pipe optionally may have one or more openings to allow inspection and cleaning of the overflow pipe.

In some embodiments, the first mixing tank and second mixing tank may have one or more openings to permit inspection and cleaning of the mixing tank.

The transportable system has a second stage, high-shear mixing apparatus connected to the first mixing tank if the system utilizes a single moderate-to-high-shear mixing apparatus comprising a shear-head impeller (for example a dispergator, disperser, overhead stirrer for high-speed, high-shear mixing or Cowles type mixer). Where the system has two mixing tanks each with a moderate-to-high-shear mixing apparatus comprising a shear-head impeller (for example a dispergator, disperser, overhead stirrer for high-speed, high-shear mixing or Cowles type mixer), the second mixing tank is connected to the second stage high-shear mixing apparatus, such as a rotor-stator and/or rotor-rotor mixing apparatus, that is used to apply high-shear to the flowable liquid slurry or suspension of microfibrillated cellulose and, optionally, one or more inorganic particulate material, and, optionally, one or more additive.

In some embodiments, the transportable make down system may utilize two or more second state rotor-stator and/or rotor-rotor high-shear mixing apparatus.

In some embodiments, when the transportable MDU is located adjacent to a paper manufacturing facility, the MDU can utilize a pulper at the paper manufacturing facility in lieu of the first mixing tank and moderate-to-high-shear mixing apparatus comprising a shear-head impeller (for example a dispergator, disperser, overhead stirrer for high-speed, high-shear mixing or Cowles type mixer) and then circulate the flowable slurry from the pulper to one or more high-shear rotor-stator and/or rotor-rotor mixing apparatus.

In some embodiments where a first and second mixing tank each comprising a single moderate-to-high-shear mixing apparatus comprising a shear-head impeller (for example a dispergator, disperser, overhead stirrer for high-speed, high-shear mixing or Cowles type mixer), followed by a second stage, high-shear mixing apparatus, the substantially homogeneous composition of microfibrillated cellulose or microfibrillated cellulose and one or more inorganic particulate material, and, optionally, one or more additive discharged therefrom is recirculated to a second inlet of the first mixing tank to enable a recirculation loop for further processing. The substantially homogenous suspension product may optionally be piped from the final delivery outlet, back to the first mixing tank so it recirculates through the entire transportable re-dispersion system for a calculated time period to achieve a specific or maximum quality level, as determined by viscosity and/or tensile index properties.

In some embodiments, a third or fourth high-shear mixing apparatus may be added in series or parallel (for example, a BVG ShearMaster rotor-stator mixing apparatus may be followed by (or in parallel to) a second rotor-stator mixing apparatus (for example a BVG ShearMaster or a Trigonal® high-shear mixing apparatus or a deflaker or refiner) or be followed by a rotor-rotor mixing apparatus (for example, an Atrex® rotor-rotor mixing apparatus. Various combinations of rotor-rotor and/or rotor-stator mixing apparatus may be configured which would be understood by the skilled person based on the disclosures set forth in this specification.

In some embodiments the high-shear processed substantially homogenous suspension is collected in a suitable holding vessel for further end-use applications.

In some embodiments the high-shear processed substantially homogenous suspension is redirected to the first mixing tank in unitary systems or twin mixing tank systems to permit further high-shear processing.

In some embodiments, the second stage, third high shear mixing apparatus is selected from a rotor-rotor apparatus, a high-shear rotor-stator apparatus, a colloid mill, an ultrafine grinding apparatus, or a refiner, wherein the rotor-rotor apparatus comprises counter-rotating rings, for subjecting the flowable slurry to high-shear processing to produce a substantially homogenous suspension of microfibrillated cellulose and, optionally, one or more inorganic particulate material, and, optionally, one or more additive, wherein the tensile properties of the microfibrillated cellulose are comparable to the tensile properties of a comparable never-partially-dried suspension of microfibrillated cellulose and, optionally, one or more inorganic particulate material, and, optionally one or more additive.

In some embodiments, the third high-shear mixing apparatus is connected to one or more filters, for example a first static filter and a second static filter which may be operated interchangeably to permit cleaning and removing deposited material, wherein the substantially homogenous suspension may then be transferred to a suitable holding vessel for further end-use applications or a second inlet of a first mixing tank or may be used directly in an end-use application.

In some embodiments, filters may be utilized after the first mixing apparatus or second (or third mixing apparatus if utilized) and the high-shear rotor-stator or rotor-rotor mixing apparatus, but could also be optionally utilized after the rotor-stator or rotor-rotor high-shear mixing apparatus, to increase throughput. The placement of filters in the system would be readily understood by the skilled person based on the disclosures in this specification and upon common general knowledge of the skilled person.

In some embodiments, a third or fourth high-shear mixing apparatus may be added in series (for example, a BVG ShearMaster rotor-stator mixing apparatus may be followed by a second rotor-stator mixing apparatus (for example a BVG ShearMaster or a Trigonal® high-shear mixing apparatus) or be followed by a rotor-rotor mixing apparatus (for example, an Atrex® rotor-rotor mixing apparatus. Various combinations of rotor-rotor and/or rotor-stator mixing apparatus may be configured, which would be understood by the skilled person.

The described methods also restore viscosity and/or tensile properties, including tensile strength and tensile index properties, of the re-dispersed microfibrillated cellulose to within 70% to essentially completely restored levels compared to similar compositions which have never been partially-dried.

In some embodiments, the substantially homogenous suspension of microfibrillated cellulose and, optionally, one or more inorganic particulate material, and, optionally, one or more additive can be pumped to an end-use manufacturing process.

In a first aspect of the present invention there is provided a method for re-dispersing a partially-dried, filtration cake composition comprising microfibrillated cellulose and, optionally, one or more inorganic particulate material, and, optionally one or more additional additive in a liquid medium; the method comprising the steps of
(a) providing a quantity of a dispersing liquid to a first mixing tank (20) through a first inlet (24);
(b) providing a partially-dried, filtration cake composition comprising microfibrillated cellulose and, optionally, one or more inorganic particulate material, and, optionally one or more additional additive, to the first mixing tank (20) through a second inlet (25);
(c) optionally, providing one or more additive to the first mixing tank (20) by either the first inlet (24), second inlet (25) or both;
wherein, the quantity of partially-dried, filtration cake composition comprising microfibrillated cellulose and, optionally, one or more inorganic particulate material and, optionally one or more additive, has a total solids content of about 8 wt. % to about 60 wt. %, and wherein the dispersing liquid and partially-dried filtration cake has a fibre content of from about 0.5 wt % to about 20 wt % fibre solids, preferably about 0.5 wt. % to about 4 wt. % fibre solids, and more preferably about 1 wt. % to about 2 wt. % fibre solids based on the total solids content of the microfibrillated cellulose and optionally one or more inorganic particulate material, and, optionally, one or more additive;
wherein the first mixing tank (20) further comprises a first high-shear mixing apparatus (22a) comprising a shear-head impeller (22b) and optionally a third inlet (29);
(d) applying high-shear mixing to the liquid medium and microfibrillated cellulose and, optionally, one or more inorganic particulate material, and, optionally one or more additive, to form a flowable slurry;
wherein the first mixing tank (20) has outlet (26) attached to inlet (31) of a second high-shear rotor-stator or rotor-rotor mixing apparatus (30);
(e) applying further high-shear mixing to the flowable slurry to form a substantially homogeneous suspension of the liquid medium and microfibrillated cellulose and, optionally one or more particulate material and, optionally, one or more additional additive;
(f) retrieving the substantially homogeneous suspension of liquid medium and microfibrillated cellulose and, optionally one or more particulate material and, optionally, one or more additional additive, through outlet (32) of second high-shear rotor-stator or rotor-rotor mixing apparatus (30), optionally connected to storage tank (60) or utilized directly in an end-use application or, optionally, recirculated to optional third inlet (29) of first mixing tank (20) to form a recirculation loop to permit further continuous processing of the substantially homogeneous suspension;
wherein the viscosity of the substantially homogeneous suspension is restored and/or tensile index of the re-dispersed microfibrillated cellulose and, optionally one or more inorganic particulate material are restored to within the range of 70% to essentially completely restored levels compared to a similar composition that has never been partially-dried.

In some embodiments, the first and/or second high-shear mixing apparatus (22a) comprising a shear-head impeller (22b) is a dispergator, disperser, overhead stirrer for high-speed, high-shear mixing or Cowles type mixer or other generally vertically oriented shear-head impeller apparatus.

In some embodiments, the high-shear rotor-stator mixing apparatus is a Trigonal® mixer (Siefer-Trigonal machine), or more generally a colloid mill, or a refiner, or a deflaker or a BVG ShearMaster® rotor-stator mixing apparatus, which impart relatively higher shear-rates, depending on required shear-levels and physical limits of the design compared to a shear head mixer imparting moderate shear. In another embodiment the high-shear rotor-stator mixing apparatus is a Cavitron® rotor-stator mixer supplied by Hagen & Funke GmbH. Sprockhovel, Germany. Feed flows typically within the range 7 to 16 m³/hr but can handle flows of up to 35 m³/h if required, High Shear mixer is controlled off a VSD drive to vary the amount of energy input.

In some embodiments, the substantially homogenous suspension product may optionally be piped from the final delivery outlet, back to the first mixing tank so it recirculates through the entire transportable re-dispersion system for a calculated time period to achieve a specific or maximum quality level, as determined by viscosity and/or tensile index properties

In some embodiments, one or more optional filter (28a/28b) (preferably 2,500 μm), which are operated interchangeably to permit cleaning and removing agglomerates in the flowable slurry, are interposed between outlet (26) and inlet (31).

In some embodiments, a pump may be utilized before the second stage high-speed rotor-stator or rotor-rotor mixer to increase throughput of the transportable re-dispersion system.

In some embodiments, the second stage high-speed rotor-stator or rotor-rotor mixing apparatus serves as a pump for the transportable re-dispersion system.

In some embodiments, a pump may be utilized after the second stage high-speed rotor-stator or rotor-rotor mixer to increase throughput of the transportable re-dispersion system.

In some embodiments, the flowable slurry from mixing tank (20) may be further processed in a second mixing tank (70) (not shown) having a second high-shear mixing apparatus (72a) comprising a shear-head impeller (72b) for high shear mixing of the liquid medium and microfibrillated cellulose and, optionally, one or more particulate material, and, optionally one or more additive, to form a flowable slurry; further comprising outlet (73) connected to inlet (31) of second high-speed rotor-stator or rotor-rotor mixing apparatus (30); further comprising an overflow tube for passively conducting flowable slurry first from mixing tank (20) to second mixing tank (70) when an overflow level of mixing tank (20) is reached.

In some embodiments, the first mixing tank and/or second mixing tank may be open at the top.

In some embodiments, the method further comprises providing the partially-dried, filtration cake composition comprising microfibrillated cellulose and, optionally, one or more inorganic particulate material, and, optionally one or more additional additive, to the first mixing tank (20) by a feed hopper.

In some embodiments, the first and/or second high-shear mixing apparatus (22a) comprising a shear-head impeller (22b) is a dispergator, disperser, overhead stirrer for high-speed, high-shear mixing or Cowles type mixer or other generally vertically oriented shear-head impeller apparatus.

In some embodiments the one or more additive is a biocide, preferably 2,2-dibromo-3-nitrilopropionamide (DBNPA) typically dosed at about 0 to about 250 ppm or chloro-2-methyl-2h-isothiazolin-3-one/2-methyl-2h-isothiazol-3-one (3:1 ratio) (CMIT/MIT) dosed at about 0 to about 200 ppm. When present, biocide is added after formation of the belt press cake but before storage of the belt press cake composition and transport to the manufacturing location for re-dispersion of the belt cake.

In some embodiments, the one or more additive is a flocculant, preferably a cationic flocculant, for example, polyacrylamide solution (available from BASF) as Percol 3035 or Axchem AF9810. The flocculants are typically dosed at about 500 ppm to about 4,000 ppm, when present. In some embodiments, flocculant is mixed via a mixer valve and inline (static) mixer system. When present, flocculant is added before formation of the belt press cake.

In some embodiments, the described method restores viscosity and/or tensile index of the re-dispersed microfibrillated cellulose to within 75% to essentially completely restored levels compared to similar compositions which have never been dried.

In some embodiments, the described method restores viscosity and/or tensile index of the re-dispersed microfibrillated cellulose to within 80% to essentially completely restored levels compared to similar compositions which have never been dried.

In some embodiments, the described method restores viscosity and/or tensile index of the re-dispersed microfibrillated cellulose to within 85% to essentially completely restored levels compared to similar compositions which have never been dried.

In some embodiments, the described method restores viscosity and/or tensile index of the re-dispersed microfibrillated cellulose to within 90% to essentially completely restored levels compared to similar compositions which have never been dried.

In some embodiments, the described method restores viscosity and/or tensile index of the re-dispersed microfibrillated cellulose to within 95% to essentially completely restored levels compared to similar compositions which have never been dried.

In some embodiments, the described method essentially restores viscosity and/or tensile index of the re-dispersed microfibrillated cellulose to essentially completely restored levels compared to similar compositions which have never been dried.

In some embodiments, the filtration cake is a belt press cake.

In some embodiments, the filtration cake is a plate and frame cake.

In some embodiments, the filtration cake is a tube press cake.

In some embodiments the one or more inorganic particulate material is selected from an alkaline earth metal carbonate or sulphate, such as calcium carbonate, magnesium carbonate, dolomite, gypsum, a hydrous kandite day such as kaolin, halloysite or ball clay, an anhydrous (calcined) kandite clay such as metakaolin or fully calcined kaolin, talc, mica, perlite, bentonite, or diatomaceous earth, or magnesium hydroxide, or aluminum trihydrate, or combinations thereof.

In some embodiments, the one or more inorganic particulate material is selected from one or more of kaolin, calcined kaolin, wollastonite, bauxite, talc, bentonite or mica.

In some embodiments, the one or more inorganic particulate material is calcium carbonate, preferably ground calcium carbonate, precipitated calcium carbonate and mixtures thereof.

In some embodiments, the one or more inorganic particulate material is kaolin clay.

In some embodiments, the one or more inorganic particulate material is hyper-platy kaolin.

In some embodiments, the one or more inorganic particulate material is bentonite.

In some embodiments, the one or more inorganic particulate material is calcium carbonate.

In some embodiments, the one or more inorganic particulate material is ground calcium carbonate.

In some embodiments, the one or more inorganic particulate material is precipitated calcium carbonate.

In some embodiments, the calcium carbonate may be in aragonite, rhombohedral or scalenohedral crystal form.

In some embodiments, the kaolin clay may typically contain at least about 50% by weight kaolinite, or at least about 75% by weight kaolinite, or at least about 85% by weight kaolinite, or at least about 90% by weight kaolinite, or at least about 95% by weight kaolinite.

In a second aspect of the present invention, there is provided a transportable make down system for re-dispersing partially-dried, filtration cake compositions comprising microfibrillated cellulose, and, optionally, one or more inorganic particulate material and, optionally, one or more additive, i.e., a system for re-dispersing a partially-dried, filtration cake composition comprising microfibrillated cellulose and, optionally, one or more inorganic particulate material, and, optionally, one or more additive in a liquid medium (preferably aqueous) to form a homogeneous suspension in a continuous or batch process, comprising: a first mixing tank (20) having tank inlet (24); second inlet (25) for provision of liquid medium to the first mixing tank (20); first high-shear mixing apparatus (22a) comprising a shear-head impeller (22b) for high shear mixing of the liquid medium and microfibrillated cellulose and, optionally, one or more particulate material, and, optionally one or more additive, to form a flowable slurry; outlet (26) attached to inlet (31) of a second high-speed rotor-stator or rotor-rotor mixing apparatus (30); wherein after application of high-shear to the flowable slurry by rotor-stator and/or rotor-rotor mixing apparatus (30) forms a substantially homogeneous suspension comprising microfibrillated cellulose and, optionally, one or more inorganic particulate material, and, optionally one or more additive; wherein the high-shear rotor-stator and/or rotor-rotor mixing apparatus (30) further comprises outlet (32) for retrieving the substantially homogeneous suspension comprising microfibrillated cellulose and, optionally, one or more inorganic particulate material, and, optionally one or more additive through outlet (32) optionally connected to storage tank 60 or utilized directly in an end-use application or recirculated to an optional third inlet (29) of mixing tank (20) to form a recirculation loop to permit further continuous processing.

In some embodiments, viscosity and/or tensile index of the re-dispersed substantially homogeneous suspension comprising microfibrillated cellulose is restored to within the range of 70% to essentially completely restored levels compared to a similar composition that has never been partially-dried.

In some embodiments, the first and/or second high-shear mixing apparatus (22a) comprising a shear-head impeller (22b) is a dispergator, disperser, overhead stirrer for high-speed, high-shear mixing or Cowles type mixer or other generally vertically oriented shear-head impeller apparatus.

In some embodiments, the high-shear rotor-stator mixing apparatus is a Trigonal® mixer (Siefer-Trigonal machine), or more generally a colloid mill, or a refiner, or a deflaker or a BVG ShearMaster® rotor-stator mixing apparatus, which impart relatively higher shear-rates, depending on required shear-levels and physical limits of the design compared to a shear head mixer imparting moderate shear. In another embodiment the high-shear rotor-stator mixing apparatus is a Cavitron® rotor-stator mixer supplied by Hagen & Funke GmbH. Sprockhovel, Germany. Feed flows typically within the range 7 to 16 m³/hr but can handle flows of up to 35 m³/h if required, High Shear mixer is controlled off a VSD drive to vary the amount of energy input.

In some embodiments, the quantity of partially-dried, filtration cake composition comprising microfibrillated cellulose and, optionally, one or more inorganic particulate material and, optionally one or more additive, has a total solids content of about 8 wt. % to about 60 wt. %, and wherein the dispersing liquid and partially-dried filtration cake in the first mixing tank has a fibre content of from about 0.5 wt % to about 20 wt %, preferably about 0.5% to about 4% fibre solids, or more preferably about 1% to about 2%, based on the total solids content of the microfibrillated cellulose and optionally one or more inorganic particulate material, and, optionally, one or more additive.

In some embodiments, the substantially homogenous suspension product may optionally be piped from the final delivery outlet, back to the first mixing tank so it recirculates through the entire transportable re-dispersion system for a calculated time period to achieve a specific or maximum quality level, as determined by viscosity and/or tensile index properties

In another aspect of the present invention, there is provided a transportable make down system for re-dispersing partially-dried, filtration cake compositions comprising microfibrillated cellulose, and, optionally, one or more inorganic particulate material, and optionally one or more additive, i.e., a system for re-dispersing a partially-dried, filtration cake composition comprising microfibrillated cellulose and, optionally, one or more inorganic particulate material, and optionally one or more additive in a liquid medium (preferably aqueous) to form a homogeneous suspension in a continuous or batch process, comprising:

a first mixing tank (20) having tank inlet (24); optional feed hopper (10) for delivery of—the partially-dried microfibrillated cellulose to the first mixing tank and, optionally, providing one or more inorganic particulate material to mixing tank (20); second inlet (25) for provision of liquid medium to the first mixing tank (20); first high-shear mixing apparatus (22a) comprising a shear-head impeller (22b) for high shear mixing of the liquid medium and microfibrillated cellulose and, optionally, one or more particulate material, and, optionally, one or more additive, to form a flowable slurry; outlet (26) attached to inlet (31) of a second high-speed rotor-stator or rotor-rotor mixing apparatus (30) for applying further high-shear mixing to the flowable slurry, further comprising outlet (32); one or more optional filter (28a/28b) which are operated interchangeably to permit cleaning and removing agglomerates in the flowable slurry interposed between outlet (26) and inlet (31), wherein after application of high-shear to the flowable slurry by one or more rotor-stator or rotor-rotor mixing apparatus (30) forms a substantially homogeneous suspension comprising microfibrillated cellulose and, optionally, one or more inorganic particulate material, and, optionally one or more additive; wherein the substantially homogeneous suspension is retrieved through outlet (32) optionally connected to storage tank 60 or utilized directly in an end-use application or recirculated to an optional third inlet (29) of mixing tank (20) to form a recirculation loop to permit further continuous processing of the substantially homogeneous suspension.

In some embodiments, the first and/or second high-shear mixing apparatus (22a) comprising a shear-head impeller (22b) is a dispergator, disperser, overhead stirrer for high-speed, high-shear mixing or Cowles type mixer or other generally vertically oriented shear-head impeller apparatus.

In some embodiments, the high-shear rotor-stator mixing apparatus is a Trigonal® mixer (Siefer-Trigonal machine), or more generally a colloid mill, or a refiner, or a deflaker or a BVG ShearMaster® rotor-stator mixing apparatus, which impart relatively higher shear-rates, depending on required shear-levels and physical limits of the design compared to a shear head mixer imparting moderate shear. In another embodiment the high-shear rotor-stator mixing apparatus is a Cavitron® rotor-stator mixer supplied by Hagen & Funke GmbH. Sprockhovel, Germany. Feed flows typically within the range 7 to 16 m³/hr but can handle flows of up to 35 m³/h if required, High Shear mixer is controlled off a VSD drive to vary the amount of energy input.

In some embodiments, the quantity of partially-dried, filtration cake composition comprising microfibrillated cellulose and, optionally, one or more inorganic particulate material and, optionally one or more additive, has a total solids content of about 8 wt. % to about 60 wt. %, and wherein the dispersing liquid and partially-dried filtration cake in the first mixing tank has a fibre content of from about 0.5 wt % to about 20 wt %, preferably about 0.5% to about 4% fibre solids, or more preferably about 1% to about 2%, based on the total solids content of the microfibrillated cellulose and optionally one or more inorganic particulate material, and, optionally, one or more additive.

In some embodiments, the system further comprises an operating system (15 not shown) for controlling the feed rate of partially-dried microfibrillated cellulose and, optionally one or more inorganic particulate material, and, optionally, one or more additive, and the liquid medium to control the solids content in first mixing tank (20).

In some embodiments, filters may be utilized after the first mixing apparatus or second (or third mixing apparatus if utilized) and the high-shear rotor-stator or rotor-rotor mixing apparatus, but could also be optionally utilized after the rotor-stator or rotor-rotor high-shear mixing apparatus to increase throughput.

In some embodiments, the first mixing tank and/or second mixing tank may be open at the top.

In some, embodiments, the substantially homogenous suspension product may optionally be piped from the final delivery outlet, back to the first mixing tank so it recirculates through the entire transportable re-dispersion system for a calculated time period to achieve a specific or maximum quality level, as determined by viscosity and/or tensile index properties

In another aspect of the present invention, there is provided a transportable make down system for re-dispersing partially-dried, filtration cake compositions comprising microfibrillated cellulose, and, optionally, one or more inorganic particulate material, and, optionally, one or more additive, further comprising a third stage, high-shear rotor-stator or rotor-rotor mixing apparatus, further comprising inlet (52) connected to outlet (32) of second stage high-shear rotor-stator or rotor-rotor mixer for applying further high-shear mixing to the substantially homogenous suspension of microfibrillated cellulose or microfibrillated cellulose and one or more inorganic particulate material retrieved through outlet (52) optionally connected to storage tank (60) or utilized directly in an end-use application or recirculated to an optional third inlet (29) of mixing tank (20) to form a recirculation loop to permit further continuous processing.

In some embodiments, the first and/or second high-shear mixing apparatus (22a) comprising a shear-head impeller (22b) is a dispergator, disperser, overhead stirrer for high-speed, high-shear mixing or Cowles type mixer or other generally vertically oriented shear-head impeller apparatus.

In some embodiments, the high-shear rotor-stator mixing apparatus is a Trigonal® mixer (Siefer-Trigonal machine), or more generally a colloid mill, or a refiner, or a deflaker or a BVG ShearMaster® rotor-stator mixing apparatus, which impart relatively higher shear-rates, depending on required shear-levels and physical limits of the design compared to a shear head mixer imparting moderate shear. In another embodiment the high-shear rotor-stator mixing apparatus is a Cavitron® rotor-stator mixer supplied by Hagen & Funke GmbH. Sprockhovel, Germany. Feed flows typically within the range 7 to 16 m³/hr but can handle flows of up to 35 m³/h if required, High Shear mixer is controlled off a VSD drive to vary the amount of energy input.

In some embodiments, the quantity of partially-dried, filtration cake composition comprising microfibrillated cellulose and, optionally, one or more inorganic particulate material and, optionally one or more additive, has a total solids content of about 8 wt. % to about 60 wt. %, and wherein the dispersing liquid and partially-dried filtration cake in the first mixing tank has a fibre content of from about 0.5 wt % to about 20 wt %, preferably about 0.5% to about 4% fibre solids, or more preferably about 1% to about 2%, based on the total solids content of the microfibrillated cellulose and optionally one or more inorganic particulate material, and, optionally, one or more additive.

In some embodiments, the substantially homogenous suspension product may optionally be piped from the final delivery outlet, back to the first mixing tank so it recirculates through the entire transportable re-dispersion system for a calculated time period to achieve a specific or maximum quality level, as determined by viscosity and/or tensile index properties.

In some embodiments, the flowable slurry from mixing tank (20) may be further processed in a second mixing tank (70) (not shown) having second high-shear mixing apparatus (72a) comprising a shear-head impeller (72b) for high shear mixing of the liquid medium and microfibrillated cellulose and, optionally, one or more particulate material to form a flowable slurry; further comprising outlet (73) connected to inlet (31) of second high-speed rotor-stator or rotor-rotor mixing apparatus (30); further comprising an overflow tube for passively conducting flowable slurry from first mixing tank (20) to second mixing tank (70) when the overflow level of mixing tank 1 is reached.

In some embodiments, one or more optional filter (28a/28b) (preferably 2,500 μm), which are operated interchangeably to permit cleaning and removing agglomerates in the flowable slurry, are interposed between outlet (26) and inlet (31).

In some embodiments, the flowable slurry from mixing tank (20) may be further processed in a second mixing tank (70) (not shown) having a second high-shear mixing apparatus (72a) comprising a shear-head impeller (72b) for high shear mixing of the liquid medium and microfibrillated cellulose and, optionally, one or more particulate material, and, optionally one or more additive, to form a flowable slurry; further comprising outlet (73) connected to inlet (31) of second high-speed rotor-stator or rotor-rotor mixing apparatus (30); further comprising an overflow tube for passively conducting flowable slurry first from mixing tank (20) to second mixing tank (70) when an overflow level of mixing tank (20) is reached.

In some embodiments, the method further comprises providing the partially-dried, filtration cake composition comprising microfibrillated cellulose and, optionally, one or more inorganic particulate material, and, optionally one or more additional additive, to the first mixing tank (20) by a feed hopper (10).

In some embodiments, the first and/or second high-shear mixing apparatus (22a) comprising a shear-head impeller (22b) is a dispergator, disperser, overhead stirrer for high-speed, high-shear mixing or Cowles type mixer or other generally vertically oriented shear-head impeller apparatus.

In some embodiments the one or more additive is a biocide, preferably DBNPA typically dosed at about 0 to about 250 ppm or CMIT/MIT typically dosed at about 0 to about 200 ppm. When present, biocide is added after formation of the belt press cake but before storage of the belt press cake composition and transport to the manufacturing location for re-dispersion of the belt cake.

In some embodiments, the one or more additive is a flocculant, preferably a cationic flocculant, for example, polyacrylamide solution (available from BASF) as Percol 3035 or Axchem AF9810. The flocculants are typically dosed at 500 ppm to 4,000 ppm. When present, flocculant is added before formation of the belt press cake.

The described methods also restore viscosity and/or tensile index of the re-dispersed microfibrillated cellulose to within 70% to essentially completely restored levels compared to similar compositions which have never been dried.

In some embodiments, the described method restores viscosity and/or tensile index of the re-dispersed microfibrillated cellulose to within 75% to essentially completely restored levels compared to similar compositions which have never been dried.

In some embodiments, the described method restores viscosity and/or tensile index of the re-dispersed microfibrillated cellulose to within 80% to essentially completely restored levels compared to similar compositions which have never been dried.

In some embodiments, the described method restores viscosity and/or tensile index of the re-dispersed microfibrillated cellulose to within 85% to essentially completely restored levels compared to similar compositions which have never been dried.

In some embodiments, the described method restores viscosity and/or tensile index of the re-dispersed microfibrillated cellulose to within 90% to essentially completely restored levels compared to similar compositions which have never been dried.

In some embodiments, the described method restores viscosity and/or tensile index of the re-dispersed microfibrillated cellulose to within 95% to essentially completely restored levels compared to similar compositions which have never been dried.

In some embodiments, the described method essentially restores viscosity and/or tensile index of the re-dispersed microfibrillated cellulose to essentially completely restored levels compared to similar compositions which have never been dried.

In some embodiments, the filtration cake is a belt press cake.

In some embodiments, the filtration cake is a plate and frame press cake.

In some embodiments the one or more inorganic particulate materials are selected from an alkaline earth metal carbonate or sulphate, such as calcium carbonate, magnesium carbonate, dolomite, gypsum, a hydrous kandite day such as kaolin, halloysite or ball clay, an anhydrous (calcined) kandite clay such as metakaolin or fully calcined kaolin, talc, mica, perlite, bentonite or diatomaceous earth, or magnesium hydroxide, or aluminum trihydrate, or combinations thereof.

In some embodiments, the one or more inorganic particulate material is selected from one or more of kaolin, calcined kaolin, wollastonite, bauxite, talc or mica.

In some embodiments, the one or more inorganic particulate material is calcium carbonate, preferably ground calcium carbonate, precipitated calcium carbonate and mixtures thereof.

In some embodiments, the one or more inorganic particulate material is kaolin clay.

In some embodiments, the one or more inorganic particulate material is hyper-platy kaolin.

In some embodiments, the kaolin clay may typically contain at least about 50% by weight kaolinite, or at least about 75% by weight kaolinite, or at least about 85% by weight kaolinite, or at least about 90% by weight kaolinite, or at least about 95% by weight kaolinite.

In some embodiments, the one or more inorganic particulate material is bentonite.

In some embodiments, the one or more inorganic particulate material is calcium carbonate.

In some embodiments, the one or more inorganic particulate material is ground calcium carbonate.

In some embodiments, the one or more inorganic particulate material is precipitated calcium carbonate.

In some embodiments, the calcium carbonate may be in aragonite, rhombohedral or scalenohedral crystal form.

In some embodiments the first mixing tank (20) has a volume of at least 1 m².

In some embodiments, the fee hopper is 4 m³.

In some embodiments, the first mixing tank 10) and second mixing tank (20) are connected with overflow pipe (30). Once the level of flowable slurry inside first mixing tank (10) reaches overflow level, the flowable slurry is constantly transferred to second mixing tank (20). In some embodiments, overflow pipe (30) may have opening (31) to allow inspection and cleaning of overflow pipe (30).

In some embodiments, first high-shear mixing apparatus and second high shear mixing apparatus are Cowles mixers.

In some embodiments, the first high-shear mixing apparatus and the second high shear mixing apparatus are dispergators.

In another aspect, there is provided a transportable make down system for re-dispersing partially-dried, filtration cake compositions comprising microfibrillated cellulose, and, optionally, one or more inorganic particulate material, and optionally one or more additive, comprising:

a first mixing tank (20) having tank inlet (24); second inlet (25) for provision of liquid medium to the first mixing tank (20); first moderate-to-high-shear mixing apparatus (22a) comprising a shear-head impeller (22b) for moderate-to-high-shear mixing of the liquid medium and microfibrillated cellulose and, optionally, one or more particulate material, and, optionally, one or more additive, to form a flowable slurry; outlet (26) attached to inlet (31) of a high-speed, first high-shear, rotor-stator and/or rotor-rotor mixing apparatus (30) for applying further high-shear to the flowable slurry; further comprising outlet (32); a second high-shear rotor-stator and/or rotor-rotor mixing apparatus (50) comprising inlet (52) connected to the first high-shear rotor-stator and/or rotor-rotor outlet (32) and comprising outlet (53); wherein after application of high-shear to the flowable slurry by the first rotor-stator and/or rotor-rotor mixing apparatus (30) and the second high-shear rotor-stator or rotor-rotor mixing apparatus (50) forms a substantially homogeneous suspension comprising microfibrillated cellulose and, optionally one or more inorganic particulate material, and, optionally, one or more additive; and the substantially homogeneous suspension is retrieved through outlet (53) optionally connected to storage tank (60) or utilized directly in an end-use application or recirculated to an optional third inlet (29) of mixing tank (20) to form a recirculation loop to permit further continuous processing of the substantially homogeneous suspension.

In some embodiments the first high-shear mixing apparatus is a rotor-stator mixing apparatus and the second high-shear mixing apparatus is a rotor-stator mixing apparatus.

In some embodiments, the first high-shear apparatus is a rotor-stator mixing apparatus and the second high-shear mixing apparatus is a rotor-rotor mixing apparatus.

In some embodiments, the first high-shear apparatus is a rotor-rotor mixing apparatus and the second high shear mixing apparatus is a rotor-rotor mixing apparatus.

In some embodiments, the first high-shear apparatus is a rotor-rotor mixing apparatus and the second high-shear mixing apparatus is a rotor-stator mixing apparatus.

In some embodiments, viscosity and/or tensile index of the re-dispersed substantially homogeneous suspension comprising microfibrillated cellulose is restored to within the range of 70% to essentially completely restored levels compared to a similar composition that has never been partially-dried.

In some embodiments, viscosity and/or tensile index of the re-dispersed substantially homogeneous suspension comprising microfibrillated cellulose is restored to within the range of 70% to essentially completely restored levels compared to a similar composition that has never been partially-dried.

In some embodiments, viscosity and/or tensile index of the re-dispersed substantially homogeneous suspension comprising microfibrillated cellulose is restored to within the range of 75% to essentially completely restored levels compared to a similar composition that has never been partially-dried.

In some embodiments, viscosity and/or tensile index of the re-dispersed substantially homogeneous suspension comprising microfibrillated cellulose is restored to within the range of 80% to essentially completely restored levels compared to a similar composition that has never been partially-dried.

In some embodiments, viscosity and/or tensile index of the re-dispersed substantially homogeneous suspension comprising microfibrillated cellulose is restored to within the range of 85% to essentially completely restored levels compared to a similar composition that has never been partially-dried.

In some embodiments, viscosity and/or tensile index of the re-dispersed substantially homogeneous suspension comprising microfibrillated cellulose is restored to within the range of 90% to essentially completely restored levels compared to a similar composition that has never been partially-dried.

In some embodiments, viscosity and/or tensile index of the re-dispersed substantially homogeneous suspension comprising microfibrillated cellulose is restored to within the range of 95% to essentially completely restored levels compared to a similar composition that has never been partially-dried.

In some embodiments, the described method essentially restores viscosity and/or tensile index of the re-dispersed microfibrillated cellulose to essentially completely restored levels compared to similar compositions which have never been dried.

In another aspect, there is provided a method for re-dispersing a partially-dried, filtration cake composition comprising microfibrillated cellulose and, optionally, one or more inorganic particulate material, and, optionally one or more additive in a liquid medium; the method comprising the steps of:

(a) providing a quantity of a dispersing liquid to a first mixing tank;

(b) providing a partially-dried, filtration cake composition comprising microfibrillated cellulose and, optionally, one or more inorganic particulate material; and, optionally one or more additional additive;

(c) optionally, providing one or more additive to the first mixing tank;

wherein, the quantity of partially-dried, filtration cake composition comprising microfibrillated cellulose and, optionally, one or more inorganic particulate material and, optionally one or more additive, has a total solids content of about 8 wt. % to about 60 wt. %, and wherein the dispersing liquid and partially-dried filtration cake has a fibre content of from about 0.5 wt % to about 20 wt % fibre solids, preferably about 0.5 wt. % to about 4 wt. % fibre solids, and more preferably about 1 wt. % to about 2 wt. % fibre solids based on the total solids content of the microfibrillated cellulose and optionally one or more inorganic particulate material, and, optionally, one or more additive;

(c) applying high-shear mixing with a first moderate-to-high-shear mixing apparatus comprising a shear-head impeller to the liquid medium and microfibrillated cellulose and, optionally, one or more inorganic particulate material, and, optionally one or more additive, to form a flowable slurry;

(d) applying further high-shear mixing with a first high-shear rotor-stator or rotor-rotor mixing apparatus and with a second high-shear rotor-stator or rotor-rotor mixing apparatus to the flowable slurry to form a substantially homogeneous suspension of the liquid medium and microfibrillated cellulose and, optionally one or more particulate material and, optionally, one or more additional additive;

(e) recovering the substantially homogeneous suspension of liquid medium and microfibrillated cellulose and, optionally one or more particulate material and, optionally, one or more additional additive, in a storage tank, or utilizing the substantially homogeneous suspension in an end-use application or, optionally, recirculating the substantially homogeneous suspension to the first mixing tank to permit further continuous processing of the substantially homogeneous suspension;

wherein the viscosity of the substantially homogeneous suspension is restored and/or tensile index of the re-dispersed microfibrillated cellulose and, optionally one or more inorganic particulate material, and, optionally, one or more additive, is restored to within the range of 70% to essentially completely restored levels compared to a similar composition that has never been partially-dried.

permit further continuous processing of the substantially homogeneous suspension.

In some embodiments, the first high-shear mixing apparatus is a rotor-stator mixing apparatus and the second high-shear mixing apparatus is a rotor-stator mixing apparatus.

In some embodiments, the first high-shear apparatus is a rotor-stator mixing apparatus and the second high-shear mixing apparatus is a rotor-rotor mixing apparatus.

In some embodiments, the first high-shear apparatus is a rotor-rotor mixing apparatus and the second high shear mixing apparatus is a rotor-rotor mixing apparatus.

In some embodiments, the first high-shear apparatus is a rotor-rotor mixing apparatus and the second high-shear mixing apparatus is a rotor-stator mixing apparatus.

In some embodiments, viscosity and/or tensile index of the re-dispersed substantially homogeneous suspension comprising microfibrillated cellulose is restored to within the range of 70% to essentially completely restored levels compared to a similar composition that has never been partially-dried.

In some embodiments, the flowable slurry is further processed in a second mixing tank having a second moderate-to-high-shear mixing apparatus comprising a shear-head impeller to impart high-shear mixing of the liquid medium and microfibrillated cellulose, and, optionally one or more inorganic particulate material, and, optionally one or more additive.

### BRIEF DESCRIPTION OF THE DRAWINGS

FIGS. 1A and 1B is a schematic of a transportable equipment apparatus and process flow diagram for re-dispersion of microfibrillated cellulose and, optionally, one or more inorganic particulate material, and optional additives. The schematic shown in FIG. 1A does not include a feed hopper. The schematic shown in FIG. 1B includes a feed hopper.

FIGS. 2A and 2B is a schematic of a transportable equipment apparatus and process flow diagram for re-dispersion of microfibrillated cellulose and, optionally, one or more inorganic particulate material, and optional additive, wherein the process or system further comprises a hydrocyclone apparatus. The schematic shown in FIG. 2A does not include a feed hopper. The schematic shown in FIG. 2B includes a feed hopper.

FIG. 3 is a plot of the cumulative particle size distribution via a vibratory sieve technique.

FIG. 4 is a plot of the tensile strength (FLT) results of the Example 4: Control Trial 1. The operating conditions were 3.5% total solids, 50 percentage of pulp (POP), 12 m³/h flow rate, 100% speed BVG Shear-Master, 100% speed on Cowles-blade mixer.

FIG. 5 is a plot of tensile strength (FLT) results of Example 5: Control Trial 2 using a 12″ Sprout Refine. The operating conditions were 0.1 J/m intensity, 20 kWh/DMT of MFC NET Specific energy input per pass, 1320 RPM, 1.111 km/rev cutting-edge length. Total solids was 9% and POP was 50%.

FIG. 6 is a plot of the tensile strength (FLT) results of the Example 6: Control Trial 3 using a Trigonal® SM180. The operating conditions were 5400 RPM, 0.1 mm gap-setting and reduction tool was W3 F.S. GL. The total solids was 9% and POP was 50%.

FIG. 7 is a plot of tensile strength (FLT) results of Example 7: Control Trial 4 using an Atrex® CD650. The operating conditions were: 55 kg/min, 2000 RPM and total solids was varied as shown in the graph legend. Standard 6-ring counter-rotating design developed by Megatrex was used.

FIG. 8 is a plot of tensile strength (FLT) for continuous operation of the Atrex® CD650 rotor-rotor high-shear apparatus. The operating conditions were 2000 RPM, 55 kg/min and 9.7% total solids (average measured). The slurry was cascaded from a feed vessel through the Atrex® and into a buffer tank. For the second pass, the contents of the buffer tank were transferred into the feed vessel and the process repeated

FIG. 9A is a drawing depicting using 6-ring and FIG. 9B depicts 8-ring embodiments of the Atrex® counter rotating rotor-rotor rings.

FIG. 10 is a plot of the tensile strength (FLT) results obtained using FLT results for the Atrex® 8-ring design (first pass) with pre-wetting using a Silverson® batch mixer. The operating conditions were—55 kg/min, 2000 RPM and 9.7% total solids (average measured). The POP was 50%.

FIG. 11 is a plot of tensile strength (FLT) results for the Atrex® 8-ring design (first and second pass) with pre-wetting using a Silverson® batch mixer. Results are shown against cumulative energy input (gross).

FIG. 12 is a plot of tensile strength (FLT) results of the inventive system and process (single pass) at two different solids concentrations.

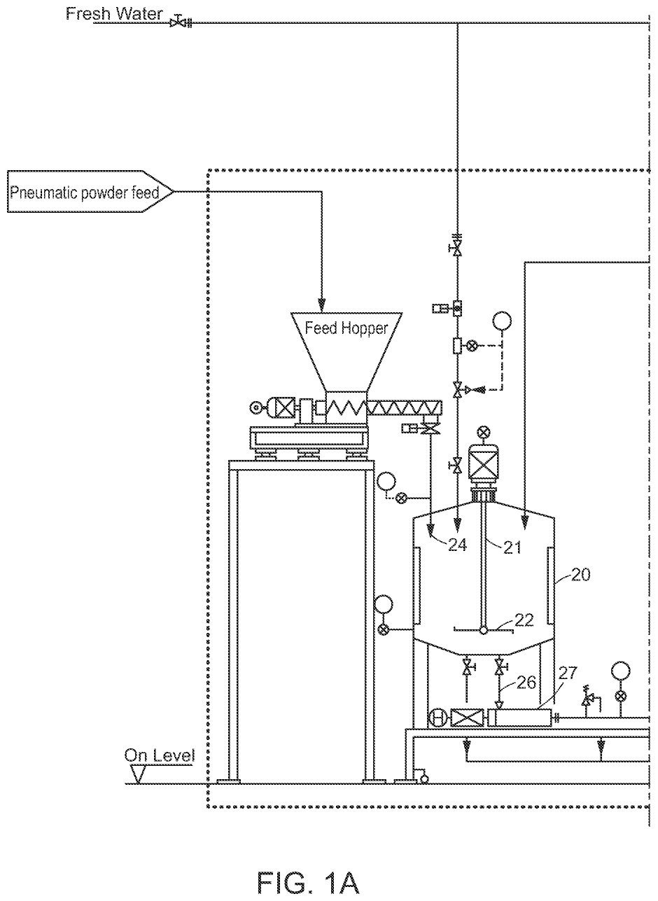

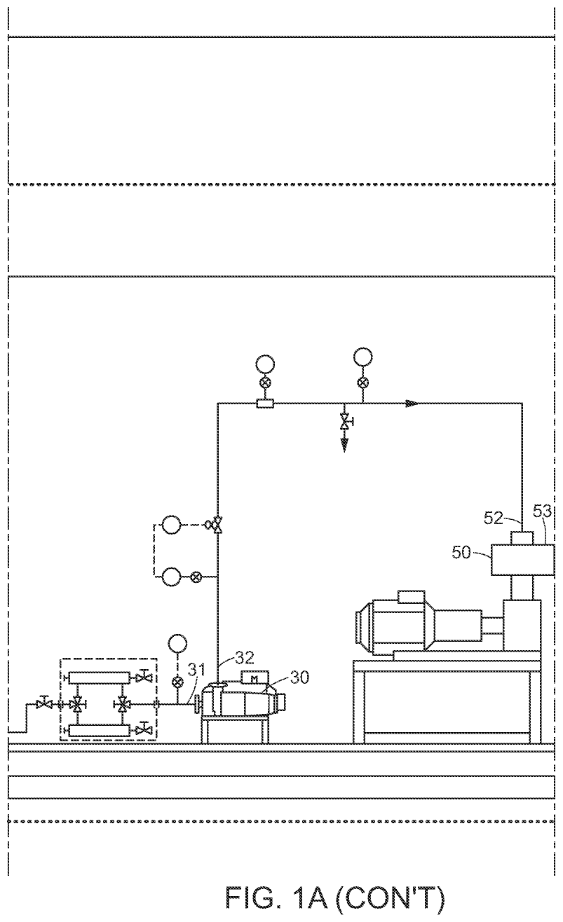

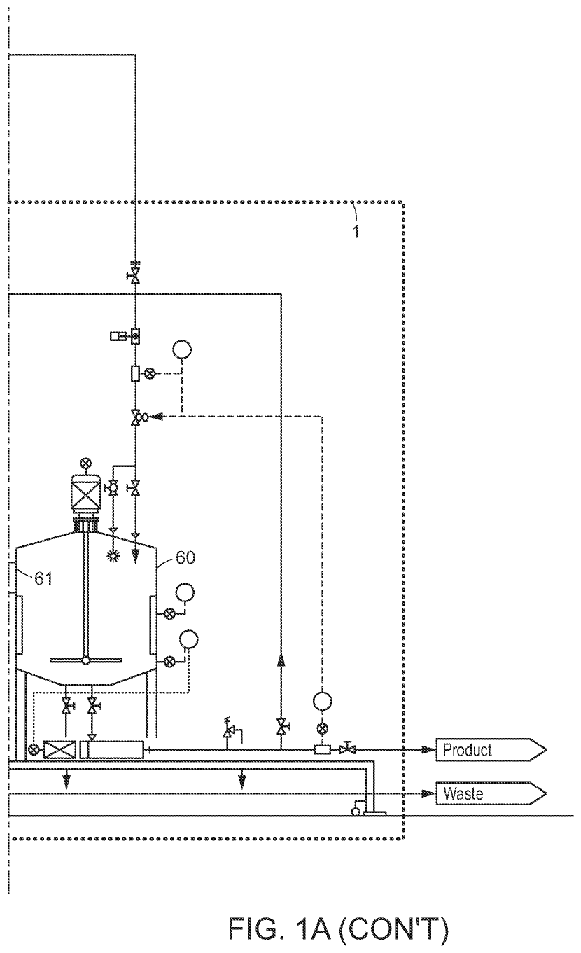

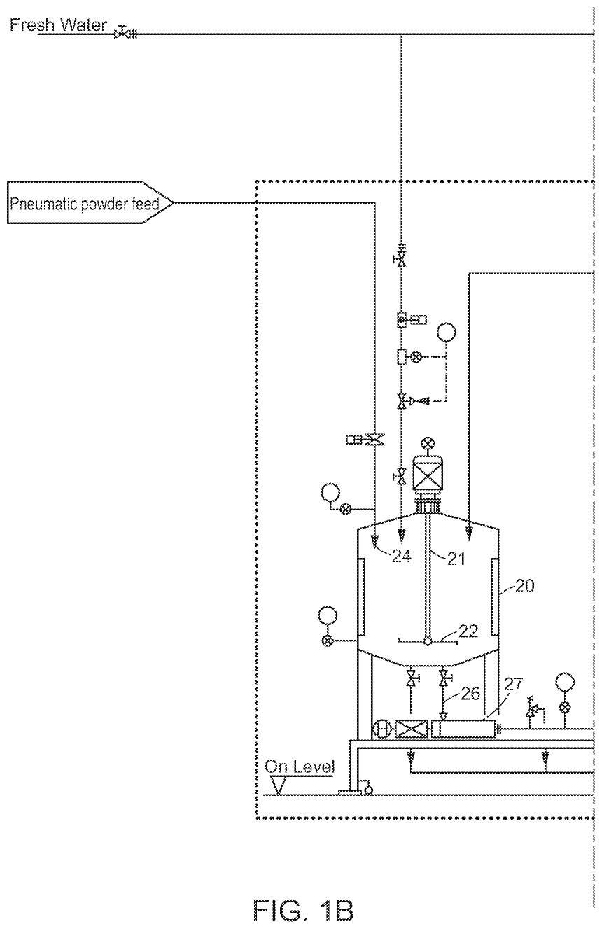

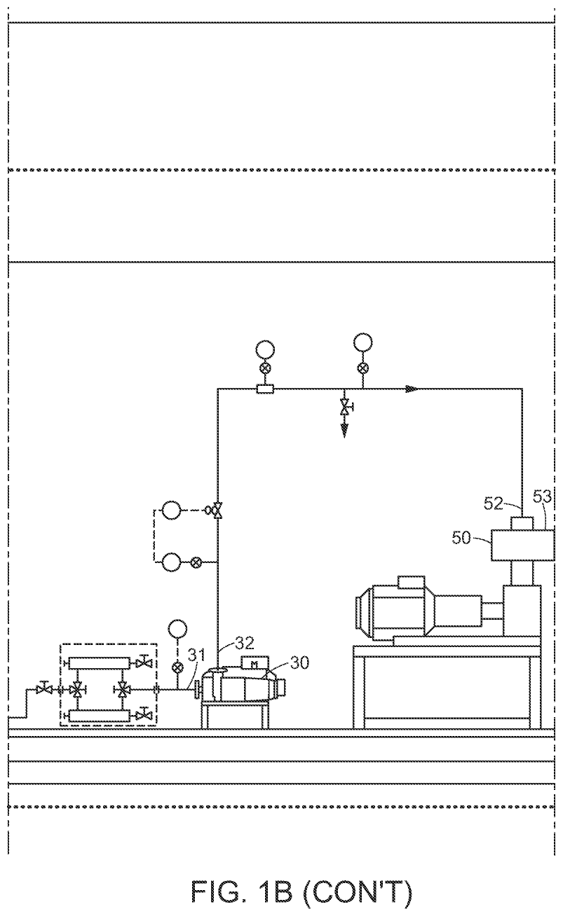

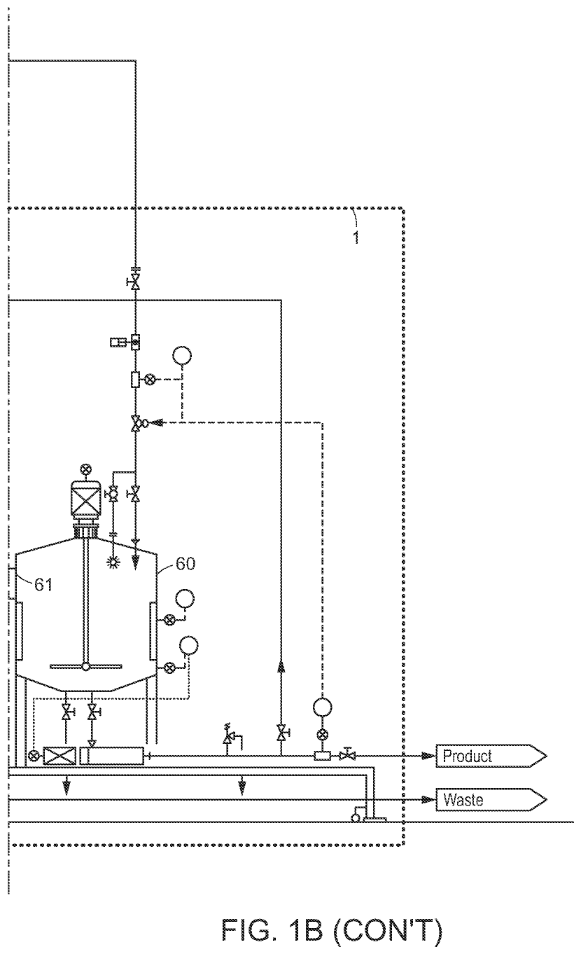

### DETAILED DESCRIPTION OF THE INVENTION

### Certain Definitions

The titles, headings and subheadings provided herein should not be interpreted as limiting the various aspects of the disclosure. Accordingly, the terms defined below are more fully defined by reference to the specification in its entirety. All references cited herein are incorporated by reference in their entirety.

Unless otherwise defined, scientific and technical terms used herein shall have the meanings that are commonly understood by those of ordinary skill in the art. Further, unless otherwise required by context, singular terms shall include pluralities and plural terms shall include the singular.

In this application, the use of “or” means “and/or” unless stated otherwise. In the context of a multiple dependent claim, the use of “or” refers back to more than one preceding independent or dependent claim in the alternative only. The use of the word “a” or “an” when used in conjunction with the term “comprising” may mean “one,” but it is also consistent with the meaning of “one or more,” “at least one,” and “one or more than one.” The use of the term “or” is used to mean “and/or” unless explicitly indicated to refer to alternatives only if the alternatives are mutually exclusive, although the disclosure supports a definition that refers to only alternatives and “and/or.”

Throughout this application, the term “about” is used to indicate that a value includes the inherent variation of error for the quantifying device, the method being employed to determine the value, or the variation that exists among the study subjects. For example, but not by way of limitation, when the term “about” is utilized, the designated value may vary by plus or minus twelve percent, or eleven percent, or ten percent, or nine percent, or eight percent, or seven percent, or six percent, or five percent, or four percent, or three percent, or two percent, or one percent. The use of the term “at least one” will be understood to include one as well as any quantity more than one, including but not limited to, 1, 2, 3, 4, 5, 10, 15, 20, 30, 40, 50, 100, etc. The term “at least one” or “one or more” may extend up to 100 or 1000 or more depending on the term to which it is attached. In addition, the quantities of 100/1000 are not to be considered limiting as lower or higher limits may also produce satisfactory results. In addition, the use of the term “at least one of X, Y, and Z” will be understood to include X alone, Y alone, and Z alone, as well as any combination of X, Y, and Z. The use of ordinal number terminology (i.e., “first”, “second”, “third”, “fourth”, etc.) is solely for the purpose of differentiating between two or more items and, unless otherwise stated, is not meant to imply any sequence or order or importance to one item over another or any order of addition.

As used herein, the terms “comprising” (and any form of comprising, such as “comprise”, “comprises”, and “comprised”), “having” (and any form of having, such as “have” and “has”), “including” (and any form of including, such as “includes” and “include”), or “containing” (and any form of containing, such as “contains” and “contain”), are inclusive or open-ended and do not exclude additional, un-recited elements or method steps. Additionally, a term that is used in conjunction with the term “comprising” is also understood to be able to be used in conjunction with the term “consisting of” or “consisting essentially of”.

By “deagglomerate,” “de-agglomerate,” ‘de-agglomeration, and the like, is meant a process of breaking up agglomerates.

By “essentially-dried” or “dry” is meant that the water content of an aqueous composition comprising microfibrillated cellulose, and, optionally, one or more inorganic particulate material is reduced by at least about 95% by weight water.

By “partially-dried” or “partially-dry” is meant that the water content of the aqueous composition comprising microfibrillated cellulose is reduced by an amount less than 95% by weight. In certain embodiments, “partially-dried” or “partially-dry” means that the water content of the aqueous composition comprising microfibrillated cellulose is reduced by at least 25%, or by at least 30% by weight, or by at least 35% by weight, or by at least 40% by weight, or by at least 45% by weight, or by at least 50% by weight, or by at least 55%, by weight, or by at least 60% by weight, or by at least 65% by weight, or by at least 70% by weight, or by at least 75% by weight, or by at least 80% by weight, or by at least 85% by weight, or by at least 90% by weight, or by at least 95% by weight.

In certain embodiments, the total solids range of the filtration cake is about 8% to about 60% total solids.

In some embodiments, the fibre content of the liquid medium and filtration cake comprising microfibrillated cellulose and, optionally, one or more inorganic particulate material, and, optionally, one or more additive is about 0.5 wt. % to about 20 wt. %, preferably, about 0.5 wt. % to about 4 wt. % or more preferably about 1 wt. % to 2 wt. %.

In an embodiment, the aqueous suspension is treated to remove at least a portion or substantially all of the water to form a partially-dried. For example, at least about 10% by volume of water in the aqueous suspension may be removed from the aqueous suspension, for example, at least about 20% by volume, or at least about 30% by volume, or least about 40% by volume, or at least about 50% by volume, or at least about 60% by volume, or at least about 70% by volume or at least about 80% by volume or at least about 90% by volume, or at least 95% by volume water from the aqueous suspension including, for example, by gravity or vacuum-assisted drainage, with or without pressing, or by evaporation, or by filtration, or by a combination of these techniques. The partially-dried or essentially-dried composition will comprise microfibrillated cellulose and, optionally one or more inorganic particulate material and one or more optional additive that may have been added to the aqueous suspension prior to drying. The partially-dried product may be stored or packaged for sale. The partially-dried or essentially-dried product may be optionally re-hydrated and incorporated in papermaking compositions and other paper products, as described herein.

Various methods are known to the skilled person for preparing partially-dried compositions comprising microfibrillated cellulose and, optionally, one or more inorganic particulate material. For example, methods disclosed in the prior art and which are incorporated herein by reference in their entirety are disclosed in U.S. Pat. Nos. 10,435,482 and 11,001,644.

The process of U.S. Pat. No. 10,435,482, is described as a method of improving the physical and/or mechanical properties of re-dispersed dried or partially-dried microfibrillated cellulose, the method comprising: (a) providing an aqueous composition of microfibrillated cellulose; (b) dewatering the aqueous composition by one or more of: i. dewatering by belt press, ii. a high pressure automated belt press, iii. centrifuge, iv. tube press, v. screw press, and vi. rotary press; to produce a dewatered microfibrillated cellulose composition; (c) drying the dewatered microfibrillated cellulose composition by one or more of: i. a fluidized bed dryer, ii. microwave and/or radio frequency dryer, iii. a hot air swept mill or dryer, a cell mill or a multirotor cell mill, and iv. freeze drying; to produce a dried or partially-dried microfibrillated cellulose composition; and (d) re-dispersing the dried or at least partially dried microfibrillated cellulose in a liquid medium; wherein the microfibrillated cellulose has a tensile index and/or viscosity which is at least 50% of the tensile index and/or viscosity of the aqueous composition of microfibrillated cellulose prior to drying at a comparable concentration and a fibre steepness of from 20 to 50.

The process of U.S. Pat. No. 11,001,644 is described as a method of improving the physical and/or mechanical properties of redispersed dried or partially dried microfibrillated cellulose, the method comprising: (a) providing an aqueous composition of microfibrillated cellulose, wherein the microfibrillated cellulose is obtained from a recycled pulp, or a papermill broke, or a papermill waste stream, or waste from a papermill; (b) dewatering the aqueous composition by one or more of: dewatering by belt press, a high pressure automated belt press, iii. centrifuge, tube press, screw press, and rotary press to produce a dewatered microfibrillated cellulose composition; (c) drying the dewatered microfibrillated cellulose composition by one or more of: i. a fluidized bed dryer, ii. microwave and/or radio frequency dryer, a hot air swept mill or dryer, a cell mill or a multirotor cell mill, and freeze drying to produce a dried or partially dried microfibrillated cellulose composition; and (d) re-dispersing the dried or at least partially dried microfibrillated cellulose in a liquid medium; wherein the microfibrillated cellulose has a tensile index and/or viscosity which is at least 50% of the tensile index and/or viscosity of the aqueous composition of microfibrillated cellulose prior to drying at a comparable concentration and a fibre steepness of from 20 to 50. Alternative processes for re-dispersing partially-dried or essentially-dried microfibrillated cellulose are disclosed in U.S. Patent Publication No. 20200263358A1, which method is incorporated herein by reference in its entirety.

In U.S. Patent Publication No. 20200263358 there is provided a method for re-dispersing dewatered, partially dried or essentially dried microfibrillated cellulose, the method comprising the steps of: (a) adding a quantity of a suitable dispersing liquid to a tank having at least a first and a second inlet and an outlet, wherein the tank further comprises a mixer and a pump attached to the outlet; (b) adding a quantity of dewatered, partially dried or essentially dried microfibrillated cellulose to the tank through the first inlet in sufficient quantity to yield a liquid composition of microfibrillated cellulose at a desired solids concentration of 0.5 to 5% fibre solids; (c) mixing the dispersing liquid and the dewatered, partially dried or essentially dried microfibrillated cellulose in the tank with the mixer to partially de-agglomerate and re-disperse the microfibrillated cellulose to form a flowable slurry; (d) pumping the flowable slurry with the pump to an inlet of a flow cell, wherein the flow cell comprises a recirculation loop and one or more sonication probe in series and at least a first and a second outlet, wherein the second outlet of the flow cell is connected to the second inlet of the tank, thereby providing for a continuous recirculation loop providing for the continuous application of ultrasonic energy to the slurry for a desired time period and/or total energy, wherein the flow cell comprises an adjustable valve at the second outlet to create back pressure of the recirculated slurry, further wherein the liquid composition comprising microfibrillated cellulose of step (c) is continuously recirculated through the recirculation loop at an operating pressure of 0 to 4 bar and at a temperature of 20° C. to 50° C.; (e) applying an ultrasonic energy input to the slurry of 200 to 10,000 kWh/t continuously by the sonication probe at a frequency range of 19 to 100 kHz and at an amplitude of up to 60%, up to 100% or up to 200% to the physical limitations of the sonicator used for 1 to 120 minutes; (f) collecting the re-dispersed suspension comprising microfibrillated cellulose with enhanced tensile index and/or viscosity properties from the first outlet of the flow cell in a suitable holding vessel.

The terms “re-dispersion,” “re-dispersing,” and “re-dispersed” refer to the suspension of dried and, optionally, pulverized, micro-fibrillated cellulose and, optionally, one or more inorganic particulate material in an aqueous medium to achieve a comparable tensile index property as before drying had occurred. This is characterised by the “tensile index” or “FLT index.”

As used herein, “FLT Index” is a tensile strength measurement performed in accordance with the procedures of Example 1.

The FLT index is a tensile test developed to assess the quality of microfibrillated cellulose and re-dispersed microfibrillated cellulose. The Percentage of Pulp (“POP”) of the test material is adjusted to 20% by adding whichever inorganic particulate was used in the production of the microfibrillated cellulose/inorganic material composite (in the case of inorganic particulate free microfibrillated cellulose then 60 wt %<2 μm GCC calcium carbonate is used). A 220 gsm sheet is formed from this material using a bespoke Buchner filtration apparatus. The resultant sheet is conditioned and its tensile index measured using an industry standard tensile tester.

As used herein, the term “include” and its grammatical variants are intended to be non-limiting, such that recitation of items in a list is not to the exclusion of other like items that can be substituted or added to the listed items.

As used herein, “mechanical properties” of the partially-dried MFC compositions include one or more of the following: Tensile Strength, Tensile Elongation, Tensile Index, Burst Strength, Tear Strength, Tear Index, Scott Bond, Breaking Energy and Breaking Elongation.

As used herein, the term “pulverize,” “pulverized,” and “pulverization” mean the mechanical disintegration of MFC press-cake into a powder.

As used herein, a mixer with a shear head impeller imparts at least “moderate to high-shear” to the partially-dried, and optionally, pulverized, composition comprising microfibrillated cellulose or microfibrillated cellulose and one or more inorganic particulate material composition, and, optionally one or more additive. An example of a moderate-to-high-shear mixer useful in the present invention is a Cowles-blade (radial-flow impeller) inside a holding vessel, where, for example, tip speeds less than 20 m/s are encountered with an impeller (D) to tank (T) diameter less than 0.5, i.e., D/T<0.5. Other exemplary mixers include various propeller mixers, dual shaft and triple shaft mixers, (e.g., Ross mixers), dispersers having blade mixers, Silverson® mixers, Myers mixers, PVC mixers, and other similar generic mixers as known by the skilled person.

As used herein a rotor-stator mixer, for example, a Trigonal® mixer (Siefer-Trigonal machine), or more generally a colloid mill, or a refiner, or a deflaker or a BVG ShearMaster® rotor-stator mixing apparatus, which impart relatively higher shear-rates, depending on required shear-levels and physical limits of the design compared to a shear head mixer imparting moderate shear. Another apparatus includes a Cavitron® rotor-stator mixer supplied by Hagen & Funke GmbH. Sprockhovel, Germany. Feed flows typically within the range 7 to 16 m³/hr but can handle flows of up to 35 m³/h if required, High Shear mixer is controlled off a VSD drive to vary the amount of energy input.

As used herein, a “rotor-rotor mixer” produces high and focused shear with high viscosity slurries compared to conventional mixers. Rotor-rotor mixers have two counter-rotating mixing elements (rotors) which are capable of imparting high shear forces. Due to the geometry of the mixer, the liquid slurry is forced through a zone of high shear forces formed by the rotors. An exemplary rotor-rotor mixer is an Atrex® mixer supplied by Megatrex Oy, Lempäälä, Finland. Alternative apparatus include an ultra-fine friction grinder (Supermasscolloider® available from Masuko Sangyo Co. Ltd., Japan. An example of an Atrex® mixer is a rotor-rotor dispergator, model G30, diameter 500 mm, 6 rotor peripheries, rotation speed applied 1500 rpm (counter-rotating rotors). The preferred gap width is less than 10 mm and preferably less than 5 mm. So-called rotor-rotor dispergators, where a series of frequently repeated impacts to the dispersion are caused by blades of several rotors that rotate in opposite directions. Atrex® dispergator is an example of such a dispergator. The adjacent rotors rotated in opposite directions at 1500 rpm.

Fibrous Substrate Comprising Cellulose

The fibrous substrate comprising cellulose (variously referred to herein as “fibrous substrate comprising cellulose,” “cellulose fibres,” “fibrous cellulose feedstock,” “cellulose feedstock” and “cellulose-containing fibres (or fibrous,” etc.) may be derived from virgin or recycled pulp.

As used herein, the term “substantially” means that the subsequently described event or circumstance completely occurs or that the subsequently described event or circumstance occurs to a great extent or degree. For example, when associated with a particular event or circumstance, the term “substantially” means that the subsequently described event or circumstance occurs at least 80% of the time, or at least 85% of the time, or at least 90% of the time, or at least 95% of the time. In the context of “substantially homogenous suspension” the suspension is understood to have minimal aggregates.

As used herein, “viscosity” is measured in accordance with the procedures of Example 2.

Unless otherwise stated, particle size properties referred to herein for the inorganic particulate materials are as measured in a well-known manner by sedimentation of the particulate material in a fully dispersed condition in an aqueous medium using a Sedigraph 5100 machine as supplied by Micromeritics Instruments Corporation, Norcross, Ga., USA (telephone: +1 770 662 3620; web-site: www.micromeritics.com), referred to herein as a “Micromeritics Sedigraph 5100 unit”. Such a machine provides measurements and a plot of the cumulative percentage by weight of particles having a size, referred to in the art as the “equivalent spherical diameter” (e.s.d), less than given e.s.d values. The mean particle size d₅₀ is the value determined in this way of the particle e.s.d at which there are 50% by weight of the particles which have an equivalent spherical diameter less than that d₅₀ value.

Alternatively, where stated, the particle size properties referred to herein for the inorganic particulate materials are as measured by the well-known conventional method employed in the art of laser light scattering, using a Malvern Mastersizer S machine as supplied by Malvern Instruments Ltd (or by other methods which give essentially the same result). In the laser light scattering technique, the size of particles in powders, suspensions and emulsions may be measured using the diffraction of a laser beam, based on an application of Mie theory. Such a machine provides measurements and a plot of the cumulative percentage by volume of particles having a size, referred to in the art as the “equivalent spherical diameter” (e.s.d), less than given e.s.d values. The mean particle size d₅₀ is the value determined in this way of the particle e.s.d at which there are 50% by volume of the particles which have an equivalent spherical diameter less than that d₅₀ value.

As used herein, the phrase “integer from X to Y” means any integer that includes the endpoints. For example, the phrase “integer from 1 to 5” means 1, 2, 3, 4, or 5.

Microfibrillated Cellulose

Microfibrillated cellulose (“MFC”), although well-known and described in the art, for purposes of the presently disclosed and/or claimed inventive concept(s), is defined as cellulose consisting of microfibrils in the form of either isolated cellulose microfibrils and/or microfibril bundles of cellulose, both of which are derived from a cellulose raw material. Thus, microfibrillated cellulose is understood to comprise partly or totally fibrillated cellulose or lignocellulose fibers, which may be achieved by a variety of processes known in the art.

As used herein, “microfibrillated cellulose” can be used interchangeably with “microfibrillar cellulose,” “nanofibrillated cellulose,” “nanocellulose,” “nanofibril cellulose,” “nanofibers of cellulose,” “nanoscale fibrillated cellulose,” “microfibrils of cellulose,” and/or simply as “MFC.” Additionally, as used herein, the terms listed above that are interchangeable with “microfibrillated cellulose” may refer to cellulose that has been completely microfibrillated or cellulose that has been substantially microfibrillated but still contains an amount of non-microfibrillated cellulose at levels that do not interfere with the benefits of the microfibrillated cellulose as described and/or claimed herein.

By “microfibrillating” is meant a process in which microfibrils of cellulose are liberated or partially liberated as individual species or as small aggregates as compared to the fibres of the pre-microfibrillated pulp. Typical cellulose fibres (i.e., pre-microfibrillated pulp) suitable for use in papermaking include larger aggregates of hundreds or thousands of individual cellulose fibrils.

Microfibrillated cellulose comprises cellulose, which is a naturally occurring polymer comprising repeated glucose units. The term “microfibrillated cellulose”, also denoted MFC, as used in this specification includes microfibrillated/microfibrillar cellulose and nano-fibrillated/nanofibrillar cellulose (NFC), which materials are also called nanocellulose.

Microfibrillated cellulose is prepared by stripping away the outer layers of cellulose fibers that may have been exposed through mechanical shearing, with or without prior enzymatic or chemical treatment. There are numerous methods of preparing microfibrillated cellulose that are known in the art.

In a non-limiting example, the term microfibrillated cellulose is used to describe fibrillated cellulose comprising nanoscale cellulose particle fibers or fibrils frequently having at least one dimension less than 100 nm. When liberated from cellulose fibres, fibrils typically have a diameter less than 100 nm. The actual diameter of cellulose fibrils depends on the source and the manufacturing methods.

The particle size distribution and/or aspect ratio (length/width) of the cellulose microfibrils attached to the fibrillated cellulose fiber or as a liberated microfibril depends on the source and the manufacturing methods employed in the microfibrillation process.

In a non-limiting example, the aspect ratio of microfibrils is typically high and the length of individual microfibrils may be more than one micrometer and the diameter may be within a range of about 5 to 60 nm with a number-average diameter typically less than 20 nm. The diameter of microfibril bundles may be larger than 1 micron, however, it is usually less than one.

In a non-limiting example, the smallest fibril is conventionally referred to as an elementary fibril, which generally as a diameter of approximately 2-4 nm. It is also common for elementary fibrils to aggregate, which may also be considered as microfibrils.

In a non-limiting example, the microfibrillated cellulose may at least partially comprise nanocellulose. The nanocellulose may comprise mainly nano-sized fibrils having a diameter that is less than 100 nm and a length that may be in the micron-range or lower. The smallest microfibrils are similar to the so-called elemental fibrils, the diameter of which is typically 2 to 4 nm. Of course, the dimensions and structures of microfibrils and microfibril bundles depend on the raw materials used in addition to the methods of producing the microfibrillated cellulose. Nonetheless, it is expected that a person of ordinary skill in the art would understand the meaning of “microfibrillated cellulose” in the context of the presently disclosed and/or claimed inventive concept(s).

Depending on the source of the cellulose fibers and the manufacturing process employed to microfibrillate the cellulose fibres, the length of the fibrils can vary, frequently from about 1 to greater than 10 micrometers.

A coarse MFC grade might contain a substantial fraction of fibrillated fibers, i.e. protruding fibrils from the tracheid (cellulose fiber), and with a certain amount of fibrils liberated from the tracheid (cellulose fiber).

In certain embodiments, the microfibrillated cellulose has a d₅₀ ranging from about 5 μm to about 500 μm, as measured by laser light scattering. In certain embodiments, the microfibrillated cellulose has a d₅₀ of equal to or less than about 400 μm, for example equal to or less than about 300 μm, or equal to or less than about 200 μm, or equal to or less than about 150 μm, or equal to or less than about 125 μm, or equal to or less than about 100 μm, or equal to or less than about 90 μm, or equal to or less than about 80 μm, or equal to or less than about 70 μm, or equal to or less than about 60 μm, or equal to or less than about 50 μm, or equal to or less than about 40 μm, or equal to or less than about 30 μm, or equal to or less than about 20 μm, or equal to or less than about 10 μm.

In certain embodiments, the microfibrillated cellulose has a modal fibre particle size ranging from about 0.1-500 μm.

In certain embodiments, the microfibrillated cellulose has a modal fibre particle size of at least about 0.5 μm, for example at least about 10 μm, or at least about 50 μm, or at least about 100 μm, or at least about 150 μm, or at least about 200 μm, or at least about 300 μm, or at least about 400 μm

In an embodiment, the microfibrillated cellulose may also be prepared from recycled pulp or a papermill broke and/or industrial waste, or a paper streams rich in mineral fillers and cellulosic materials from a papermill.

The microfibrillated cellulose may, for example, be treated prior to dewatering and/or drying. For example, one or more additives as specified below (e.g. salt, sugar, glycol, urea, glycol, carboxymethyl cellulose, guar gum, or a combination thereof as specified below) may be added to the microfibrillated cellulose. For example, one or more oligomers (e.g. with or without the additives specified above) may be added to the microfibrillated cellulose. For example, one or more inorganic particulate materials may be added to the microfibrillated cellulose to improve dispersibility (e.g. talc or minerals having a hydrophobic surface-treatment such as a stearic acid surface-treatment (e.g. stearic acid treated calcium carbonate). The additives may, for example, be suspended in low dielectric solvents. The microfibrillated cellulose may, for example, be in an emulsion, for example an oil/water emulsion, prior to dewatering and/or drying. The microfibrillated cellulose may, for example, be in a masterbatch composition, for example a polymer masterbatch composition and/or a high solids masterbatch composition, prior to dewatering and/or drying. The microfibrillated cellulose may, for example, be a high solids composition (e.g. solids content equal to or greater than about 60 wt % or equal to or greater than about 70 wt % or equal to or greater than about 80 wt % or equal to or greater than about 90 wt % or equal to or greater than about 95 wt % or equal to or greater than about 98 wt % or equal to or greater than about 99 wt %) prior to dewatering and/or drying. Any combination of one or more of the treatments may additionally or alternatively be applicable to the microfibrillated cellulose after dewatering and drying but prior to or during re-dispersion.

The fibrous substrate comprising cellulose may be added to a grinding vessel fibrous substrate comprising cellulose in a dry state. For example, a dry paper broke may be added directly to the grinder vessel. The aqueous environment in the grinder vessel will then facilitate the formation of a pulp.

Various methods of producing microfibrillated cellulose (“MFC”) are known in the art. Certain methods and compositions comprising microfibrillated cellulose produced by grinding procedures are described in WO 2010/131016. Husband, J. C., Svending, P., Skuse, D. R., Motsi, T., Likitalo, M., Coles, A., FiberLean Technologies Ltd., 2015, “Paper filler composition,” PCT International Application No. WO 2010/131016. Paper products comprising such microfibrillated cellulose have been shown to exhibit excellent paper properties, such as paper burst and tensile strength. The methods described in WO 2010/131016 also enable the production of microfibrillated cellulose economically.

WO 2007/091942 A1 describes a process, in which chemical pulp is first refined, then treated with one or more wood degrading enzymes, and finally homogenized to produce MFC as the final product. The consistency of the pulp is taught to be preferably from 0.4 to 10%. The advantage is said to be avoidance of clogging in the high-pressure fluidizer or homogenizer.

WO 2010/131016 describes a grinding procedure for the production of microfibrillated cellulose with or without inorganic particulate material. Such a grinding procedure is described below. In an embodiment of the process set forth in WO 2010/131016, the contents of which is hereby incorporated by reference in its entirety, the process utilizes mechanical disintegration of cellulose fibres to produce microfibrillated cellulose (“MFC”) cost-effectively and at large scale, without requiring cellulose pre-treatment. An embodiment of the method uses stirred media detritor grinding technology, which disintegrates fibres into MFC by agitating grinding media beads. In this process, a mineral such as calcium carbonate or kaolin is added as a grinding aid, greatly reducing the energy required. Husband, J. C., Svending, P., Skuse, D. R., Motsi, T., Likitalo, M., Coles, A., FiberLean Technologies Ltd., 2015, “Paper filler composition,” U.S. Pat. No. 9,127,405B2.

Preparing the Aqueous Suspension of Microfibrillated Cellulose and Inorganic Particulate Material.

In certain embodiments, the composition comprising microfibrillated cellulose is obtainable by a process comprising microfibrillating a fibrous substrate comprising cellulose in the presence of a grinding medium. The process is advantageously conducted in an aqueous environment.

The particulate grinding medium, when present, may be of a natural or a synthetic material. The grinding medium may, for example, comprise balls, beads or pellets of any hard mineral, ceramic or metallic material. Such materials may include, for example, alumina, zirconia, zirconium silicate, aluminum silicate or the mullite-rich material which is produced by calcining kaolinitic clay at a temperature in the range of from about 1300° C. to about 1800° C. For example, in some embodiments a Carbolite® grinding media is preferred. Alternatively, particles of natural sand of a suitable particle size may be used.

The grinding may be carried out in one or more stages. For example, a coarse inorganic particulate material may be ground in the grinder vessel to a predetermined particle size distribution, after which the fibrous material comprising cellulose is added and the grinding continued until the desired level of microfibrillation has been obtained. The coarse inorganic particulate material used in accordance with an aspect of this invention initially may have a particle size distribution in which less than about 20% by weight of the particles have an equivalent spherical diameter (e.s.d.) of less than 2 μm for example, less than about 15% by weight, or less than about 10% by weight of the particles have an e.s.d. of less than 2 μm. In another embodiment, the coarse inorganic particulate material used in accordance with an aspect of this invention initially may have a particle size distribution, as measured using a Malvern Insitec or equivalent apparatus, in which less than about 20% by volume of the particles have an e.s.d of less than 2 μm for example, less than about 15% by volume, or less than about 10% by volume of the particles have an e.s.d. of less than 2 μm. In another embodiment, the fibrous material containing cellulose may be ground in the presence of a grinding medium and in the absence of inorganic particulate matter, as described below.

The coarse inorganic particulate material may be wet or dry ground in the absence or presence of a grinding medium. In the case of a wet grinding stage, the coarse inorganic particulate material is preferably ground in an aqueous suspension in the presence of a grinding medium. In such a suspension, the coarse inorganic particulate material may preferably be present in an amount of from about 5% to about 85% by weight of the suspension; more preferably in an amount of from about 20% to about 80% by weight of the suspension. Most preferably, the coarse inorganic particulate material may be present in an amount of about 30% to about 75% by weight of the suspension. As described above, the coarse inorganic particulate material may be ground to a particle size distribution such that at least about 10% by weight of the particles have an e.s.d of less than 2 μm, for example, at least about 20% by weight, or at least about 30% by weight, or at least about 40% by weight, or at least about 50% by weight, or at least about 60% by weight, or at least about 70% by weight, or at least about 80% by weight, or at least about 90% by weight, or at least about 95% by weight, or about 100% by weight of the particles, have an e.s.d of less than 2 μm after which the cellulose pulp is added and the two components are co-ground to microfibrillate the fibres of the cellulose pulp. In another embodiment, the coarse inorganic particulate material is ground to a particle size distribution, as measured using a Malvern Insitec apparatus (or equivalent) such that at least about 10% by volume of the particles have an e.s.d of less than 2 μm, for example, at least about 20% by volume, or at least about 30% by volume or at least about 40% by volume, or at least about 50% by volume, or at least about 60% by volume, or at least about 70% by volume, or at least about 80% by volume, or at least about 90% by volume, or at least about 95% by volume, or about 100% by volume of the particles, have an e.s.d of less than 2 μm after which the cellulose pulp is added and the two components are co-ground to microfibrillate the fibres of the cellulose pulp.

Generally, the type of and particle size of grinding medium to be selected for use in the invention may be dependent on the properties, e.g., the particle size of, and the chemical composition of, the feed suspension of material to be ground. Preferably, the particulate grinding medium comprises particles having an average diameter in the range of from about 0.1 mm to about 6.0 mm and, more preferably, in the range of from about 0.2 mm to about 4.0 mm. The grinding medium (or media) may be present in an amount up to about 70% by volume of the charge. The grinding media may be present in amount of at least about 10% by volume of the charge, for example, at least about 20% by volume of the charge, or at least about 30% by volume of the charge, or at least about 40% by volume of the charge, or at least about 50% by volume of the charge, or at least about 60% by volume of the charge.

Unless otherwise stated, particle size properties of the microfibrillated cellulose materials are as measured by the well-known conventional method employed in the art of laser light scattering, using a Malvern Insitec apparatus (or equivalent), as supplied by Malvern Instruments Ltd (or by other methods which give essentially the same result.

The fibrous substrate comprising cellulose may be in the form of a pulp (i.e., a suspension of cellulose fibres in water), which may be prepared by any suitable chemical or mechanical treatment, or combination thereof.

Details of the procedure used to characterise the particle size distributions of mixtures of inorganic particle material and microfibrillated cellulose using a Malvern Insitec apparatus (or equivalent) are provided below.

The fibrous substrate comprising cellulose may be microfibrillated in the presence of an inorganic particulate material to obtain microfibrillated cellulose having a d₅₀ ranging from about 5 μm to about 500 μm, as measured by laser light scattering. The fibrous substrate comprising cellulose may be microfibrillated in the presence of an inorganic particulate material to obtain microfibrillated cellulose having a d₅₀ of equal to or less than about 400 μm, for example equal to or less than about 300 μm, or equal to or less than about 200 μm, or equal to or less than about 150 μm, or equal to or less than about 125 μm, or equal to or less than about 100 μm, or equal to or less than about 90 μm, or equal to or less than about 80 μm, or equal to or less than about 70 μm, or equal to or less than about 60 μm, or equal to or less than about 50 μm, or equal to or less than about 40 μm, or equal to or less than about 30 μm, or equal to or less than about 20 μm, or equal to or less than about 10 μm.

The fibrous substrate comprising cellulose may be microfibrillated in the presence of an inorganic particulate material to obtain microfibrillated cellulose having a modal fibre particle size ranging from about 0.1-500 μm and a modal inorganic particulate material particle size ranging from 0.25-20 μm. The fibrous substrate comprising cellulose may be microfibrillated in the presence of an inorganic particulate material to obtain microfibrillated cellulose having a modal fibre particle size of at least about 0.5 μm, for example at least about 10 μm, or at least about 50 μm, or at least about 100 μm, or at least about 150 μm, or at least about 200 μm, or at least about 300 μm, or at least about 400 μm.

The fibrous substrate comprising cellulose may be microfibrillated in the presence of an inorganic particulate material to obtain microfibrillated cellulose having a fibre steepness equal to or greater than about 10, as measured by Malvern. Fibre steepness (i.e., the steepness of the particle size distribution of the fibres) is determined by the following formula:

Steepness=100×(d₃₀/d₇₀).

The microfibrillated cellulose may have a fibre steepness equal to or less than about 100. The microfibrillated cellulose may have a fibre steepness equal to or less than about 75, or equal to or less than about 50, or equal to or less than about 40, or equal to or less than about 30. The microfibrillated cellulose may have a fibre steepness from about 20 to about 50, or from about 25 to about 40, or from about 25 to about 35, or from about 30 to about 40.

The finer mineral peak can be fitted to the measured data points and subtracted mathematically from the distribution to leave the fibre peak, which can be converted to a cumulative distribution. Similarly, the fibre peak can be subtracted mathematically from the original distribution to leave the mineral peak, which can also be converted to a cumulative distribution. Both these cumulative curves may then be used to calculate the mean particle size (d₅₀) and the steepness of the distribution (d₃₀/d₇₀×100). The differential curve may then be used to find the modal particle size for both the mineral and fibre fractions.

The Inorganic Particulate Material

The inorganic particulate material, when present, may, for example, be an alkaline earth metal carbonate or sulphate, such as calcium carbonate, magnesium carbonate, dolomite, gypsum, a hydrous kandite day such as kaolin, halloysite or ball clay, an anhydrous (calcined) kandite clay such as metakaolin or fully calcined kaolin, talc, mica, perlite, bentonite, or diatomaceous earth, or magnesium hydroxide, or aluminum trihydrate, or combinations thereof.

A preferred inorganic particulate material for use in the method is calcium carbonate. Hereafter, the invention may tend to be discussed in terms of calcium carbonate, and in relation to aspects where the calcium carbonate is processed and/or treated. The invention should not be construed as being limited to such embodiments.

The particulate calcium carbonate used in the present invention may be obtained from a natural source by grinding. Ground calcium carbonate (GCC) is typically obtained by crushing and then grinding a mineral source such as chalk, marble or limestone, which may be followed by a particle size classification step, in order to obtain a product having the desired degree of fineness. Other techniques such as bleaching, flotation and magnetic separation may also be used to obtain a product having the desired degree of fineness and/or color. The particulate solid material may be ground autogenously, i.e. by attrition between the particles of the solid material themselves, or, alternatively, in the presence of a particulate grinding medium comprising particles of a different material from the calcium carbonate to be ground. These processes may be carried out with or without the presence of a dispersant and biocides, which may be added at any stage of the process. Generally, when present, biocide is added after formation of the belt press cake but before storage of the belt press cake composition and transport to the manufacturing location for re-dispersion of the belt cake.

Precipitated calcium carbonate (PCC) may be used as the source of particulate calcium carbonate in the present invention, and may be produced by any of the known methods available in the art. TAPPI Monograph Series No 30, “Paper Coating Pigments”, pages 34-35 describes the three main commercial processes for preparing precipitated calcium carbonate which is suitable for use in preparing products for use in the paper industry, but may also be used in the practice of the present invention. In all three processes, a calcium carbonate feed material, such as limestone, is first calcined to produce quicklime, and the quicklime is then slaked in water to yield calcium hydroxide or milk of lime. In the first process, the milk of lime is directly carbonated with carbon dioxide gas. This process has the advantage that no by-product is formed, and it is relatively easy to control the properties and purity of the calcium carbonate product. In the second process the milk of lime is contacted with soda ash to produce, by double decomposition, a precipitate of calcium carbonate and a solution of sodium hydroxide. The sodium hydroxide may be substantially completely separated from the calcium carbonate if this process is used commercially. In the third main commercial process the milk of lime is first contacted with ammonium chloride to give a calcium chloride solution and ammonia gas. The calcium chloride solution is then contacted with soda ash to produce by double decomposition precipitated calcium carbonate and a solution of sodium chloride. The crystals can be produced in a variety of different shapes and sizes, depending on the specific reaction process that is used. The three main forms of PCC crystals are aragonite, rhombohedral and scalenohedral, all of which are suitable for use in the present invention, including mixtures thereof.

Wet grinding of calcium carbonate involves the formation of an aqueous suspension of the calcium carbonate which may then be ground, optionally in the presence of a suitable dispersing agent. Reference may be made to, for example, EP 614948 (the contents of which are incorporated by reference in their entirety) for more information regarding the wet grinding of calcium carbonate.

In some circumstances, minor additions of other minerals may be included, for example, one or more of kaolin, calcined kaolin, wollastonite, bauxite, talc, bentonite, or mica, could also be present.

When the inorganic particulate material of the present invention is obtained from naturally occurring sources, it may be that some mineral impurities will contaminate the ground material. For example, naturally occurring calcium carbonate can be present in association with other minerals. Thus, in some embodiments, the inorganic particulate material includes an amount of impurities. In general, however, the inorganic particulate material used in the invention will contain less than about 5% by weight, preferably less than about 1% by weight, of other mineral impurities.

The inorganic particulate material used during the microfibrillating step of the method of the present invention will preferably have a particle size distribution in which at least about 10% by weight of the particles have an e.s.d. of less than 2 μm, for example, at least about 20% by weight, or at least about 30% by weight, or at least about 40% by weight, or at least about 50% by weight, or at least about 60% by weight, or at least about 70% by weight, or at least about 80% by weight, or at least about 90% by weight, or at least about 95% by weight, or about 100% of the particles have an e.s.d. of less than 2 μm.

Unless otherwise stated, particle size properties referred to herein for the inorganic particulate materials are as measured in a well-known manner by sedimentation of the particulate material in a fully dispersed condition in an aqueous medium using a Sedigraph 5100 machine as supplied by Micromeritics Instruments Corporation, Norcross, Ga., USA (telephone: +1 770 662 3620; web-site: www.micromeritics.com), referred to herein as a “Micromeritics Sedigraph 5100 unit”. Such a machine provides measurements and a plot of the cumulative percentage by weight of particles having a size, referred to in the art as the “equivalent spherical diameter” (e.s.d), less than given e.s.d. values. The mean particle size d₅₀ is the value determined in this way of the particle e.s.d. at which there are 50% by weight of the particles which have an equivalent spherical diameter less than that d₅₀ value.

Alternatively, where stated, the particle size properties referred to herein for the inorganic particulate materials are as measured by the well-known conventional method employed in the art of laser light scattering, using a Malvern Insitec apparatus (or equivalent), as supplied by Malvern Instruments Ltd (or by other methods which give essentially the same result). In the laser light scattering technique, the size of particles in powders, suspensions and emulsions may be measured using the diffraction of a laser beam, based on an application of Mie theory. Such a machine provides measurements and a plot of the cumulative percentage by volume of particles having a size, referred to in the art as the “equivalent spherical diameter” (e.s.d.), less than given e.s.d. values. The mean particle size d₅₀ is the value determined in this way of the particle e.s.d. at which there are 50% by volume of the particles which have an equivalent spherical diameter less than that d₅₀ value.

Unless otherwise stated, particle size properties of the microfibrillated cellulose materials are as measured by the well-known conventional method employed in the art of laser light scattering, using a Malvern Insitec L machine as supplied by Malvern Instruments Ltd (or by other methods which give essentially the same result).

Details of the procedure used to characterize the particle size distributions of mixtures of inorganic particle material and microfibrillated cellulose using a Malvern Mastersizer S machine are provided below.

Another preferred inorganic particulate material for use is kaolin clay. Hereafter, this section of the specification may tend to be discussed in terms of kaolin, and in relation to aspects where the kaolin is processed and/or treated. The invention should not be construed as being limited to such embodiments. Thus, in some embodiments, kaolin is used in an unprocessed form.

Kaolin clay used in this invention may be a processed material derived from a natural source, namely raw natural kaolin clay mineral. The processed kaolin clay may typically contain at least about 50% by weight kaolinite. For example, most commercially processed kaolin clays contain greater than about 75% by weight kaolinite and may contain greater than about 90%, in some cases greater than about 95% by weight of kaolinite.

Kaolin clay used in the present invention may be prepared from the raw natural kaolin clay mineral by one or more other processes which are well known to those skilled in the art, for example by known refining or beneficiation steps.

For example, the clay mineral may be bleached with a reductive bleaching agent, such as sodium hydrosulfite. If sodium hydrosulfite is used, the bleached clay mineral may optionally be dewatered, and optionally washed and again optionally dewatered, after the sodium hydrosulfite bleaching step.

The clay mineral may be treated to remove impurities, e.g. by flocculation, flotation, or magnetic separation techniques well known in the art. Alternatively the clay mineral used in an aspect of the invention may be untreated in the form of a solid or as an aqueous suspension.

The process for preparing the particulate kaolin clay used in the present invention may also include one or more comminution steps, e.g., grinding or milling. Light comminution of a coarse kaolin is used to give suitable delamination thereof. The comminution may be carried out by use of beads or granules of a plastic (e.g. nylon), sand or ceramic grinding or milling aid. The coarse kaolin may be refined to remove impurities and improve physical properties using well known procedures. The kaolin clay may be treated by a known particle size classification procedure, e.g., screening and centrifuging (or both), to obtain particles having a desired d₅₀ value or particle size distribution.

Fibrous Substrate Comprising Cellulose

The fibrous substrate comprising cellulose may be derived from any suitable source, such as wood, grasses (e.g., sugarcane, bamboo) or rags (e.g., textile waste, cotton, hemp or flax). The fibrous substrate comprising cellulose may be in the form of a pulp (i.e., a suspension of cellulose fibres in water), which may be prepared by any suitable chemical or mechanical treatment, or combination thereof. For example, the pulp may be a chemical pulp, or a chemithermomechanical pulp, or a mechanical pulp, or a recycled pulp, or a papermill broke, or a papermill waste stream, or waste from a papermill, or a combination thereof. The cellulose pulp may be beaten (for example in a Valley beater) and/or otherwise refined (for example, processing in a conical or plate refiner) to any predetermined freeness, reported in the art as Canadian standard freeness (CSF) in cm³. CSF means a value for the freeness or drainage rate of pulp measured by the rate that a suspension of pulp may be drained. For example, the cellulose pulp may have a Canadian standard freeness of about 10 cm³ or greater prior to being microfibrillated. The cellulose pulp may have a CSF of about 700 cm³ or less, for example, equal to or less than about 650 cm³, or equal to or less than about 600 cm³, or equal to or less than about 550 cm³, or equal to or less than about 500 cm³, or equal to or less than about 450 cm³, or equal to or less than about 400 cm³, or equal to or less than about 350 cm³, or equal to or less than about 300 cm³, or equal to or less than about 250 cm³, or equal to or less than about 200 cm³, or equal to or less than about 150 cm³, or equal to or less than about 100 cm³, or equal to or less than about 50 cm³. The cellulose pulp may then be dewatered by methods well known in the art, for example, the pulp may be filtered through a screen in order to obtain a wet sheet comprising at least about 10% solids, for example at least about 15% solids, or at least about 20% solids, or at least about 30% solids, or at least about 40% solids. The pulp may be utilized in an unrefined state, that is to say, without being beaten or dewatered, or otherwise refined.

The cellulose pulp may be beaten (for example in a Valley beater) and/or otherwise refined (for example, processing in a conical or plate refiner) to any predetermined freeness, reported in the art as Canadian standard freeness (CSF) in cm³. CSF means a value for the freeness or drainage rate of pulp measured by the rate that a suspension of pulp may be drained, and this test is carried out according to the T 227 cm-09 TAPPI standard. For example, the cellulose pulp may have a Canadian standard freeness of about 10 cm³ or greater prior to being microfibrillated. The cellulose pulp may have a CSF of about 700 cm³ or less, for example, equal to or less than about 650 cm³, or equal to or less than about 600 cm³, or equal to or less than about 550 cm³, or equal to or less than about 500 cm³, or equal to or less than about 450 cm³, or equal to or less than about 400 cm³, or equal to or less than about 350 cm³, or equal to or less than about 300 cm³, or equal to or less than about 250 cm³, or equal to or less than about 200 cm³, or equal to or less than about 150 cm³, or equal to or less than about 100 cm³, or equal to or less than about 50 cm³. The cellulose pulp may have a CSF of about 20 to about 700. The cellulose pulp may then be dewatered by methods well known in the art, for example, the pulp may be filtered through a screen in order to obtain a wet sheet comprising at least about 10% solids, for example at least about 15% solids, or at least about 20% solids, or at least about 30% solids, or at least about 40% solids. The pulp may be utilized in an unrefined state, that is to say, without being beaten or dewatered, or otherwise refined.

Microfibrillated cellulose may be produced by any method of reducing the particle size of polysaccharides as would be known to a person of ordinary skill in the art. However, methods for reducing particle size while preserving a high aspect ratio in the polysaccharide are preferred. In particular, the at least one microfibrillated cellulose may be produced by a method selected from the group consisting of grinding; sonication; homogenization; impingement mixer; heat; steam explosion; pressurization-depressurization cycle; freeze-thaw cycle; impact; grinding (such as a disc grinder); pumping; mixing; ultrasound; microwave explosion; and/or milling. Various combinations of these may also be used, such as milling followed by homogenization. In one embodiment, the at least one microfibrillated cellulose is formed by subjecting one or more cellulose-containing raw materials to a sufficient amount of shear in an aqueous suspension such that a portion of the crystalline regions of the cellulose fibers in the one or more cellulose-containing raw materials are fibrillated.

Microfibrillation of the fibrous substrate comprising cellulose may be obtained under wet conditions in the presence of the inorganic particulate material by a method in which the mixture of cellulose pulp and inorganic particulate material is pressurized (for example, to a pressure of about 500 bar) and then passed to a zone of lower pressure. The rate at which the mixture is passed to the low pressure zone is sufficiently high and the pressure of the low pressure zone is sufficiently low as to cause microfibrillation of the cellulose fibres. For example, the pressure drop may be obtained by forcing the mixture through an annular opening that has a narrow entrance orifice with a much larger exit orifice. The drastic decrease in pressure as the mixture accelerates into a larger volume (i.e., a lower pressure zone) induces cavitation which causes microfibrillation. In an embodiment, microfibrillation of the fibrous substrate comprising cellulose may be obtained in a homogenizer under wet conditions in the presence of the inorganic particulate material. In the homogenizer, the cellulose pulp-inorganic particulate material mixture is pressurized (for example, to a pressure of about 500 bar), and forced through a small nozzle or orifice. The mixture may be pressurized to a pressure of from about 100 to about 1000 bar, for example to a pressure of equal to or greater than 300 bar, or equal to or greater than about 500, or equal to or greater than about 200 bar, or equal to or greater than about 700 bar. The homogenization subjects the fibres to high shear forces such that as the pressurized cellulose pulp exits the nozzle or orifice, cavitation causes microfibrillation of the cellulose fibres in the pulp. Additional water may be added to improve flowability of the suspension through the homogenizer. The resulting aqueous suspension comprising microfibrillated cellulose and inorganic particulate material may be fed back into the inlet of the homogenizer for multiple passes through the homogenizer. In a preferred embodiment, the inorganic particulate material is a naturally platy mineral, such as kaolin. As such, homogenization not only facilitates microfibrillation of the cellulose pulp, but also facilitates delamination of the platy particulate material.

Microfibrillated Cellulose Prepared without Addition of Inorganic Particulate Material

In a preferred embodiment, the microfibrillated cellulose is prepared in accordance with a method comprising a step of microfibrillating a fibrous substrate comprising cellulose in an aqueous environment by grinding in the presence of a grinding medium which is to be removed after the completion of grinding, wherein the grinding is performed in a tower mill or a screened grinder, and wherein the grinding is carried out in the absence of grindable inorganic particulate material.

A stirred media mill consists of a rotating impeller that transfers kinetic energy to small grinding media beads, which grind down the charge via a combination of shear, compressive, and impact forces. A variety of grinding apparatus may be used to produce MFC by the disclosed methods herein, including, for example, a tower mill, a screened grinding mill, or a stirred media detritor.

A grindable inorganic particulate material is a material which would be ground in the presence of the grinding medium.

The particulate grinding medium may be of a natural or a synthetic material. The grinding medium may, for example, comprise balls, beads or pellets of any hard mineral, ceramic or metallic material. Such materials may include, for example, alumina, zirconia, zirconium silicate, aluminum silicate or the mullite-rich material which is produced by calcining kaolinitic clay at a temperature in the range of from about 1300° C. to about 1800° C. For example, in some embodiments a Carbolite® grinding media is preferred. Alternatively, particles of natural sand of a suitable particle size may be used.

Generally, the type of and particle size of grinding medium to be selected for use in the invention may be dependent on the properties, e.g., the particle size of, and the chemical composition of, the feed suspension of material to be ground. Preferably, the particulate grinding medium comprises particles having an average diameter in the range of from about 0.5 mm to about 6 mm. In one embodiment, the particles have an average diameter of at least about 3 mm.

The grinding medium may comprise particles having a specific gravity of at least about 2.5. The grinding medium may comprise particles have a specific gravity of at least about 3, or least about 4, or least about 5, or at least about 6.

The grinding medium (or media) may be present in an amount up to about 70% by volume of the charge. The grinding media may be present in amount of at least about 10% by volume of the charge, for example, at least about 20% by volume of the charge, or at least about 30% by volume of the charge, or at least about 40% by volume of the charge, or at least about 50% by volume of the charge, or at least about 60% by volume of the charge.

The fibrous substrate comprising cellulose may be microfibrillated to obtain microfibrillated cellulose having a do ranging from about 5 μm to about 500 μm, as measured by laser light scattering.

The fibrous substrate comprising cellulose may be microfibrillated to obtain microfibrillated cellulose having a d₅₀ of equal to or less than about 400 μm, for example equal to or less than about 300 μm, or equal to or less than about 200 μm, or equal to or less than about 150 μm, or equal to or less than about 125 μm, or equal to or less than about 100 μm, or equal to or less than about 90 μm, or equal to or less than about 80 μm, or equal to or less than about 70 μm, or equal to or less than about 60 μm, or equal to or less than about 50 μm, or equal to or less than about 40 μm, or equal to or less than about 30 μm, or equal to or less than about 20 μm, or equal to or less than about 10 μm.

The fibrous substrate comprising cellulose may be microfibrillated to obtain microfibrillated cellulose having a modal fibre particle size ranging from about 0.1-500 μm. The fibrous substrate comprising cellulose may be microfibrillated in the presence to obtain microfibrillated cellulose having a modal fibre particle size of at least about 0.5 μm, for example at least about 10 μm, or at least about 50 μm, or at least about 100 μm, or at least about 150 μm, or at least about 200 μm, or at least about 300 μm, or at least about 400 μm.

The fibrous substrate comprising cellulose may be microfibrillated to obtain microfibrillated cellulose having a fibre steepness equal to or greater than about 10, as measured by Malvern. Fibre steepness (i.e., the steepness of the particle size distribution of the fibres) is determined by the following formula:

Steepness=100×(d₃₀/d₇₀)

The microfibrillated cellulose may have a fibre steepness equal to or less than about 100. The microfibrillated cellulose may have a fibre steepness equal to or less than about 75, or equal to or less than about 50, or equal to or less than about 40, or equal to or less than about 30. The microfibrillated cellulose may have a fibre steepness from about 20 to about 50, or from about 25 to about 40, or from about 25 to about 35, or from about 30 to about 40. In an embodiment, a preferred steepness range is about 20 to about 50.

In one embodiment, the grinding vessel is a tower mill. The tower mill may comprise a quiescent zone above one or more grinding zones. A quiescent zone is a region located towards the top of the interior of a tower mill in which minimal or no grinding takes place and comprises microfibrillated cellulose and inorganic particulate material. The quiescent zone is a region in which particles of the grinding medium sediment down into the one or more grinding zones of the tower mill.

The tower mill may comprise a classifier above one or more grinding zones. In an embodiment, the classifier is top mounted and located adjacent to a quiescent zone. The classifier may be a hydrocyclone.

The tower mill may comprise a screen above one or more grind zones. In an embodiment, a screen is located adjacent to a quiescent zone and/or a classifier. The screen may be sized to separate grinding media from the product aqueous suspension comprising microfibrillated cellulose and to enhance grinding media sedimentation.

In another embodiment, the microfibrillated cellulose may be prepared in a stirred media detritor. A stirred media mill consists of a rotating impeller that transfers kinetic energy to small grinding media beads, which grind down the charge via a combination of shear, compressive, and impact forces. A variety of grinding apparatus may be used to produce MFC by the disclosed methods herein, including, for example, a tower mill, a screened grinding mill, or a stirred media detritor.

In an embodiment, the grinding is performed under plug flow conditions. Under plug flow conditions the flow through the tower is such that there is limited mixing of the grinding materials through the tower. This means that at different points along the length of the tower mill the viscosity of the aqueous environment will vary as the fineness of the microfibrillated cellulose increases. Thus, in effect, the grinding region in the tower mill can be considered to comprise one or more grinding zones which have a characteristic viscosity. A skilled person in the art will understand that there is no sharp boundary between adjacent grinding zones with respect to viscosity.

In an embodiment, water is added at the top of the mill proximate to the quiescent zone or the classifier or the screen above one or more grinding zones to reduce the viscosity of the aqueous suspension comprising microfibrillated cellulose at those zones in the mill. By diluting the product microfibrillated cellulose at this point in the mill it has been found that the prevention of grinding media carry over to the quiescent zone and/or the classifier and/or the screen is improved. Further, the limited mixing through the tower allows for processing at higher solids lower down the tower and dilute at the top with limited backflow of the dilution water back down the tower into the one or more grinding zones. Any suitable amount of water which is effective to dilute the viscosity of the product aqueous suspension comprising microfibrillated cellulose may be added. The water may be added continuously during the grinding process, or at regular intervals, or at irregular intervals.

In another embodiment, water may be added to one or more grinding zones via one or more water injection points positioned along the length of the tower mill, or each water injection point being located at a position which corresponds to the one or more grinding zones. Advantageously, the ability to add water at various points along the tower allows for further adjustment of the grinding conditions at any or all positions along the mill.

The tower mill may comprise a vertical impeller shaft equipped with a series of impeller rotor disks throughout its length. The action of the impeller rotor disks creates a series of discrete grinding zones throughout the mill.

In another embodiment, the grinding is performed in a screened grinder, preferably a stirred media detritor. The screened grinder may comprise one or more screen(s) having a nominal aperture size of at least about 250 μm, for example, the one or more screens may have a nominal aperture size of at least about 300 μm, or at least about 350 μm, or at least about 400 μm, or at least about 450 μm, or at least about 500 μm, or at least about 550 μm, or at least about 600 μm, or at least about 650 μm, or at least about 700 μm, or at least about 750 μm, or at least about 800 μm, or at least about 850 μm, or at or least about 900 μm, or at least about 1000 μm.

The screen sizes noted immediately above are applicable to the tower mill embodiments described above.

As noted above, the grinding is performed in the presence of a grinding medium. In an embodiment, the grinding medium is a coarse media comprising particles having an average diameter in the range of from about 1 mm to about 6 mm, for example about 2 mm, or about 3 mm, or about 4 mm, or about 5 mm.

In another embodiment, the grinding media has a specific gravity of at least about 2.5, for example, at least about 3, or at least about 3.5, or at least about 4.0, or at least about 4.5, or least about 5.0, or at least about 5.5, or at least about 6.0.

As described above, the grinding medium (or media) may be in an amount up to about 70% by volume of the charge. The grinding media may be present in amount of at least about 10% by volume of the charge, for example, at least about 20% by volume of the charge, or at least about 30% by volume of the charge, or at least about 40% by volume of the charge, or at least about 50% by volume of the charge, or at least about 60% by volume of the charge.

In one embodiment, the grinding medium is present in amount of about 50% by volume of the charge.

By ‘charge’ is meant the composition which is the feed fed to the grinder vessel. The charge includes water, grinding media, the fibrous substrate comprising cellulose and any other optional additives (other than as described herein).

The use of a relatively coarse and/or dense media has the advantage of improved (i.e., faster) sediment rates and reduced media carry over through the quiescent zone and/or classifier and/or screen(s).

A further advantage in using relatively coarse screens is that a relatively coarse or dense grinding media can be used in the microfibrillating step. In addition, the use of relatively coarse screens (i.e., having a nominal aperture of least about 250 μm) allows a relatively high solids product to be processed and removed from the grinder, which allows a relatively high solids feed (comprising fibrous substrate comprising cellulose and inorganic particulate material) to be processed in an economically viable process. As discussed below, it has been found that a feed having a high initial solids content is desirable in terms of energy sufficiency. Further, it has also been found that product produced (at a given energy) at lower solids has a coarser particle size distribution.

In accordance with one embodiment, the fibrous substrate comprising cellulose is present in the aqueous environment at an initial solids content of at least about 1 wt %. The fibrous substrate comprising cellulose may be present in the aqueous environment at an initial solids content of at least about 2 wt %, for example at least about 3 wt %, or at least about at least 4 wt %. Typically the initial solids content will be no more than about 10 wt %.

In another embodiment, the grinding is performed in a cascade of grinding vessels, one or more of which may comprise one or more grinding zones. For example, the fibrous substrate comprising cellulose may be ground in a cascade of two or more grinding vessels, for example, a cascade of three or more grinding vessels, or a cascade of four or more grinding vessels, or a cascade of five or more grinding vessels, or a cascade of six or more grinding vessels, or a cascade of seven or more grinding vessels, or a cascade of eight or more grinding vessels, or a cascade of nine or more grinding vessels in series, or a cascade comprising up to ten grinding vessels. The cascade of grinding vessels may be operatively inked in series or parallel or a combination of series and parallel. The output from and/or the input to one or more of the grinding vessels in the cascade may be subjected to one or more screening steps and/or one or more classification steps.

The total energy expended in a microfibrillation process may be apportioned equally across each of the grinding vessels in the cascade. Alternatively, the energy input may vary between some or all of the grinding vessels in the cascade.

A person skilled in the art will understand that the energy expended per vessel may vary between vessels in the cascade depending on the amount of fibrous substrate being microfibrillated in each vessel, and optionally the speed of grind in each vessel, the duration of grind in each vessel and the type of grinding media in each vessel. The grinding conditions may be varied in each vessel in the cascade in order to control the particle size distribution of the microfibrillated cellulose.

In an embodiment the grinding is performed in a closed circuit. In another embodiment, the grinding is performed in an open circuit.

As the suspension of material to be ground may be of a relatively high viscosity, a suitable dispersing agent may preferably be added to the suspension prior to grinding. The dispersing agent may be, for example, a water soluble condensed phosphate, polysilicic acid or a salt thereof, or a polyelectrolyte, for example a water soluble salt of a poly(acrylic acid) or of a poly(methacrylic acid) having a number average molecular weight not greater than 80,000. The amount of the dispersing agent used would generally be in the range of from 0.1 to 2.0% by weight, based on the weight of the dry inorganic particulate solid material. The suspension may suitably be ground at a temperature in the range of from 4° C. to 100° C.

Other additives which may be included during the microfibrillation step include: carboxymethyl cellulose, amphoteric carboxymethyl cellulose, oxidising agents, 2,2,6,6-Tetramethylpiperidine-1-oxyl (TEMPO), TEMPO derivatives, and wood degrading enzymes.

The pH of the suspension of material to be ground may be about 7 or greater than about 7 (i.e., basic), for example, the pH of the suspension may be about 8, or about 9, or about 10, or about 11. The pH of the suspension of material to be ground may be less than about 7 (i.e., acidic), for example, the pH of the suspension may be about 6, or about 5, or about 4, or about 3. The pH of the suspension of material to be ground may be adjusted by addition of an appropriate amount of acid or base. Suitable bases included alkali metal hydroxides, such as, for example NaOH. Other suitable bases are sodium carbonate and ammonia. Suitable acids included inorganic acids, such as hydrochloric and sulphuric acid, or organic acids. An exemplary acid is orthophosphoric acid.

The total energy input in a typical grinding process to obtain the desired aqueous suspension composition may typically be between about 100 and 1500 kWht−1 based on the total dry weight of the inorganic particulate filler. The total energy input may be less than about 1000 kWht−1, for example, less than about 800 kWht−1, less than about 600 kWht−1, less than about 500 kWht−1, less than about 400 kWht−1, less than about 300 kWht−1, or less than about 200 kWht−1. As such, the present inventors have surprisingly found that a cellulose pulp can be microfibrillated at relatively low energy input when it is co-ground in the presence of an inorganic particulate material. As will be apparent, the total energy input per tonne of dry fibre in the fibrous substrate comprising cellulose will be less than about 10,000 kWht−1, for example, less than about 9000 kWht−1, or less than about 8000 kWht−1, or less than about 7000 kWht−1, or less than about 6000 kWht−1, or less than about 5000 kWht−1 for example less than about 4000 kWht−1, less than about 3000 kWht−1, less than about 2000 kWht−1, less than about 1500 kWht−1, less than about 1200 kWht−1, less than about 1000 kWht−1, or less than about 800 kWhf−1. The total energy input varies depending on the amount of dry fibre in the fibrous substrate being microfibrillated, and optionally the speed of grind and the duration of grind.

Mechanical Properties of Microfibrillated Cellulose

The re-dispersed microfibrillated cellulose has a mechanical and/or physical property which is closer to that of the microfibrillated cellulose prior to drying or at least partial drying.

The mechanical property may be any determinable mechanical property associated with microfibrillated cellulose. For example, the mechanical property may be a strength property, for example, tensile index. Tensile index may be measured using a tensile tester. Any suitable method and apparatus may be used provided it is controlled in order to compare the tensile index of the microfibrillated cellulose before drying and after re-dispersal. For example, the comparison should be conducted at equal concentrations of microfibrillated cellulose, and any other additive or inorganic particulate material(s) which may be present. Tensile index may be expressed in any suitable units such as, for example, Nm/g or kNm/kg.

The physical property may be any determinable physical property associated with microfibrillated cellulose. For example, the physical property may be viscosity. Viscosity may be measured using a viscometer. Any suitable method and apparatus may be used provided it is controlled in order to compare the viscosity of the microfibrillated cellulose prior to drying and after re-dispersal. For example, the comparison should be conducted at equal concentrations of microfibrillated cellulose, and any other additive or inorganic particulate material(s) which may be present. In certain embodiments, the viscosity is Brookfield viscosity, with units of mPas.

In certain embodiments, the partially-dried microfibrillated cellulose is prepared in accordance with the procedures of U.S. Pat. No. 10,001,644 which is incorporated by reference herein in its entirety.

In certain embodiments, the tensile index and/or viscosity of the re-dispersed microfibrillated cellulose is at least about 25% of the tensile index and/or viscosity of the aqueous composition of microfibrillated cellulose prior to drying, for example, at least about 30%, or at least about 35%, or at least about 40%, or at least 45%, or at least about 50%, or at least about 55%, or at least about 60%, or at least about 65%, or at least about 70%, or at least about 75%, or at least about 80% of the tensile index and/or viscosity of the microfibrillated cellulose prior to drying.

Exemplary Preparation of Microfibrillated Cellulose Belt Press Cake.

Preparation of a belt-press cake comprising microfibrillated cellulose and inorganic particulate material at 50% percentage of pulp (POP), prepared by grinding a substrate comprising cellulose with an inorganic particulate material at 2.5% total solids. The grinder product is passed through two pressure screens in series with 250 μm then 120 μm slot sizes.

The grinder product is passed through a BVG high shear mixer at 80 kWh/t energy input.

2000 ppm Percol 3035 flocculant is added and mixed with MFC/mineral slurry with a static inline mixer.

The product is fed onto a belt filter press at ambient temperature running at 2 m/min with a pressing pressure of 35 bar.

Ploughs are fitted to the gravity dewatering section of the belt filter press to assist gravity dewatering before the pressure section.

Press cake comes off the belt filter press at 40% total solids and falls into a screw feeder which transports the material into a Winkworth, plough share type mixer. In these trials the Winkworth mixer has a Weir inside which is at 3% (0% is highest) which helps to increase residence time in the mixer The mixer breaks the large pieces of press cake up into small granules. The mixer is run at 40% speed.

Inside the Winkworth mixer biocide is added at two addition points. At the first addition point about 250 ppm DBMPA (based on total weight of cake) is added to the product and distributed within the cake by the action of the Winkworth mixer. At the second addition point inside the Winkworth mixer, about 200 ppm of CMIT/MIT (3:1 ratio) is added and mixed into the cake carrier water is added to the CMIT/MIT biocide before it is added to the product to help distribute the biocide evenly in the cake product. Product exits the Winkworth mixer and is screw fed into a bagging unit where FIBC bags are filled with −1000 kg of cake product. A vibrating table is used to help with packing.

In certain embodiments, the viscosity of the re-dispersed microfibrillated cellulose is at least about 25% of the viscosity of the aqueous composition of microfibrillated cellulose prior to drying, for example, at least about 30%, or at least about 35%, or at least about 40%, or at least 45%, or at least about 50%, or at least about 55%, or at least about 60%, or at least about 65%, or at least about 70%, or at least about 75%, or at least about 80% of the viscosity of the microfibrillated cellulose prior to drying.

### EXAMPLES

### Example 1: Re-Dispersion of Microfibrillated Cellulose: FLT Index (Tensile Index) Test

The laboratory scale dispersion of microfibrillated cellulose and microfibrillated cellulose and microfibrillated cellulose and inorganic particulate material composite pressed-cake material into a slurry is achieved through the use of a high shear mixer called a Silverson®. These steps are performed to adequately disperse the pressed-cake into a homogeneous slurry, so that it can be used for hand sheet evaluations or quality control characterisation.

Place an empty, clean poise pot on the balance and tare. Weigh out FiberLean press-cake material into poise pot. Based on the mass in the pot, dilute to 2% fibre solids using water (approx. 4% total solids for 50% MFC cake). Allow to soak for 1 hour. Mix on the Silverson® for 1 minute on full power. Re-measure the total solids content.

ISO9001 Compliant.

A laboratory procedure for making sheets from a pure microfibrillated cellulose or microfibrillated cellulose and inorganic particulate material composite sample on a custom-built filtration apparatus and measuring their strength.

Tensile Index Test: Microfibrillated cellulose FiberLean products at 20% Percentage of Pulp (POP) and above. Microfibrillated cellulose and microfibrillated cellulose and inorganic particulate material composites are adjusted to 20% POP by addition of filler. Sheets of approximately 220 gsm are made by dewatering the diluted microfibrillated cellulose and inorganic particulate material slurry on the filtration apparatus, then pressing and drying with a Rapid Köthen dryer. Tests required on the sheets are gsm and tensile strength.

Method for Microfibrillated Cellulose and Inorganic Particulate Material Composites. Record % solids and % POP of sample (see separate procedure). If % POP is greater than 20%, add mineral of the same type as in the microfibrillated cellulose and inorganic particulate material composite product to bring it to 20% (see separate procedure for microfibrillated cellulose and inorganic particulate material composite handsheets). If % POP is between 18% and 20% a correction factor will need to be applied to the result. Take approximately 4.4 g dry weight of sample (44 g for a 10% solids sample) and dilute with water to 400 mls to obtain a total solids of approximately 1.1% (0.22% fibre solids)—this will make a 220 gsm sheet on the 15.9 cm diameter exposed screen of the apparatus. Stir well to ensure good dispersion. Add 1 ml of the 0.2 wt % polyDADMAC solution to the diluted sample and stir well. If drainage is very slow this may be increased up to 5 ml. Remove the top section from the filtration unit and place a filter paper on top of the screen. Wet the filter paper with a wash bottle, and push any bubbles that form out to the rim of the paper. Ensure drain valve at bottom of unit is closed, then switch on the vacuum to adhere the filter to the screen, ensuring it sits flush with no creases. Replace the top section and clamp into place, then switch off vacuum and open drain valve to release vacuum and drain water. Close drain valve, then pour sample into top section over the end of a spatula or similar to ensure an even distribution. Avoid pouring sample directly onto filter paper. Allow sample to settle for a few seconds, then switch on vacuum and filter the sample. This should take approximately 2 minutes. Wait 1 minute then switch off vacuum supply and open drain valve to release vacuum and remove water from unit. Unclamp and remove top section of unit. Carefully remove the filter paper and filtered sample together. Place the sample and filter on a Rapid Köthen carrier board. Place a Rapid Köthen sheet cover over the sample. Place sample and covers into Rapid Köthen drier and dry for 7 minutes at −0.9 bar or −26.5 inch Hg pressure, if the vacuum pressure is lower then extended time will be required in the drier unit. Separate dry sample from filters and covers and condition at 23° C.+/−2° C. and 50% RH+/−5% for a minimum of 20 minutes

Testing. Weigh the sheet (4 d.p.) to determine its gsm. Cut sample into 15 mm wide strips using the cutter. A minimum of 5 strips is required. Measure force in Newtons required to break each strip with the tensile tester. Use Excel spreadsheet provided to calculate tensile index for each sample as in section 6.

Calculations. Area of sheet in m² (A)=0.0001×π×(diameter in cm)²/4 (0.0199 for 15.9 cm diameter sheet). Sheet gsm=Mass of sheet in grams/A. Mass of slurry required=100×220×A/TS (TS=% total solids). Microfibrillated cellulose and inorganic particulate material composite Tensile Index kN m kg⁻¹ (T)=1000×Fₘ/(W×gsm) where Fₘ=Max tensile force (N). W=Strip width (15 mm as standard) gsm=gsm of sample. Record the average tensile index and standard deviation of the 5 measurements in each case. If % POP is less than 20%, then tensile index should be corrected according to T_{corrected}=T/[1−7.6*(0.2-% POP)].

Equipment check and calibration. Calibration and procedures follow those laid down in the following standards: Paper testing—T220 sp-96.

### Example 2: Viscosity Measurements

A Brookfield viscosity test for microfibrillated cellulose and inorganic particulate material composite samples at 1.0% fibre solids using Vane Spindle. Kaolin and calcium carbonate based microfibrillated cellulose and inorganic particulate material composite samples may be measured in the following manner.

Viscometer: Brookfield YR-1 or R.V. or similar instrument including Vane Spindles.

Method for Microfibrillated Cellulose and Inorganic Particulate Material Composite. Ensure that the slurry is homogenous by shaking the container and contents vigorously. Use a palette knife to scoop and transfer at least 100 ml to a polystyrene pot. Stir well with spatula (or spindle). Set the speed of the viscometer to the required speed (10 rpm) and switch on. Allow the spindle to rotate for 30 seconds. Note and record the viscometer reading, speed, and Vane number.

Viscosity Measurement at 1.0% Fibre Solids Contents. Mix the slurry thoroughly by shaking the container and contents vigorously. Transfer a representative portion (approximately 100 g) of the microfibrillated cellulose and inorganic particulate material composite slurry to a tarred polystyrene pot. Weigh and record the weight of the slurry. Calculate the water addition required to achieve 1.0% Fibre Solids content. Add the volume of de-ionised water required to give the specified test solids. The viscosity of the microfibrillated cellulose and inorganic particulate material composite is expressed in millipascal-second (mPa·s) and is calculated from the chart provided according to the manufacturer's instruction. The standard deviation of a test slurry having a viscosity of 500 mPa·s is 5.

Calculating the Fibre Solids Contents.

FS=TS×POP/10

Where FS=% Fibre Solids. TS=% Total Solids. POP=% Pulp on Product. Dilution Calculation. The volume of water required to give a dilution of D mass % is calculated as follows: —

$$V = \frac{( I - R )}{R} \times W$$

Where V=Volume of water required
   I=Initial wt % Fibre solids
   R=Required wt % Fibre Solids
   W=the Weight of the slurry content in the pot

Dilution Calculation—Total Solids Concentrations

The weight of mineral required to give a dilution of D mass % is calculated as follows: —

M=(I−R)×W/R
Where M=the weight of Mineral required
   I=Initial wt % total solids
   R=Required wt % total solids
   W=the Weight of the MFC slurry content in the pot

Mineral is the product used in the microfibrillated cellulose and inorganic particulate material composite slurry contents. (Carbonate or Kaolin).

% Total solids is obtained after the microfibrillated cellulose and inorganic particulate material composite slurry dried at 80-100° C.

% Pulp on Product (POP) is obtained after the “Total Solids” sample burned at 450° C. (Kaolin at 950° C.).

In the following Comparative Examples and Examples all experiments utilized a dry, powdered mixture of ground calcium carbonate (60%<2 μm) and bleached softwood Kraft pulp. The total concentration was nominally 75% by weight and the concentration of pulp on dry product was 50% by weight.

The dry, powdered mixture of ground calcium carbonate (60%<2 μm) and bleached softwood Kraft pulp was blended with water using different commercial equipment under optimum conditions as specified by their manufacturers. A combination of equipment was developed into a process that achieves a substantially homogeneous suspension.

The analysis of the re-dispersed microfibrillated cellulose compositions included: Tensile (FLT) strength, as described in Example 1 and apparent viscosity using a Brookfield vane spindle viscometer, as described in Example 2. Particle size distribution as measured by light scattering on the Malvern Insitec L, as described in Example 3.

### Example 3. Particle Size Analyser: Malvern Insitec L

Method for Microfibrillated Cellulose and Inorganic Particle Material Composite.

Ensure that the slurry is homogenous by shaking the container and contents vigorously.

Switch the Malvern Insitec unit on and replace the water in the recirculation beaker with clean, room temperature ±5° C. tap water (800 ml-900 ml). Start the recirculation pump and ensure the pump speed setting is at 2500 RPM.

Open the Malvern ‘RTSizer’ software program on the computer desktop and perform a background measurement on the tap water.

Following the notification of a valid background measurement, enable particle size data collection via the ‘New Size History’ icon.

Using a pipette add the slurry into the recirculation beaker until a transmission of between 40% and 60% is reached.

At a transmission of 40-60%, allow the instrument to continue its measurement for a further 1 minute.

Use the ‘Malvern RTSizer’ software functions to average the 1 minute time-lapse of particle size history data and record the averaged size distribution parameters

Following data collection, the system is cleaned with tap water and de-ionised water to remove any residues on the window cell.

### Example 4: Control Trial 1

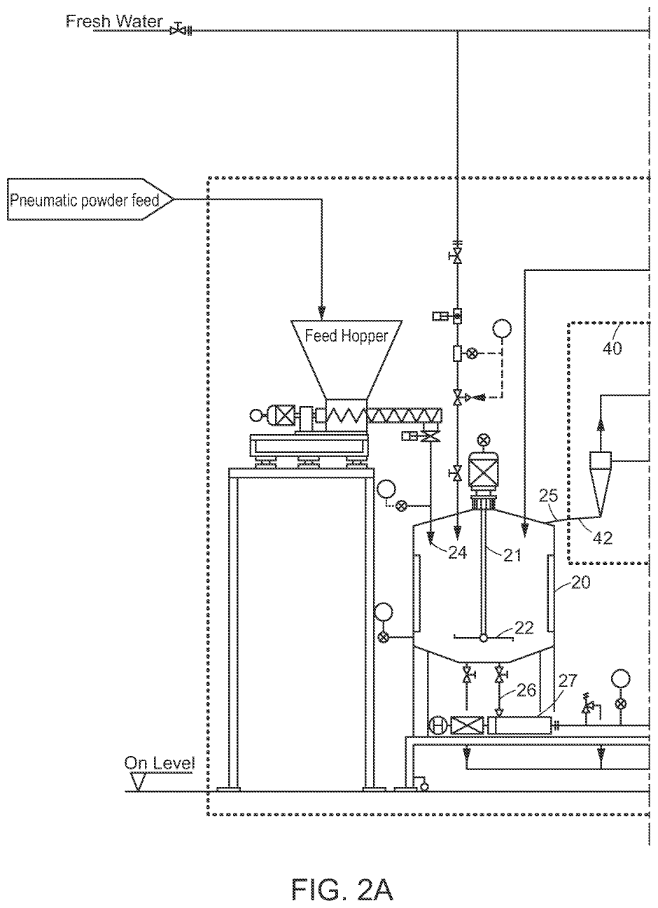

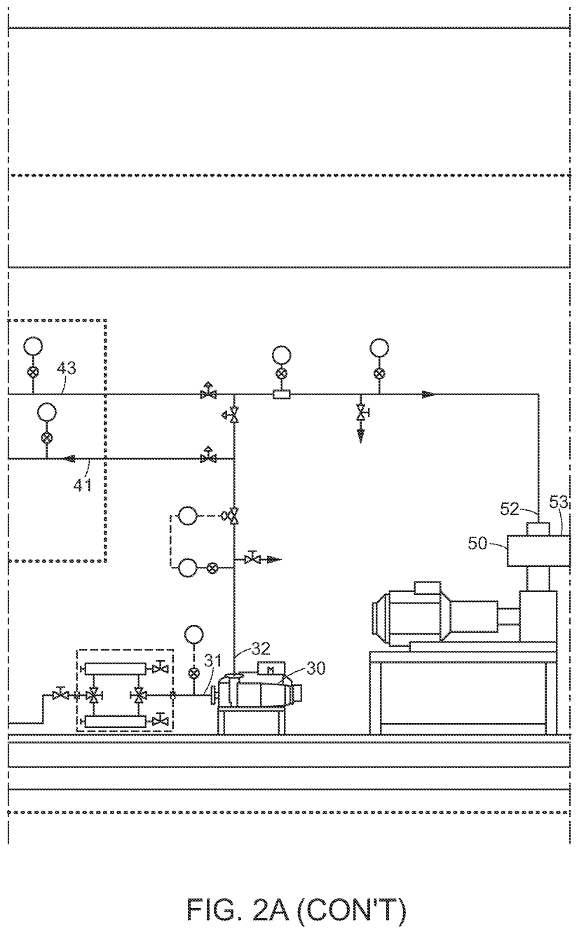

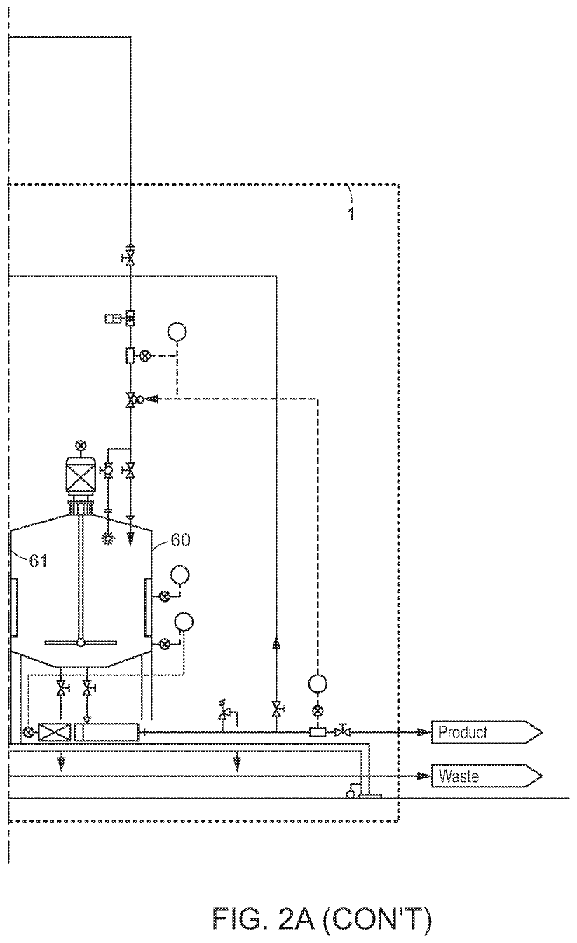

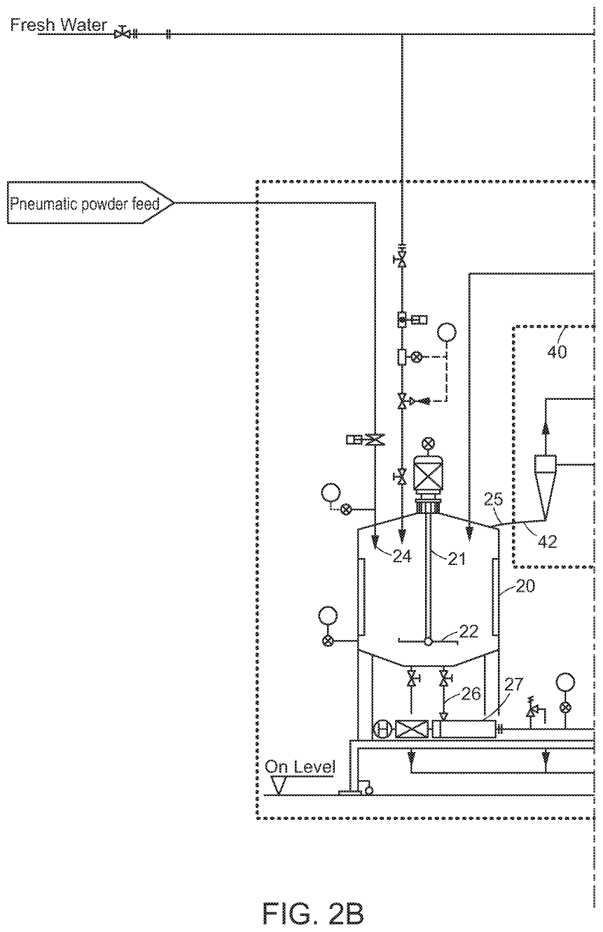

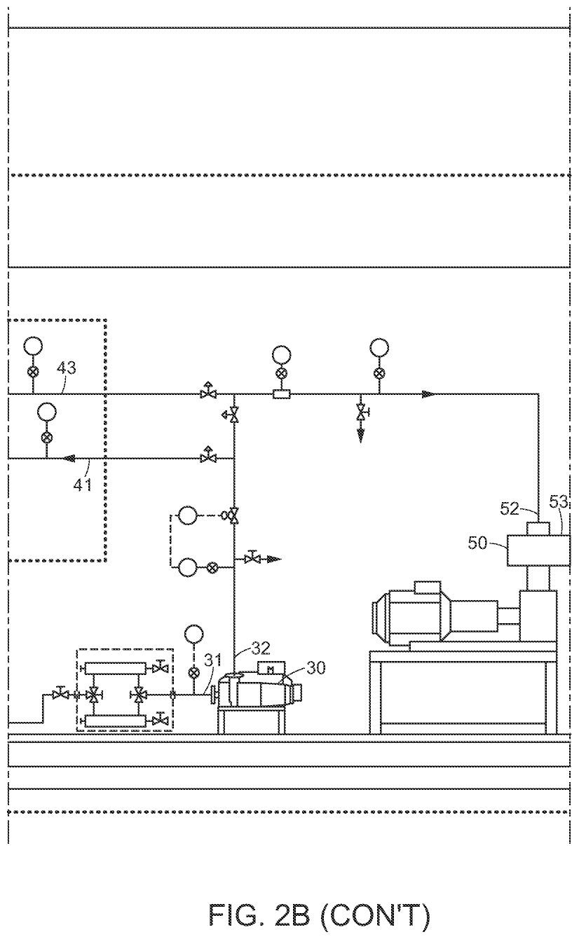

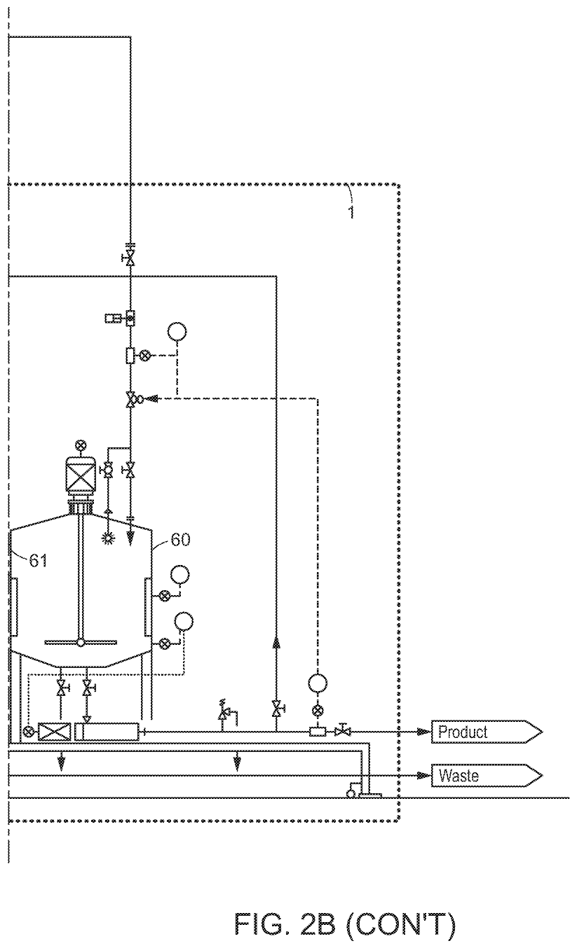

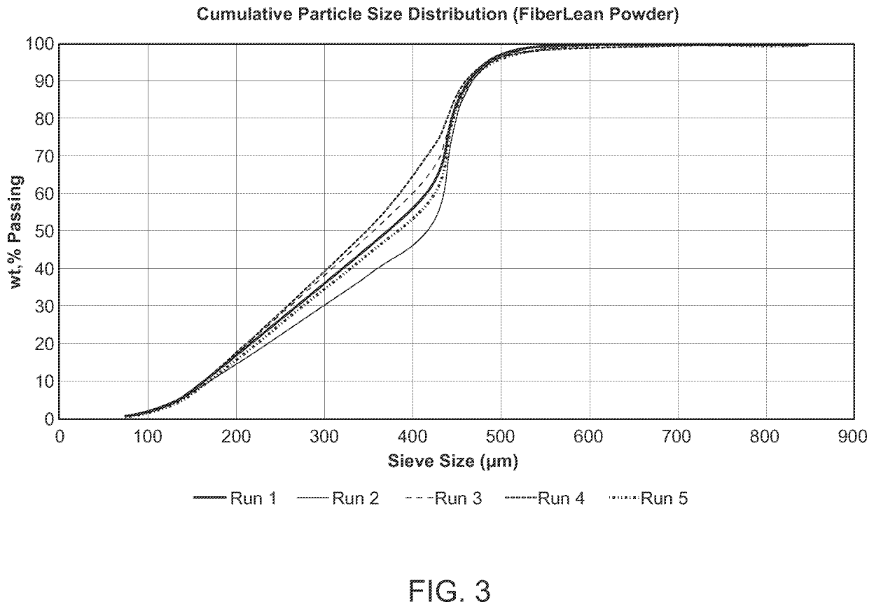

A system consisting of two Cowles-blade (saw-tooth shaped impeller) mixers in series with a high-shear rotor-stator in-line mixer, was used to re-disperse the dry, powdered mixture. FIG. 2 below shows the control system.

The standard conditions for operating the equipment were 3.5% total solids (for 50% POP) and 100% speed on the BVG shear-master. The flow rate was kept low at 12 m³/h to maximise residence time in the tanks.

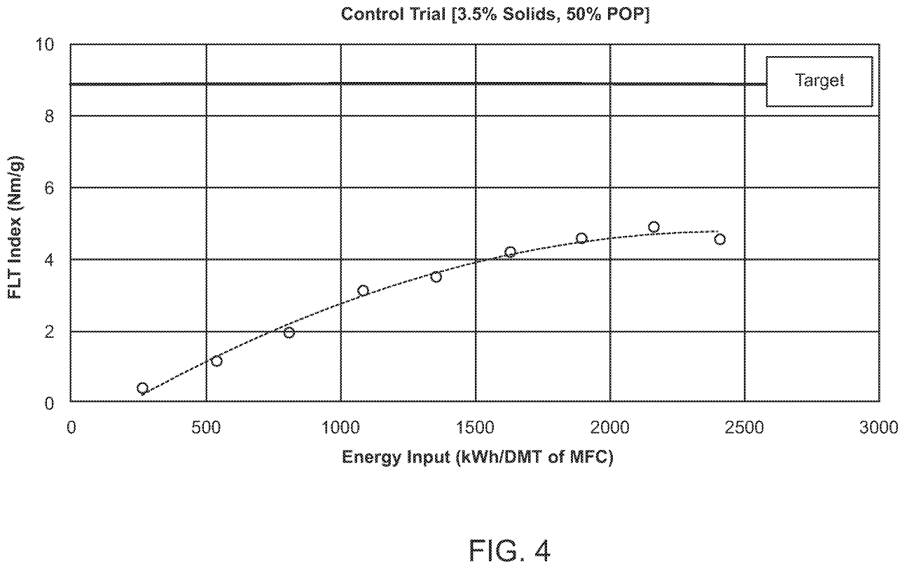

As seen in FIG. 4, the slurry failed on the main testing parameters (tensile strength and apparent viscosity) even after 2400 kWh/DMT of MFC specific energy input and 18 passes through the system.

### Example 5: Control Trial 2

A pilot-scale 12″ Sprout refiner was used to evaluate re-dispersion of the dry, powdered mixture. It is commonly used in the paper industry for pulp refining. The powder was blended with water in a Denver pulper before being recirculated around the 12″ Sprout refiner and a holding tank. The optimised conditions used were: 0.1 J/m intensity, 20 kWh/DMT of MFC net specific energy input per pass, 1320 RPM speed and disc design to give 1.111 km/rev of cutting-edge length. The total solids concentration was 9%. The percentage of pulp (POP) was 50%.

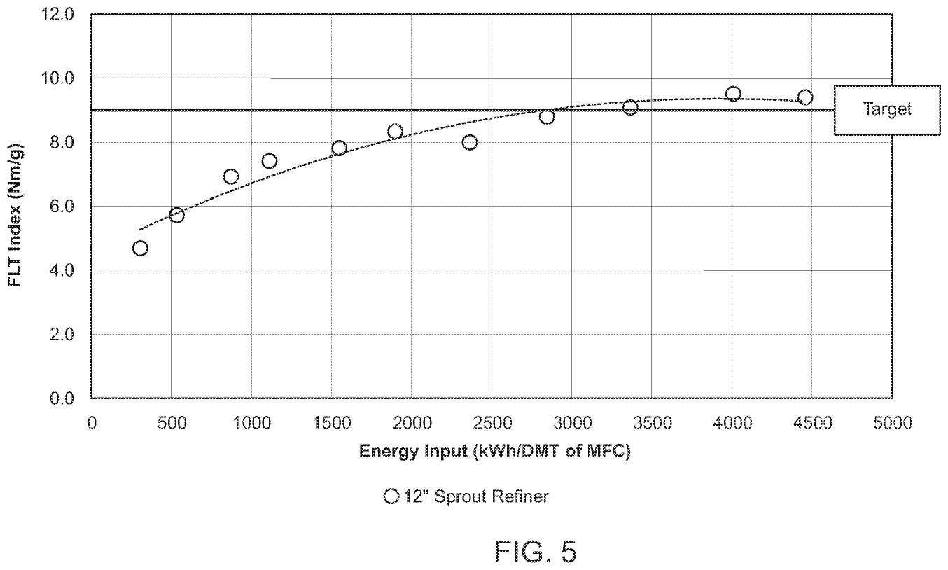

The results are shown in FIG. 5. The main quality parameters (tensile index and apparent viscosity) return after 15 passes and 2840 kWh/DMT of MFC gross specific energy input. This unfortunately confines the process to a batch operation and the high energy consumption makes it economically unfeasible.

### Example 6: Control Trial 3

A Trigonal® SM180 was used to evaluate re-dispersion of the dry, powdered mixture. It is used commonly in the bitumen industry to blend additives uniformly into the mixture but also as a pulp de-flaker. The slurry was blended using a hand-held mixer in a small vessel and the blended slurry was contained in a hold-up tank. The hold-up tank was connected in recirculation with the Trigonal® SM180. The conditions chosen were determined to be optimum from a series of trials—W3 F.S. GL reduction tool (counter-cut groove pattern), 5400 RPM, 0.1 mm gap-setting and total solids concentration was 9%. The POP was 50%.

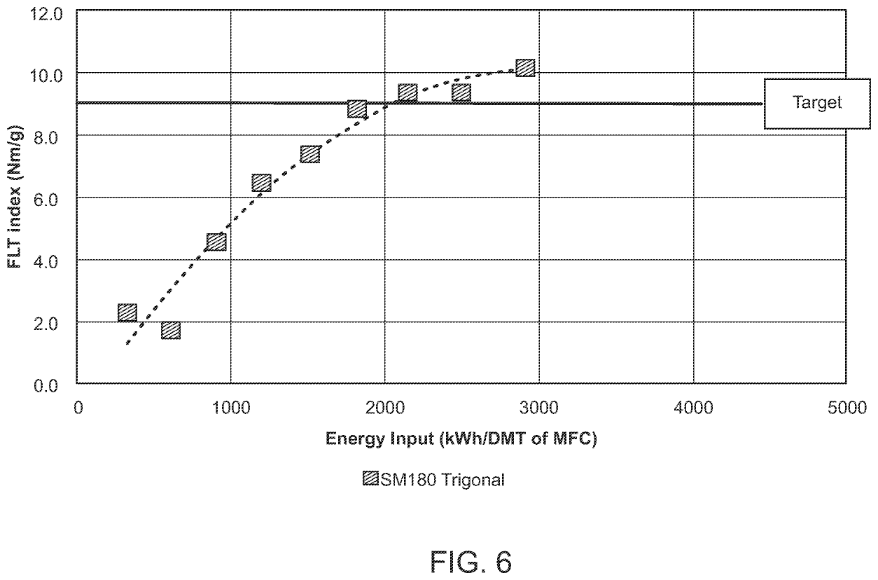

The results are shown in FIG. 6. The main quality parameters (tensile index and viscosity) return after 18 passes and 1808 kWh/DMT of MFC gross specific energy input. This unfortunately confines it to a batch operation as well, with a high capital and operational cost.

### Example 7: Control Trial 4

An Atrex® by Megatrex Oy, was used to evaluate re-dispersion of the dry, powdered mixture. It is used commonly in the paper industry to re-disperse paper broke (waste run-off from paper-machine) and also in disintegrating coarse minerals. The most optimum conditions were selected—2000 RPM rotation speed and 55 kg/min flow rate. Their standard 6-ring design was used. The counter-rotation of each segment generates very high shear-rates. The throughput is limited due to the high motor power requirements for generating such shear-rates in the fluid.

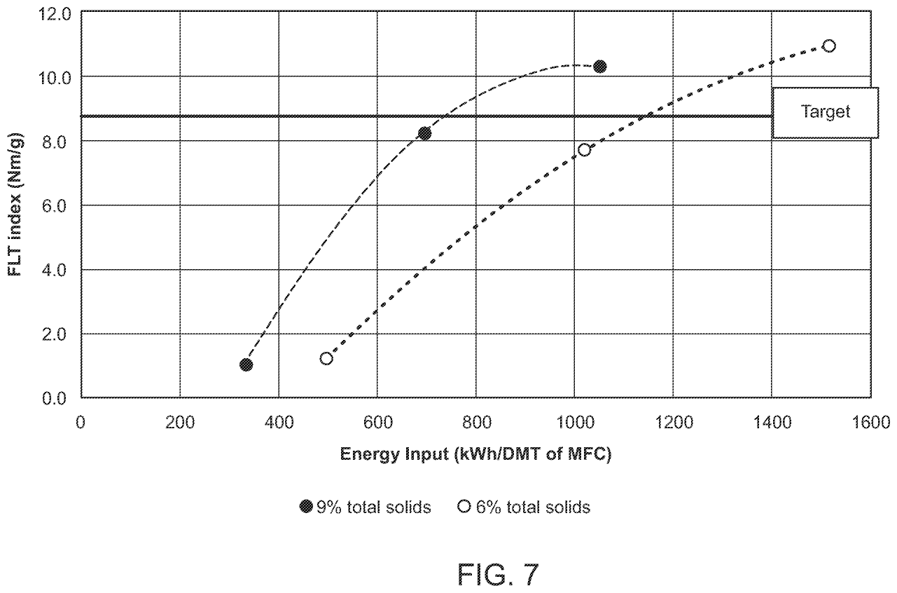

The results are shown in FIG. 7. The main quality parameters (tensile index and apparent viscosity) are above the target in Pass 3 after 1000 kWh/DMT of MFC gross specific energy input using 9% total solids. After Pass 2, they appear close to the target with 700 kWh/DMT of MFC gross specific energy input at 9% total solids.

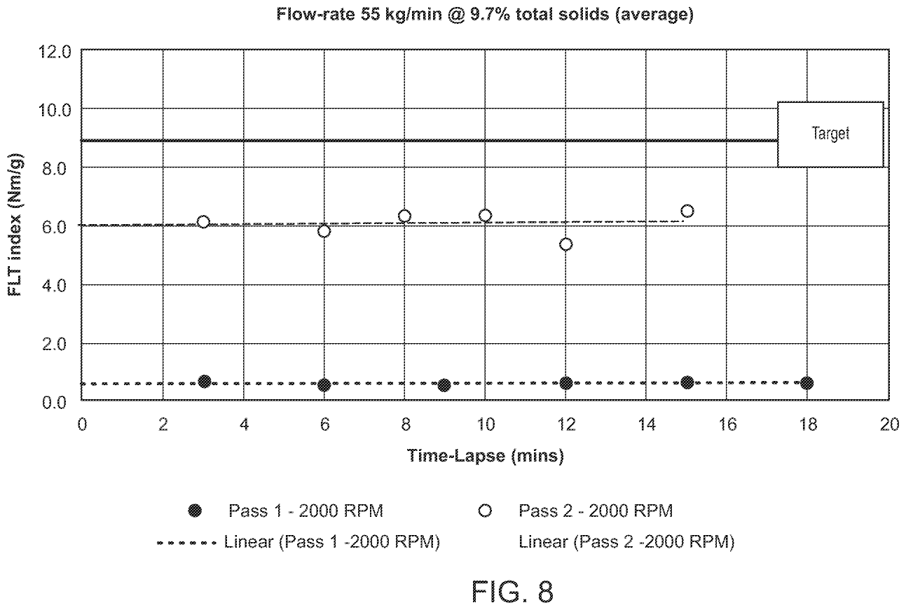

However, as shown in FIG. 8, on continuous operation, two passes are not sufficient for total re-dispersion of the product to the same quality parameters of the never-dried slurry. The system does not appear viable with the energy consumption and corresponding quality parameters. The Atrex® is a high capital cost equipment with a significantly large power consumption requirement per pass at fixed throughputs.

### Example 8: Control Trial 5

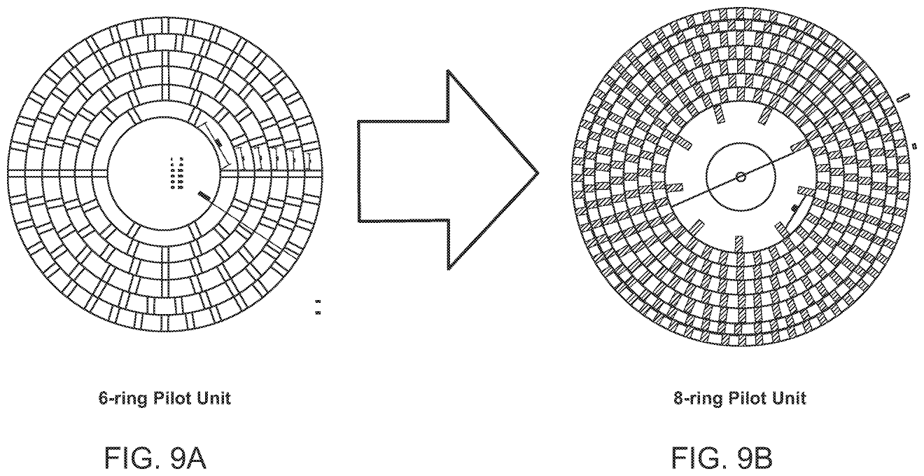

The Atrex® counter-rotating rings were upgraded after discussion with the engineering team at Megatrex. The existing 6-ring design (shown on the left in FIG. 9A) was redesigned to include more bars for maximum contact with the fibre/mineral particles in the slurry and a further two rings to extend shearing effect between the rings (as shown on the right in FIG. 9B.

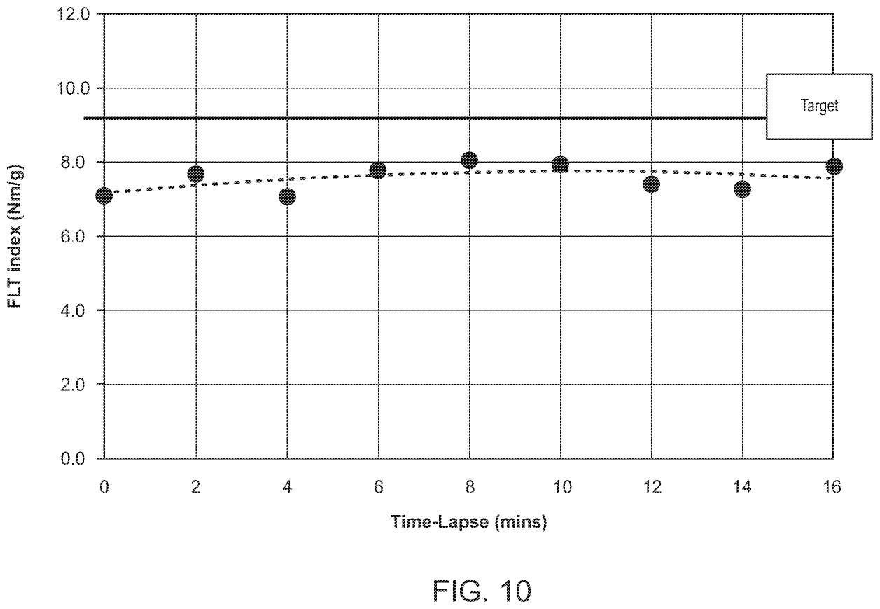

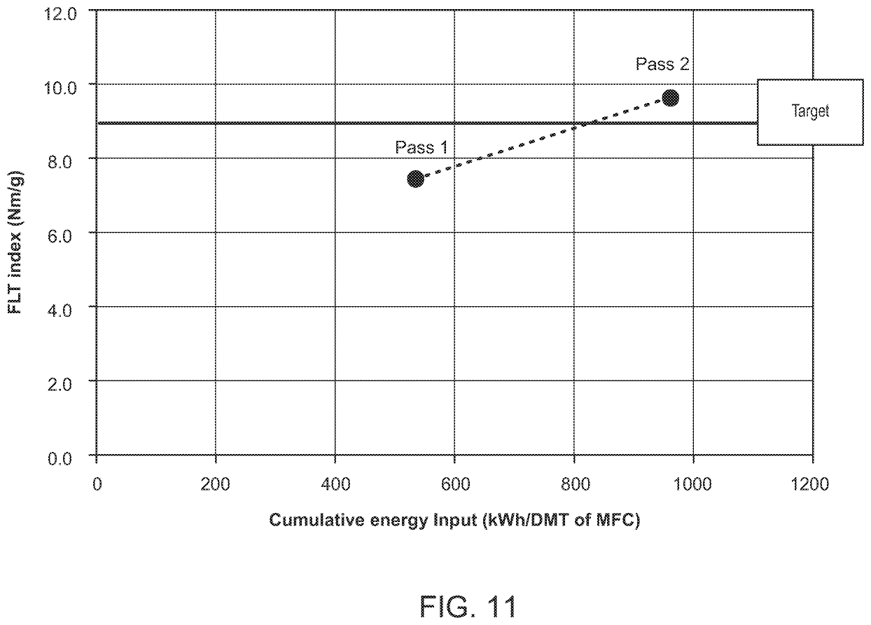

The dry, powdered mixture was also pre-wetted in a mixing tank with a moderate shear-head impeller, meant to mimic the effect of using a Cowles-blade mixer. The FLT results were much improved as seen in FIG. 10 below, but still insufficient. Two passes significantly increase the capital and operational cost of the process as seen in FIG. 11.

### Example 9: Inventive Trial Example

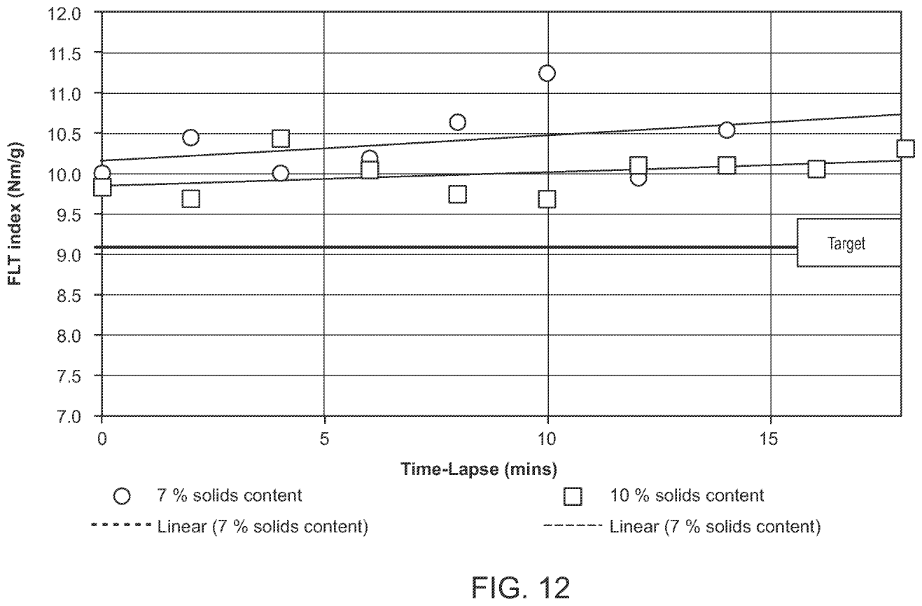

The system depicted in the flowsheet aims to improve the efficiency of the Atrex® by feeding partially wetted and suspended fibres into its high-shear counter-rotating chambers. The Trigonal® SM180 and Cowles-blade mixer act as low-cost pre-wetting devices, while the hydrocyclone improves the efficiency of the pre-wetting stage by separating unwetted components from the flow stream. The fibre-mineral component that has been wetted and disintegrated travels into the Atrex® high-shear zones as shown in FIG. 12.

The system of Example 9: Trial sheet demonstrates a process for re-dispersing dry, powdered MFC using a combination of equipment that results in a lower capital and operating cost than when used individually. The performance, in terms of tensile index and apparent viscosity, are comparable as shown in Table 1 below.

TABLE 1

| | Energy | | | | | | |
|---|---|---|---|---|---|---|---|
| | Input | # of | Apparent | FLT | Malvern | Malvern | Malvern |
| | kWh/DMT | Passes | Viscosity | Strength | D30 | D50 | D90 |
| Process | of MFC | — | mPa · s | Nm/g | μm | μm | μm |
| Never dried Slurry | N/A | N/A | ≥1000 | ≥9.0 | 80 | 158 | 526 |
| FL MDU Only (Batch) | 2409 | 18 | 600 | 4.6 | 58 | 125 | 442 |
| 12″ Sprout Refiner Only (Batch) | 2840 | 15 | 1460 | 8.8 | — | — | — |
| SM180 Trigonal ® Only (Batch) | 1808 | 18 | 1080 | 8.8 | 37 | 78 | 332 |
| Atrex ® Only 6-ring (Batch) | 1052 | 3 | 1360 | 10.2 | 28 | 61 | 284 |
| Atrex ® w/Pre-wettng 8-ring | 962 | 2 | 1040 | 9.7 | 26 | 58 | 288 |
| Proposed Continuous Process Flowsheet | 659 | 1 | 1056 | 10.0 | 29 | 66 | 321 |

The system of Example 9: Trial 1 combines low and relatively high capital equipment in order to maximise the efficiency of re-dispersing the powdered mixture while minimising the overall cost. The closed-circuit operation of the wetting stage with the Trigonal® SM180 allows a low energy, high throughput cost-effective treatment of the slurry before the Atrex®. The Atrex®'s power consumption requirements and throughput limitations for generating very high shear-rates are diminished under a single pass operation. Therefore, integrating the equipment together provides an overall cost-effective treatment of the dry, powdered MFC to produce a slurry at the customer site with the same tensile index properties of the never-dried slurry.

### Example 10

Preparation of a belt-press cake comprising microfibrillated cellulose and inorganic particulate material at 50% percentage of pulp (POP), prepared by grinding a substrate comprising cellulose with an inorganic particulate material at 2.5% total solids. The grinder product is passed through two pressure screens in series with 250 μm then 120 μm slot sizes.

The grinder product is passed through a BVG high shear mixer at 80 kWh/t energy input.

2000 ppm Percol 3035 flocculant is added and mixed with MFC/mineral slurry with a static inline mixer.

The product is fed onto a belt filter press at ambient temperature running at 2 m/min with a pressing pressure of 35 bar.

Ploughs are fitted to the gravity dewatering section of the belt filter press to assist gravity dewatering before the pressure section.

Press cake comes off the belt filter press at 28% total solids and falls into a screw feeder which transports the material into a Winkworth, plough share type mixer. The mixer breaks the large pieces of press cake up into small granules. The mixer is run at 40% speed. In these trials, the Winkworth mixer has a Weir inside which is at 3% (0% is highest) which helps to increase residence time in the mixer.

Inside the Winkworth mixer biocide is added at two addition points. At the first addition point 250 ppm DBNPA (based on total weight of cake) is added to the product and distributed within the cake by the action of the Winkworth mixer. At the second addition point inside the Winkworth mixer, 200 ppm of CMIT/MIT (3:1 ratio) is added and mixed into the cake carrier water is added to the CMIT/MIT biocide before it is added to the product to help distribute the biocide evenly in the cake product. Product exits the Winkworth mixer and is screw fed into a bagging unit where FIBC bags are filled with −1000 kg of cake product. A vibrating table is used to help with packing.

### Example 11: Manufacture of Belt Press Cake and Tensile Index Testing

Belt press cakes were manufactured in accordance with the general procedures in Example 10. Microfibrillated cellulose was manufactured with and without inorganic particulate material in accordance with the grinding procedures set forth in the present disclosure. For example, microfibrillated cellulose with inorganic particulate materials was manufactured substantially in accordance with the co-grinding procedures set forth in section [0171], et seq. Preparing the Aqueous Suspension of Microfibrillated Cellulose and Inorganic Particulate Material. Micofibrillated cellulose without inorganic particulate material was manufactured in substantially in accordance with the procedures set forth in section [00210]Microfibrillated Cellulose Prepared Without Addition of Inorganic Particulate Material of the present specification. Tensile Index (FLT Index) testing was measured substantially in accordance with Example 1 for the slurry before belt pressing and on the corresponding belt press cake (i.e., belt press cake sample is made down for testing using the make down method of Example 1. Results of the make-down testing of the belt cakes is shown in Table 2. In this Example 11, microfibrillated cellulose was made from NBSK, eucalyptus and old corrugated cardboard. The first two examples were made at 50% percentage of pulp (POP) and 100% POP.

TABLE 2

| | | | | | | | No added mineral | | |
|---|---|---|---|---|---|---|---|---|---|
| | 50% POP | | | 100% POP | | | (~14% POP) | | |
| | FLT Index | FLT Index | | FLT Index | FLT Index | | FLT Index | FLT Index | |
| | Pre-belt | After | FLT % of | Pre-belt | After | FLT % of | Pre-belt | After | FLT % of |
| | press | makedown | belt press | press | makedown | belt press | press | makedown | belt press |
| | (Nm/g) | Nm/g | cake | (Nm/g) | (Nm/g) | cake | (Nm/g) | (Nm/g) | cake |
| NBSK | 9.7 | 10.0 | 100 | 8.3 | 8.7 | 100 | | | |
| Eucalyptus | 10.9 | 10.0 | 92 | 10.9 | 9.6 | 88 | | | |
| OCC | 8.2 | 7.4 | 90 | | | | 8.2 | 7.5 | 91 |

### Example 12. Make Down of Belt Press Cakes by a Single Pass and Multiple Passes Through Make Down Unit

Microfibrillated Cellulose was manufactured substantially in accordance with Example 11. MFC was made from the indicated pulps. Tensile Index (FLT Index) and viscosity were measured for the slurry before belt pressing and the cake after make down using a single pass through the make down unit. Tensile Index (FLT Index) was also measured after the cake was made down using a single pass through the MDU followed by a single pass through a Trigonal® rotor-stator high-shear mixing apparatus. Finally, Tensile Index (FLT Index) was also measured after the cake was made down using multiple passes through the MDU and Trigonal® rotor-stator high-shear mixing apparatus and the slurry was recirculated until there was no further increase in performance. Tensile Index and viscosity testing are note in Table 3 below. Pulps utilized to manufacture the MFC are noted in column 2 of Table 3 and the inorganic particulate materials are noted in column 3.

TABLE 3

| | | | | | Pre | | Post | | | |
|---|---|---|---|---|---|---|---|---|---|---|
| | | | | Cake | dewatering | | dewatering (MDU) | | Percentage | |
| | Fibre | Mineral | | Total | FLT/ | Viscosity/ | FLT/ | Viscosity/ | Recovery | |
| Name | Type | Type | POP | solids/% | Nm/g | mPas | Nm/g | mPas | FLT | Viscosity |
| Trial Point 1 | NBSK | GCC | 50 | 29.1 | 9.7 | no data | 8.2 | | 85% | no data |
| Trial Point 2 | NBSK | GCC | 50 | 27.7 | 9.8 | 547 | 8.1 | 1664 | 83% | 304% |
| Trial Point 3 | NBSK | GCC | 20 | 44.3 | 9.4 | 591 | 9 | 2160 | 96% | 365% |
| Trial Point 4 | NBSK | Kaolin | 20 | 39.5 | 12.9 | 732 | 10.7 | 2057 | 83% | 281% |
| Trial Point 5 | NBSK | Talc | 50 | 27.4 | 12.8 | 489 | 12.3 | 1651 | 96% | 338% |
| Trial Point 6 | Acacia | GCC | 50 | 30.9 | 7.8 | 1084 | 6.6 | 703 | 85% | 65% |

Tensile index and viscosity testing for samples after multiple passages through the MDU are presented in Table 4. Tensile Index was tested substantially in accordance with Example 1 and viscosity was tested substantially in accordance with Example 2.

TABLE 4

| | | | | | Pre | | Post | | | |
|---|---|---|---|---|---|---|---|---|---|---|
| | | | | Cake | dewatering | | dewatering (MDU) | | Percentage | |
| | Fibre | Mineral | | Total | FLT/ | Viscosity/ | FLT/ | Viscosity/ | Recovery | |
| Name | Type | Type | POP | solids/% | Nm/g | mPas | Nm/g | mPas | FLT | Viscosity |
| Trial Point 1 | NBSK | GCC | 50 | 29.1 | 9.7 | no data | 8.2 | | 85% | no data |
| Trial Point 2 | NBSK | GCC | 50 | 27.7 | 9.8 | 547 | 8.1 | 1664 | 83% | 304% |
| Trial Point 3 | NBSK | GCC | 20 | 44.3 | 9.4 | 591 | 9 | 2160 | 96% | 365% |
| Trial Point 4 | NBSK | Kaolin | 20 | 39.5 | 12.9 | 732 | 10.7 | 2057 | 83% | 281% |
| Trial Point 5 | NBSK | Talc | 50 | 27.4 | 12.8 | 489 | 12.3 | 1651 | 96% | 338% |
| Trial Point 6 | Acacia | GCC | 50 | 30.9 | 7.8 | 1084 | 6.6 | 703 | 85% | 65% |

### Example 13: Manufacture of MFC Plate and Frame Press Cakes

Plate and frame press cakes were manufactured substantially in accordance with Example 11. Pulp utilized for the manufacture of MFC is listed in column 2 of Table 5. When present, inorganic particulate material is listed in column 3 of Table 5. Tensile Index was tested substantially in accordance with Example 1 and viscosity was tested substantially in accordance with Example 2.

TABLE 5

| | | Re- | | Re- | Total | | FLT | | FLT % | Viscosity |
|---|---|---|---|---|---|---|---|---|---|---|
| | Product | dispersion | | dispersion | solids | POP | Index | Viscosity | of never | % of never |
| Sample | form | method | Comment | Time secs | wt. % | wt. % | Nm/g | mPas | filtered | filtered |
| EUCA | slurry | None | [symbol] ontrol, not | None | 0.5 | 98.3 | 10.8 | 2120 | | |
| | | | dewatere [symbol] | | | | | | | |
| | Plate and | Shake | Low shear | 60 | 17.5 | 99.1 | 1.8 | 60 | 17 | 3 |
| | Frame cake | Lab stir | Low shear | 60 | 17.5 | 99.1 | 1.6 | 220 | 15 | 10 |
| | | Silverson big hole | Medium shear | 5 | 17.5 | 99.1 | 6.9 | 1450 | 64 | 68 |
| | | Silverson std hole | High shear | 5 | 17.5 | 99.1 | 12.4 | 2280 | 100 | 100 |
| | | | | 10 | | | 11.6 | 2880 | 100 | 100 |
| | | | | 30 | | | 11.3 | 3200 | 100 | 100 |
| | | | | 60 | | | 14.2 | 3328 | 100 | 100 |
| | | Re- | | | Total | | FLT | | FLT % | Viscosity |
| | Product | dispersion | | Re- | solids | POP | Index | Viscosity | of never | % of never |
| Sample | form | method | | dispersion | wt. % | wt. % | Nm/g | mPas | filtered | filtered |
| Birch | slurry | None | [symbol] ontrol, not | None | 0.5 | 99.0 | 16.8 | 3140 | | |
| | | | dewatere [symbol] | | | | | | | |
| | Plate and | Shake | Low shear | 60 | 16.6 | 99.0 | 0.5 | 60 | 3 | 2 |
| | Frame cake | Lab stir | Low shear | 60 | 16.6 | 99.0 | | 180 | 12 | 6 |
| | | Silverson big hole | Medium shear | 5 | 16.6 | 99.0 | 7.9 | 2040 | 47 | 65 |
| | | Silverson std hole | High shear | 5 | 16.6 | 99.0 | 7.2 | 2560 | 43 | 82 |
| | | | | 10 | | | 12.8 | 3440 | 76 | 100 |
| | | | | 30 | | | 17.7 | 6500 | 100 | 100 |
| | | | | 60 | | | 15.0 | 3644 | 89 | 100 |

| | | Re- | | | Total | | FLT | | | |
|---|---|---|---|---|---|---|---|---|---|---|
| | Product | dispersion | | Re- | solids | POP | Index | Viscosity | | |
| Sample | form | method | | dispersion | wt. % | wt. % | Nm/g | mPas | | |
| Acacia | slurry | None | [symbol] ontrol, not | None | 0.6 | 99.8 | 9.9 | 920 | | |
| | | | dewatere [symbol] | | | | | | | |
| | Plate and | Shake | Low shear | 60 | 21.6 | 99.4 | 0.2 | 40 | 2 | 4 |
| | Frame cake | Lab stir | Low shear | 60 | 21.6 | 99.4 | 0.1 | 40 | 1 | 4 |
| | | Silverson big hole | Medium shear | 5 | 21.6 | 99.4 | 1.8 | 340 | 18 | 37 |
| | | Silverson std hole | High shear | 5 | 21.6 | 99.4 | 7.8 | 840 | 79 | 91 |
| | | | | 10 | | | 8.3 | 1080 | 84 | 100 |
| | | | | 30 | | | 9.2 | 1180 | 93 | 100 |
| | | | | 60 | | | 9.7 | 1308 | 98 | 100 |

[symbol]

indicates data missing or illegible when filed

### Example 14. Paper Properties Utilizing MFC Made Down with MDU

Samples of MFC prepared with inorganic particulate material at 20% POP and 50% POP as belt press cakes is presented in Table 6. Belt press cakes were prepared in accordance with the procedures in Example 11. Tensile index, Burst index, Internal Bond and Bendtsten Porosity were tested in accordance with the following TAPPI industry standards. Tensile index was tested substantially in accordance with Example 1. The make down procedure for the belt press cake is set forth in column 2 of Table 6. The belt press cakes were made down by treating them with a BVG mixer (moderate to high-shear) followed by a high-shear Silverson mixer with either 140 kWh/t or 1000 kWh/t energy input from the Silverson mixer. Belt press cake samples contained 2,000 ppm Flopam 4650 (low-medium charge/medium MW cationic PAM) added as a flocculant prior to belt pressing. Control samples are belt press feed slurry with no flocculant added. Paper samples made on a paper machine utilized a paper furnish of 70/30 eucalyptus/pine refined to 30° SR. The target grammage was 80 gsm. Filler loading was 30% (GCC) and the MFC dose was 3%. Physical properties of the paper samples were measured and presented in Table 6. The results demonstrate that paper containing re-dispersed MFC from belt press cakes (as described) have similar properties to paper containing never-dried MFC.

TABLE 6

| | | Paper Properties | | | |
|---|---|---|---|---|---|
| | | | MD | | |
| | | Burst | Tensile | Internal | Bendtsen |
| FiberLean | Make down | Index/ | Index/ | Bond/ | Porosity/ |
| Sample | method | kPam²g⁻¹ | Nm/g | kgcn | cm³min⁻¹ |
| 20 POP | | 1.35 | 33.5 | 0.85 | 900 |
| Control (belt | | | | | |
| press feed | | | | | |
| slurry) | | | | | |
| 20 POP belt | BVG mixer- | 1.27 | 30.5 | 0.98 | 840 |
| filter press | Silverson | | | | |
| cake | (1000 kWh/t) | | | | |
| | BVG mixer- | 1.36 | 34.5 | 1.00 | 700 |
| | Silverson | | | | |
| | (140 kWh/t) | | | | |
| 50 POP | | 1.20 | 31.5 | 1.06 | 900 |
| Control (belt | | | | | |
| press feed | | | | | |
| slurry) | | | | | |
| 50 POP belt | BVG mixer- | 1.32 | 30.0 | 0.99 | 880 |
| filter press | Silverson | | | | |
| cake | (1000 kWh/t) | | | | |
| | BVG mixer- | 1.25 | 31.5 | 1.03 | 900 |
| | Silverson | | | | |
| | (140 kWh/t) | | | | |

References discussed in the application are incorporated by reference in their entirety.

All patents, patent applications and publications cited herein are hereby incorporated by reference in their entirety. The disclosures of these publications in their entireties are hereby incorporated by reference into this application. The disclosures of each and every patent, patent application, publication, and accession number cited herein are hereby incorporated herein by reference in their entirety.

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

The foregoing embodiments and advantages are merely exemplary and are not to be construed as limiting the present invention. The present disclosures can be readily applied to other types of methods. Also, the description of the embodiments of the present invention is intended to be illustrative and not to limit the scope of the claims. Many alternatives, modifications, and variations will be apparent to those skilled in the art.

The various embodiments described in this specification can be combined to provide further embodiments. Aspects of the embodiments can be modified, if necessary to employ concepts of the various patents, applications and publications to provide yet further embodiments.

While the present disclosure has been disclosed with reference to various embodiments, it is apparent that other embodiments and variations of these may be devised by others skilled in the art without departing from the true spirit and scope of the disclosure. The appended claims are intended to be construed to include all such embodiments and equivalent variations. The foregoing written specification is considered to be sufficient to enable one skilled in the art to practice the embodiments.

The foregoing description and Examples detail certain embodiments and describes the best mode contemplated by the inventors. It will be appreciated, however, that no matter how detailed the foregoing may appear in text, the embodiment may be practiced in many ways and should be construed in accordance with the appended claims and any equivalents thereof.

What is claimed:

1. A method for re-dispersing a partially-dried, filtration cake composition comprising microfibrillated cellulose and, optionally, one or more inorganic particulate material, and, optionally one or more additive in a liquid medium; the method comprising the steps of:
(a) providing a quantity of a dispersing liquid to a first mixing tank;
(b) providing a partially-dried, filtration cake composition comprising microfibrillated cellulose and, optionally, one or more inorganic particulate material; and, optionally one or more additional additive;
(c) optionally, providing one or more additive to the first mixing tank;
wherein, the quantity of partially-dried, filtration cake composition comprising microfibrillated cellulose and, optionally, one or more inorganic particulate material and, optionally one or more additive, has a total solids content of about 8 wt. % to about 60 wt. %, and wherein the dispersing liquid and partially-dried filtration cake has a fibre content of from about 0.5 wt % to about 20 wt % fibre solids, preferably about 0.5 wt. % to about 4 wt. % fibre solids, and more preferably about 1 wt. % to about 2 wt. % fibre solids based on the total solids content of the microfibrillated cellulose and optionally one or more inorganic particulate material, and, optionally, one or more additive;
(c) applying high-shear mixing with a first moderate-to-high-shear mixing apparatus comprising a shear-head impeller to the liquid medium and microfibrillated cellulose and, optionally, one or more inorganic particulate material, and, optionally one or more additive, to form a flowable slurry;
(d) applying further high-shear mixing with a high-shear rotor-stator or rotor-rotor mixing apparatus to the flowable slurry to form a substantially homogeneous suspension of the liquid medium and microfibrillated cellulose and, optionally one or more particulate material and, optionally, one or more additional additive;
(e) recovering the substantially homogeneous suspension of liquid medium and microfibrillated cellulose and, optionally one or more particulate material and, optionally, one or more additional additive, in a storage tank, or utilizing the substantially homogeneous suspension in an end-use application or, optionally, recirculating the substantially homogeneous suspension to the first mixing tank to permit further continuous processing of the substantially homogeneous suspension;
wherein the viscosity of the substantially homogeneous suspension is restored and/or tensile index of the re-dispersed microfibrillated cellulose and, optionally one or more inorganic particulate material, and, optionally, one or more additive, is restored to within the range of 70% to essentially completely restored levels compared to a similar composition that has never been partially-dried.

2. The method according to claim 1, further comprising providing the partially-dried, filtration cake composition comprising microfibrillated cellulose and, optionally, one or more inorganic particulate material, and, optionally one or more additional additive, to the first mixing tank (20) by a feed hopper.

3. The method according to claim 1 or claim 2, further comprising one or more optional filter apparatus for removal of agglomerates in the flowable slurry.

4. The method according to claim 1, wherein the flowable slurry is further processed in a second mixing tank having a second moderate-to-high-shear mixing apparatus comprising a shear-head impeller to impart high-shear mixing of the liquid medium and microfibrillated cellulose and, optionally, one or more particulate material, and, optionally one or more additive, to form a flowable slurry, wherein the first mixing tank and second mixing tank are connected by an overflow tube for passively conducting flowable slurry from the first mixing tank to the second mixing tank when an overflow level of mixing tank is reached.

5. The method according to any one of claims 1-3, wherein the first moderate-to-high-shear mixing apparatus comprising a shear-head impeller (22b) is selected from a dispergator, disperser, overhead stirrer for high-speed, high-shear mixing or Cowles type mixer or other generally vertically oriented shear-head impeller apparatus.

6. The method according to claim 4, wherein the first and/or second moderate-to-high-shear mixing apparatus comprising a shear-head impeller (22b) is a dispergator, disperser, overhead stirrer for high-speed, high-shear mixing or Cowles type mixer or other generally vertically oriented shear-head impeller apparatus.

7. The method according to claim 5, wherein the first moderate-to-high-shear mixing apparatus comprising a shear-head impeller is a dispergator.

8. The method according to claim 6, wherein the first and/or second high-shear mixing apparatus comprising a shear-head impeller is a dispergator.

9. The method according to claim 5, wherein the first moderate-to-high-shear mixing apparatus comprising a shear-head impeller is a Cowles-type mixer.

10. The method according to claim 5, wherein the first moderate-to-high-shear mixing apparatus comprising a shear-head impeller is a generally vertically oriented shear-head impeller apparatus.

11. The method according to claim 6, wherein the first and/or second moderate-to-high-shear mixing apparatus comprising a shear-head impeller is a Cowles-type mixer.

12. The method according to claim 6, wherein the first moderate-to-high-shear mixing apparatus comprising a shear-head impeller is a generally vertically oriented shear-head impeller apparatus.

13. The method according to claim 6, wherein the first and/or second moderate-to-high-shear mixing apparatus comprising a shear-head impeller is a generally vertically oriented shear-head impeller apparatus.

14. The method according to claim 5, wherein the high-shear rotor-stator mixing apparatus is a Trigonal® SM180, BVG ShearMaster or Cavitron mixing apparatus.

15. The method according to claim 6, wherein the high-shear rotor-stator mixing apparatus is a Trigonal® SM180, BVG ShearMaster or Cavitron mixing apparatus.

16. The method according to claim 5, wherein the high-shear rotor-stator mixing apparatus is a colloid mill.

17. The method according to claim 6, wherein the high-shear rotor-stator mixing apparatus is a colloid mill.

18. The method according to claim 5, wherein the rotor-rotor mixing apparatus comprises counter rotating rings.

19. The method according to claim 6, wherein the rotor-rotor mixing apparatus comprises counter rotating rings

20. The method according to claim 5, wherein the rotor-rotor mixing apparatus is an Atrex dispergator

21. The method according to claim 6, wherein the rotor-rotor mixing apparatus is an Atrex dispergator

22. The method according to any one of the preceding claims, wherein the one or more additive is a biocide.

23. The method according to claim 22, wherein the biocide is preferably 2,2-dibromo-3-nitrilopropionamide (DBNPA).

24. The method according to claim 23, wherein the DBNPA is dosed at about 250 ppm.

25. The method according to claim 22 wherein the biocide is 2-methyl-2h-isothiazolin-3-one/2-methyl-2h-isothiazol-3-one (3:1 ratio) (CMIT/MIT).

26. The method according to claim 25, wherein the CMIT/MIT is dosed at about 200 ppm.

27. The method according to any one of claims 1-4, wherein the one or more additive is a flocculant.

28. The method according to claim 27, wherein the flocculant is a cationic flocculant.

29. The method according to claim 27, wherein the cationic flocculant is a polyacrylamide solution.

30. The method according to any one of claims 1-4, wherein the method restores viscosity of the re-dispersed microfibrillated cellulose to within 75% to essentially completely restored levels compared to similar compositions which have never been dried.

31. The method according to any one of claims 1-4, wherein the method restores viscosity of the re-dispersed microfibrillated cellulose to within 80% to essentially completely restored levels compared to similar compositions which have never been dried.

32. The method according to any one of claims 1-4, wherein the method restores viscosity of the re-dispersed microfibrillated cellulose to within 85% to essentially completely restored levels compared to similar compositions which have never been dried.

33. The method according to any one of claims 1-4, wherein the method restores viscosity of the re-dispersed microfibrillated cellulose to within 90% to essentially completely restored levels compared to similar compositions which have never been dried.

34. The method according to any one of claims 1-4, wherein the method restores viscosity of the re-dispersed microfibrillated cellulose to within 95% to essentially completely restored levels compared to similar compositions which have never been dried.

35. The method according to any one of claims 1-4, wherein the method essentially restores viscosity of the re-dispersed microfibrillated cellulose to a level comparable to a similar composition that has never been dried.

36. The method according to any one of claims 1-4, wherein the method restores tensile index of the re-dispersed microfibrillated cellulose to within 75% to essentially completely restored levels compared to similar compositions which have never been dried.

37. The method according to any one of claims 1-4, wherein the method restores tensile index of the re-dispersed microfibrillated cellulose to within 80% to essentially completely restored levels compared to similar compositions which have never been dried.

38. The method according to any one of claims 1-4, wherein the method restores tensile index of the re-dispersed microfibrillated cellulose to within 85% to essentially completely restored levels compared to similar compositions which have never been dried.

39. The method according to any one of claims 1-4, wherein the method restores tensile index of the re-dispersed microfibrillated cellulose to within 90% to essentially completely restored levels compared to similar compositions which have never been dried.

40. The method according to any one of claims 1-4, wherein the method restores tensile index of the re-dispersed microfibrillated cellulose to within 95% to essentially completely restored levels compared to similar compositions which have never been dried.

41. The method according to any one of claims 1-4, wherein the method essentially restores tensile index of the re-dispersed microfibrillated cellulose to a level comparable to a similar composition that has never been dried.

42. The method according to any one of claims 1-4, wherein the filtration cake is a belt press cake.

43. The method according to any one of claims 1-4, wherein the filtration cake is a plate and frame press cake.

44. The method according to any one of claims 1-4, wherein the filtration cake is a tube press cake.

45. The method according to any one of the claims 1-44, wherein the one or more inorganic particulate materials are selected from an alkaline earth metal carbonate or sulphate, such as calcium carbonate, magnesium carbonate, dolomite, gypsum, a hydrous kandite day such as kaolin, halloysite or ball clay, an anhydrous (calcined) kandite clay such as metakaolin or fully calcined kaolin, talc, mica, perlite, bentonite or diatomaceous earth, or magnesium hydroxide, or aluminum trihydrate, or combinations thereof.

46. The method according to any one of claims 1-44, wherein the one or more inorganic particulate material is selected from one or more of kaolin, calcined kaolin, wollastonite, bauxite, talc, bentonite or mica.

47. The method according to any one of claims 1-44, the one or more inorganic particulate material is calcium carbonate, preferably ground calcium carbonate, precipitated calcium carbonate and mixtures thereof.

48. The method according to any one of claims 1-44, where the one or more inorganic particulate material is kaolin clay.

49. The method according to any one of claims 1-44, wherein the one or more inorganic particulate material is hyper-platy kaolin.

50. The method according to any one of claims 1-44, wherein the microfibrillated cellulose is produced from hardwood pulp, softwood pulp, wheat straw pulp, bamboo, bagasse, virgin fiber, chemical pulp, chemithermomechanical pulp, mechanical pulp, thermomechanical pulp, kraft pulp, bleached long fibre kraft pulp, eucalyptus pulp, spruce pulp, pine pulp, beech pulp, hemp pulp, acacia cotton pulp, recycled pulp, papermill broke, paper steam rich in mineral fillers, or a combination thereof.

51. The method according to any one of claims 1-44, wherein the hardwood pulp is selected from the group consisting of eucalyptus, aspen, birch, and mixed hardwood pulps

52. The method according to any one of claims 1-44, wherein the softwood pulp is selected from the group consisting of spruce, pine, fir, larch, hemlock, and mixed softwood pulp.

53. A transportable make down system for re-dispersing partially-dried, filtration cake compositions comprising microfibrillated cellulose, and, optionally, one or more inorganic particulate material, and optionally one or more additive, comprising:
a first mixing tank (20) having tank inlet (24); second inlet (25) for provision of liquid medium to the first mixing tank (20); first moderate-to-high-shear mixing apparatus (22a) comprising a shear-head impeller (22b) for moderate-to-high-shear mixing of the liquid medium and microfibrillated cellulose and, optionally, one or more particulate material, and, optionally, one or more additive, to form a flowable slurry; outlet (26) attached to inlet (31) of a high-speed, high-shear, rotor-stator and/or rotor-rotor mixing apparatus (30) for applying further high-shear to the flowable slurry; further comprising outlet (32); wherein after application of high-shear to the flowable slurry by the rotor-stator and/or rotor-rotor mixing apparatus (30) forms a substantially homogeneous suspension comprising microfibrillated cellulose and, optionally one or more inorganic particulate material, and, optionally, one or more additive; and the substantially homogeneous suspension is retrieved through outlet (32) optionally connected to storage tank (60) or utilized directly in an end-use application or recirculated to an optional third inlet (29) of mixing tank (20) to form a recirculation loop to permit further continuous processing of the substantially homogeneous suspension.

54. The system according to claim 53, wherein viscosity and/or tensile index of the re-dispersed substantially homogeneous suspension comprising microfibrillated cellulose is restored to within the range of 70% to essentially completely restored levels compared to a similar composition that has never been partially-dried.

55. The system according to claim 53, further comprising providing the partially-dried, filtration cake composition comprising microfibrillated cellulose and, optionally, one or more inorganic particulate material, and, optionally one or more additional additive, to the first mixing tank (20) by a feed hopper.

56. The system according to claim 53, further comprising one or more optional filter (28a/28b), which is operated interchangeably to permit cleaning and removing agglomerates in the flowable slurry, interposed between outlet (26) and inlet (31).

57. The system according to claim 53, wherein the flowable slurry from mixing tank (20) may be further processed in a second mixing tank (70) having second moderate-to-high-shear mixing apparatus (72a) comprising a shear-head impeller (72b) for high shear mixing of the liquid medium and microfibrillated cellulose and, optionally, one or more particulate material, and, optionally, one or more additive; further comprising outlet (73) connected to inlet (31) of second high-speed, high-shear rotor-stator and/or rotor-rotor mixing apparatus (30); further comprising an overflow tube for passively conducting flowable slurry from first mixing tank (20) to second mixing tank (70) when the overflow level of mixing tank 1 is reached.

58. The system according to any one of claims 53-56, wherein the system restores viscosity of the re-dispersed microfibrillated cellulose to within 75% to essentially completely restored levels compared to similar compositions which have never been dried.

59. The system according to any one of claims 53-56, wherein the method restores tensile index of the re-dispersed microfibrillated cellulose to within 75% to essentially completely restored levels compared to similar compositions which have never been dried.

60. The system according to any one of claims 53-56, wherein the method restores viscosity of the re-dispersed microfibrillated cellulose to within 80% to essentially completely restored levels compared to similar compositions which have never been dried.

61. The system according to any one of claims 53-56 wherein the method restores tensile index of the re-dispersed microfibrillated cellulose to within 80% to essentially completely restored levels compared to similar compositions which have never been dried.

62. The system according to any one of claims 53-56, wherein the method restores viscosity of the re-dispersed microfibrillated cellulose to within 85% to essentially completely restored levels compared to similar compositions which have never been dried.

63. The system according to any one of claims 53-56, wherein the method restores tensile index of the re-dispersed microfibrillated cellulose to within 85% to essentially completely restored levels compared to similar compositions which have never been dried.

64. The system according to any one of claims 53-56, wherein the method restores viscosity of the re-dispersed microfibrillated cellulose to within 90% to essentially completely restored levels compared to similar compositions which have never been dried.

65. The system according to any one of claims 53-56, wherein the method restores tensile index of the re-dispersed microfibrillated cellulose to within 90% to essentially completely restored levels compared to similar compositions which have never been dried.

66. The system according to any one of claims 53-56, wherein the method restores viscosity of the re-dispersed microfibrillated cellulose to within 95% to essentially completely restored levels compared to similar compositions which have never been dried.

67. The system according to any one of claims 53-56, wherein the method restores tensile index of the re-dispersed microfibrillated cellulose to within 95% to essentially completely restored levels compared to similar compositions which have never been dried.

68. The system according to any one of claims 53-56, wherein the method essentially restores viscosity of the re-dispersed microfibrillated cellulose to a level comparable to a similar composition which has never been dried.

69. The system according to any one of claims 53-56, wherein the method essentially restores tensile index of the re-dispersed microfibrillated cellulose to a level comparable to a similar composition which has never been dried.

70. The system according to any one of claims 53-56, further comprising an operating system for controlling the feed rate of partially-dried microfibrillated cellulose and, optionally one or more inorganic particulate material, and, optionally, one or more additive, and the liquid medium to control the solids content in first mixing tank (20).

71. The system according to any one of claims 53-55, wherein the first high-shear mixing apparatus (22a) comprising a shear-head impeller (22b) is a dispergator, disperser, overhead stirrer for high-speed, high-shear mixing or Cowles type mixer or other generally vertically oriented shear-head impeller apparatus.

72. The system according to claim 56, wherein the first and/or second high-shear mixing apparatus (22a) comprising a shear-head impeller (22b) is a dispergator, disperser, overhead stirrer for high-speed, high-shear mixing or Cowles type mixer or other generally vertically oriented shear-head impeller apparatus.

73. The system according to claim 66, wherein the first moderate-to-high-shear mixing apparatus (22a) comprising a shear-head impeller (22b) is a dispergator.

74. The system according to claim 66, wherein the first moderate-to-high-shear mixing apparatus (22a) comprising a shear-head impeller (22b) is a disperser.

75. The system according to claim 66, wherein the first moderate-to-high-shear mixing apparatus (22a) comprising a shear-head impeller (22b) is an overhead stirrer for high-speed, high-shear mixing.

76. The system according to claim 66, wherein the first moderate-to-high-shear mixing apparatus (22a) comprising a shear-head impeller (22b) is Cowles type mixer.

77. The system according to claim 67, wherein the first and/or second moderate-to-high-shear mixing apparatus (22a) comprising a shear-head impeller (22b) is a dispergator.

78. The system according to claim 67, wherein the first and/or second high-shear mixing apparatus (22a) comprising a shear-head impeller (22b) is a disperser.

79. The system according to claim 67, wherein the first and/or second high-shear mixing apparatus (22a) comprising a shear-head impeller (22b) is an overhead stirrer for high-speed, high-shear mixing.

80. The system according to claim 67, wherein the first and/or second high-shear mixing apparatus (22a) comprising a shear-head impeller (22b) is a Cowles-type mixer.

81. The system according to any one of claims 53-56, wherein the filtration cake is a belt press cake.

82. The system according to any one of claims 53-56 wherein the filtration cake is a plate and frame press cake.

83. The system according to any one of the preceding claims, wherein the one or more inorganic particulate materials are selected from an alkaline earth metal carbonate or sulphate, such as calcium carbonate, magnesium carbonate, dolomite, gypsum, a hydrous kandite day such as kaolin, halloysite or ball clay, an anhydrous (calcined) kandite clay such as metakaolin or fully calcined kaolin, hyper-platy kaolin, talc, mica, perlite, bentonite or diatomaceous earth, or magnesium hydroxide, or aluminum trihydrate, or combinations thereof.

84. The system according to any one of the preceding claims, wherein the one or more inorganic particulate material is selected from one or more of kaolin, calcined kaolin, wollastonite, bauxite, talc, bentonite or mica.

85. The system according to any one of the preceding claims, wherein the one or more inorganic particulate material is calcium carbonate, preferably ground calcium carbonate, precipitated calcium carbonate and mixtures thereof.

86. The system according to claim 83 wherein the one or more inorganic particulate material is kaolin clay.

87. The system according to claim 83, wherein the one or more inorganic particulate material is hyper-platy kaolin.

88. The system according to any one of claims 53-56, wherein the first mixing tank (20) has a volume of at least 1 m².

89. The system according to any one of the preceding claims, wherein the microfibrillated cellulose is produced from hardwood pulp, softwood pulp, wheat straw pulp, bamboo, bagasse, virgin fiber, chemical pulp, chemithermomechanical pulp, mechanical pulp, thermomechanical pulp, kraft pulp, bleached long fibre kraft pulp, eucalyptus pulp, spruce pulp, pine pulp, beech pulp, hemp pulp, acacia cotton pulp, recycled pulp, papermill broke, paper steam rich in mineral fillers, or a combination thereof.

90. The system according to any one of the preceding claims, wherein the hardwood pulp is selected from the group consisting of eucalyptus, aspen, birch, and mixed hardwood pulps.

91. The system according to any one of the preceding claims, wherein the softwood pulp is selected from the group consisting of spruce, pine, fir, larch, hemlock, and mixed softwood pulp.

92. The system according to claim 53, wherein, the quantity of partially-dried, filtration cake composition comprising microfibrillated cellulose and, optionally, one or more inorganic particulate material and, optionally one or more additive, has a total solids content of about 8 wt. % to about 60 wt. %, and wherein the dispersing liquid and partially-dried filtration cake has a fibre content of from about 0.5 wt % to about 20 wt % fibre solids, preferably about 0.5 wt. % to about 4 wt. % fibre solids, and more preferably about 1 wt. % to about 2 wt. % fibre solids based on the total solids content of the microfibrillated cellulose and optionally one or more inorganic particulate material, and, optionally, one or more additive.

93. A transportable make down system for re-dispersing partially-dried, filtration cake compositions comprising microfibrillated cellulose, and, optionally, one or more inorganic particulate material, and optionally one or more additive, comprising:
a first mixing tank (20) having tank inlet (24); second inlet (25) for provision of liquid medium to the first mixing tank (20); first moderate-to-high-shear mixing apparatus (22a) comprising a shear-head impeller (22b) for moderate-to-high-shear mixing of the liquid medium and microfibrillated cellulose and, optionally, one or more particulate material, and, optionally, one or more additive, to form a flowable slurry; outlet (26) attached to inlet (31) of a high-speed, first high-shear, rotor-stator and/or rotor-rotor mixing apparatus (30) for applying further high-shear to the flowable slurry; further comprising outlet (32); a second high-shear rotor-stator and/or rotor-rotor mixing apparatus (50) comprising inlet (52) connected to the first high-shear rotor-stator and/or rotor-rotor outlet (32) and comprising outlet (53);
wherein after application of high-shear to the flowable slurry by the first rotor-stator and/or rotor-rotor mixing apparatus (30) and the second high-shear rotor-stator or rotor-rotor mixing apparatus (50) forms a substantially homogeneous suspension comprising microfibrillated cellulose and, optionally one or more inorganic particulate material, and, optionally, one or more additive; and the substantially homogeneous suspension is retrieved through outlet (53) optionally connected to storage tank (60) or utilized directly in an end-use application or recirculated to an optional third inlet (29) of mixing tank (20) to form a recirculation loop to permit further continuous processing of the substantially homogeneous suspension.

94. The system according to claim 93, wherein the first high-shear mixing apparatus is a rotor-stator mixing apparatus and the second high-shear mixing apparatus is a rotor-stator mixing apparatus.

95. The system according to claim 93, wherein the first high-shear apparatus is a rotor-stator mixing apparatus and the second high-shear mixing apparatus is a rotor-rotor mixing apparatus.

96. The system according to claim 93, wherein the first high-shear apparatus is a rotor-rotor mixing apparatus and the second high shear mixing apparatus is a rotor-rotor mixing apparatus.

97. The system according to claim 93, wherein the first high-shear apparatus is a rotor-rotor mixing apparatus and the second high-shear mixing apparatus is a rotor-stator mixing apparatus.

98. The system according to claim 93, wherein viscosity and/or tensile index of the re-dispersed substantially homogeneous suspension comprising microfibrillated cellulose is restored to within the range of 70% to essentially completely restored levels compared to a similar composition that has never been partially-dried.

99. The system according to claim 93, wherein the flowable slurry is further processed in a second mixing tank having a second moderate-to-high-shear mixing apparatus comprising a shear-head impeller to impart high-shear mixing of the liquid medium and microfibrillated cellulose, and, optionally one or more inorganic particulate material, and, optionally one or more additive.

100. A method for re-dispersing a partially-dried, filtration cake composition comprising microfibrillated cellulose and, optionally, one or more inorganic particulate material, and, optionally one or more additive in a liquid medium; the method comprising the steps of:
(a) providing a quantity of a dispersing liquid to a first mixing tank;
(b) providing a partially-dried, filtration cake composition comprising microfibrillated cellulose and, optionally, one or more inorganic particulate material; and, optionally one or more additional additive;
(c) optionally, providing one or more additive to the first mixing tank;
wherein, the quantity of partially-dried, filtration cake composition comprising microfibrillated cellulose and, optionally, one or more inorganic particulate material and, optionally one or more additive, has a total solids content of about 8 wt. % to about 60 wt. %, and wherein the dispersing liquid and partially-dried filtration cake has a fibre content of from about 0.5 wt % to about 20 wt % fibre solids, preferably about 0.5 wt. % to about 4 wt. % fibre solids, and more preferably about 1 wt. % to about 2 wt. % fibre solids based on the total solids content of the microfibrillated cellulose and optionally one or more inorganic particulate material, and, optionally, one or more additive;
(c) applying high-shear mixing with a first moderate-to-high-shear mixing apparatus comprising a shear-head impeller to the liquid medium and microfibrillated cellulose and, optionally, one or more inorganic particulate material, and, optionally one or more additive, to form a flowable slurry;
(d) applying further high-shear mixing with a first high-shear rotor-stator or rotor-rotor mixing apparatus and with a second high-shear rotor-stator or rotor-rotor mixing apparatus to the flowable slurry to form a substantially homogeneous suspension of the liquid medium and microfibrillated cellulose and, optionally one or more particulate material and, optionally, one or more additional additive;
(e) recovering the substantially homogeneous suspension of liquid medium and microfibrillated cellulose and, optionally one or more particulate material and, optionally, one or more additional additive, in a storage tank, or utilizing the substantially homogeneous suspension in an end-use application or, optionally, recirculating the substantially homogeneous suspension to the first mixing tank to permit further continuous processing of the substantially homogeneous suspension;
wherein the viscosity of the substantially homogeneous suspension is restored and/or tensile index of the re-dispersed microfibrillated cellulose and, optionally one or more inorganic particulate material, and, optionally, one or more additive, is restored to within the range of 70% to essentially completely restored levels compared to a similar composition that has never been partially-dried.
permit further continuous processing of the substantially homogeneous suspension.

101. The method according to claim 100, wherein the first high-shear mixing apparatus is a rotor-stator mixing apparatus and the second high-shear mixing apparatus is a rotor-stator mixing apparatus.

102. The method according to claim 110, wherein the first high-shear apparatus is a rotor-stator mixing apparatus and the second high-shear mixing apparatus is a rotor-rotor mixing apparatus.

103. The system according to claim 100, wherein the first high-shear apparatus is a rotor-rotor mixing apparatus and the second high shear mixing apparatus is a rotor-rotor mixing apparatus.

104. The system according to claim 100, wherein the first high-shear apparatus is a rotor-rotor mixing apparatus and the second high-shear mixing apparatus is a rotor-stator mixing apparatus.

105. The system according to claim 100, wherein viscosity and/or tensile index of the re-dispersed substantially homogeneous suspension comprising microfibrillated cellulose is restored to within the range of 70% to essentially completely restored levels compared to a similar composition that has never been partially-dried.

106. The system according to claim 100, wherein the flowable slurry is further processed in a second mixing tank having a second moderate-to-high-shear mixing apparatus comprising a shear-head impeller to impart high-shear mixing of the liquid medium and microfibrillated cellulose, and, optionally one or more inorganic particulate material, and, optionally one or more additive.
